(19) United States
(12) Patent Application Publication
(10) Pub. No.: US 2007/0136603 A1
(43) Pub. Date: Jun. 14, 2007

(54) Method and apparatus for providing secure access control for protected information

(75) Inventor: Horen Kuecuekyan, Baldwinsville, NY (US)

Correspondence Address: BURR & BROWN, PO BOX 7068, SYRACUSE, NY, 13261-7068, US

(73) Assignee: Sensis Corporation, East Syracuse, NY (US)

(21) Appl. No.: 11/584,800

(22) Filed: Oct. 20, 2006

Related U.S. Application Data
(60) Provisional application No. 60/729,049, filed on Oct. 21, 2005.
(60) Provisional application No. 60/735,646, filed on Nov. 10, 2005.
(60) Provisional application No. 60/736,560, filed on Nov. 14, 2005.

(51) Int. Cl. H04L 9/00

(52) U.S. Cl. 713/185

(57) ABSTRACT

There are provided methods and apparatuses for processing requests from requestors, methods and apparatuses for transmitting indicia representative of information from a first domain to a second domain, methods comprising, and apparatuses for, determining whether a requestor is authorized to perform a desired operation on a target comprising at least one element which comprises an information set of indicia and arrangements of stored data, as well as computer-readable media having computer-executable commands for performing the same. In some aspects of the present invention, there are provided high-assurance data security apparatuses and methods, in particular, user data protection via enforcement of policy-based access control.

### CROSS-REFERENCE TO RELATED APPLICATIONS

This application claims the benefit of U.S. Provisional Patent Application No. 60/729,049, filed Oct. 21, 2005, the entirety of which is incorporated herein by reference.

This application claims the benefit of U.S. Provisional Patent Application No. 60/735,646, filed Nov. 10, 2005, the entirety of which is incorporated herein by reference.

This application claims the benefit of U.S. Provisional Patent Application No. 60/736,560, filed Nov. 14, 2005, the entirety of which is incorporated herein by reference.

### FIELD OF THE INVENTION

The present invention relates to high-assurance data security apparatuses and methods, in particular, user data protection via enforcement of policy-based access control.

### BACKGROUND OF THE INVENTION

There is an ever-increasing volume of protected data, the rate of increase of which is constantly increasing.

Moreover, there are increasingly more complicated situations where different owners or controllers of information (e.g., agencies, machines, software applications, etc.) want or need to provide to different people and/or entities (which may be located within the same organization as the owner or controller of information or outside such organization) access to different sets of such information.

There is an ongoing need for apparatuses and methods which more securely provide secure access control for larger and larger groups of information, with increasingly complicated differentiated rules for access by different users and entities, and with greater reliability and speed.

### BRIEF SUMMARY OF THE INVENTION

The present invention is directed to apparatuses and methods which provide security to prevent unauthorized access to user data in localized or distributed systems.

The present invention is directed to providing a strong security enforcement layer placed between a system's data and the potential producers and consumers of that data. The purpose of the security layer provided by the present invention is to strictly control access to all data in a distributed system by enforcing the explicit security policy rules of the or each domain in the distributed system. A domain in the context of the present invention is comprised of all network-reachable data that is under the exclusive control of a single security policy. The present invention is directed to providing the ability to perform a single access control decision within one domain, or across multiple domains where each domain is under the control of its own security policy.

The present invention is directed to apparatus and methods which can process access requests from “requesters” wishing to perform “operations” on data “targets” in single or multiple-domain systems. The defined operations preferably include at least read, write, publish, and subscribe. A variety of other possible operations could be treated in a manner similar to those specifically mentioned herein, i.e., the present invention is not limited to handling requests for any particular operations. (A delete operation is considered to be a “write” operation.) For example, other operations could include a request to view the files to which a particular user has access.

The smallest unit of information to be protected is referred to as an “Element” (which is smaller in granularity than a “file”). An element is a user-defined piece of data that the domain owner wishes to protect differently than other elements in a target. A target may therefore be comprised of multiple elements, and the elements of a target may physically be distributed across multiple domains. In multiple-domain systems that utilize this architecture, a separate instance of a system according to the present invention must be the security framework for each domain.

Distributed Security Architecture (DSA) systems (referred to herein as “DSA” or “DSA systems”) according to the present invention are high-assurance data security products whose purpose is to provide the following services:
user data protection via enforcement of policy-based access control. DSA explicitly grants permission to perform operations, e.g., read/write and subscribe/publish operations on data that concurrently resides in one or more protected domains, where in the latter case the data is distributed across multiple security domains;
identification & authentication of requesters; and
confidentiality of source(s), and of data.

DSA is unique in its ability to perform a single, distributed access control decision across multiple protected domains without compromising confidentiality of sources and data across domain boundaries. In a multiple-domain scenario, one access control decision is distributed such that partial decisions are independently made in each domain that owns a portion of the required information. The result is a securely coordinated end-to-end access control decision that protects the confidentiality of each participating domain's sources and data.

Because the DSA internal architecture is comprised of a set of distributed software components, the entire architecture is designed such that the security of the DSA system itself is highly assured.

DSA must explicitly and completely grant a request prior to any operations being allowed on any targets, including the case where the target of a request may have elements that are physically distributed across multiple domains. To achieve this, DSA must explicitly enforce the security policy rules of each domain in a multi-domain system. Because a requestor is never allowed to have explicit location information for a requested target, either within or outside of its local domain, each DSA Domain must securely manage this location information without divulging it to any user, or to another DSA domain.

DSA provides an enforcement barrier between users and protected data that cannot be bypassed by unauthorized users. This is because DSA requires protected data to reside on hosts with secure operating systems that are configured with mandatory access control policies of their own that allow exclusive access to data only through an DSA host. Therefore, a user can get access to protected data if and only if a security policy rule exists in DSA granting such access.

If a request is granted, DSA then generates an Agent which is given the ability to perform the granted operation on a specific target on behalf of the authorized user. This design construct prevents the user from being given the opportunity to know where the target is actually located. An agent can be designed to exist for any desired length of time. For example, in the case of a read operation or a write operation, the agent can be terminated upon that operation being performed or the passage of a specific amount of time, whichever occurs first. Similarly, an agent for a subscribe operation or a publish operation can be designed to last indefinitely or for a specific limited period of time.

As noted above, protected data resides on hosts with secure operating systems that are configured with mandatory access control policies that allow exclusive access to data only through a DSA host. Preferably, such exclusive access to the data is allowed only for Agents within the domain in which the data resides.

For a multiple-domain DSA system, DSA restricts all communication between domains to occur only through highly secure DSA-controlled connections that are dynamically established and torn-down in each direction, for each instance of communication. In such a specific inter-domain interface (also referred to as “inter-domain access control”), within each domain, a pair of virtual addresses are established, preferably using software context switches which dynamically “flip” among virtual addresses within the protected domain, as well as a physical address which can be connected to respective physical addresses of other domains via a permanent or semi-permanent conduit (“big pipe”). Accordingly, in a preferred embodiment, in a situation where one or more element is transferred from one domain to an agent in another domain, such element(s) would pass from a data host in the local domain, through the first and second virtual addresses in the local domain, through the physical address in the local domain and to a virtual address in the other domain through the physical address of that other domain. Preferably, where such a communication is made, each domain receives information from the other domain regarding the virtual address in that other domain which communicates directly to the physical address of that other domain. Preferably, no domain would ever know the virtual address which communicates directly with a data host in any other domain.

A user never knows that their request may have a target that is physically distributed across multiple domains. Each DSA domain operates independently with its own security policy, and is allowed to instantiate secure cross-domain communications only with other domains that are trusted. Even so, an DSA domain never divulges location information of its local targets across a domain boundary. For the multiple domain case, a request is granted either entirely or not at all. Once all portions of a target are granted in each domain, the last domain in the chain initiates construction of its Agent, and back-propagates the chain all the way to the first domain that issued the original request. The user then may access their local Agent, without knowledge that there is a chain of multi-domain Agents that are actually fulfilling the request in its entirety, across domain boundaries. In this manner, DSA provides cross-domain trust management based upon a chain of trust of an “Agent”, not the user.

The present invention provides a way to avoid having to configure access for a plurality of users to respective groups of targets where such users can directly access protected data from a host.

The following is a brief summary of a representative example of how a session in which a user submits a single request can be conducted:
First, the user completes an identification and authentication (I&A) procedure. For example, the I&A procedure can include the user submitting an authentication request, which may include the user's user name and password, and the user then receiving from DSA an authentication token. Such an I&A procedure can suitably be used in order to determine that the user is aware of information which should be known only to the person whom the user claims to be, thereby attempting to eliminate imposters. This procedure can also be used to determine whether the user is in the correct location for the person whom the user claims to be. Alternatively or additionally, an I&A procedure can include or consist of deriving indicia from the user, e.g., using biometrics (iris scanning, fingerprinting, etc.).
Next, the user submits a request. In a preferred embodiment: the client access layer (CAL) (or the thin data layer (TDL), depending on the nature of the user, as described below), acting on behalf of the user, sends notification to DSA that the user intends to submit a request. An access request handling (ARH) process within DSA, designed to balance loading of requests among hosts allocated to determining whether requests are grantable (and/or forwarding a new request to other domains for non-local elements), returns an address (preferably a virtual address) to CAL or TDL, specifying the location to which the request should be sent. Then, CAL or TDL submits the user's authentication token and the user's identity credentials (which can be obtained by prompting the user to enter his or her credentials) to that address.
DSA for the local domain then determines whether it owns any of the elements within the target by looking to the virtual resource representation contained in the virtual resource manager for the local domain, and, if so, whether there are policy rules which grant the user access to the elements within the target which are owned by the local domain. If it is determined that there are any elements within the target for which there is not a rule which grants access to that element to the user, the request will be denied (and no further communication will be provided to the user). If it is determined that all of the elements within the target are owned by the local domain and there are rules which indicate that the user is entitled to perform the requested operation(s) on all of those elements, the request will be granted. If it is determined that only some of the elements of the target are contained in the local domain and there are rules which indicate that the user has the right to perform the requested operation(s) on those (or that) elements within the target which are contained in the local domain, a revised request, for those elements of the target which are not contained in the local domain, will then be sent from the local domain to another domain, where the request will be handled in a manner analogous to that described above. If it is determined that none of the elements within the target are owned by the local domain, a revised request for all of the elements within the target will be sent from the local domain to another domain, where the request will be handled in a manner analogous to that described above.
In cases where the request traverses across more than one domain, if it is determined that for any element within the target there is not a rule which grants to the user the rights to perform the requested operation(s) on that element, the request will be denied and no further communication will be sent to the user. If a request traverses multiple domains and is ultimately found to be grantable, agents will be created in each of the domains across which the request traversed and the user will be provided with an agent access token, as well as the location of the agent in the user's local domain. The agent in the local domain will have received the location of the agent in the next domain that the request traversed (i.e., the domain to which the local domain sent a revised request), and each successive agent will have the location of the agent in the domain to which the request was sent by that domain (except for the final domain, i.e., the domain in which a determination was made that the requestor has the rights to perform the requested operation(s) on all the remaining elements within the target).

Preferably, in a multi-domain system, there is an established sequence through which requests are forwarded (e.g., in a five domain system, domain 1 always forwards to domain 2, domain 2 always forwards to domain 3, domain 3 always forwards to domain 4, domain 4 always forwards to domain 5, and domain 5 always forwards to domain 1). Preferably, if a request returns to the local domain in which it originated (i.e., one or more element has not been located), the request is automatically denied and the requestor receives no further communication.

The processes which handle requests may be contained on any number of host computers, thereby making the request-handling function scalable.

Preferably, each request-handling process has two request interfaces, one for requests which originate in the local domain, and a second for requests which have been forwarded from another domain.

The following is a summary of a sequence of steps which can be carried out in a representative example of a policy rule enforcement process.
First, a decision is made regarding whether the user's clearance level is equal to or greater than the protection level which has been assigned to each element within the target. Where a target includes elements having different protection levels, the target is preferably assigned a protection level which is equal to the greatest protection level of any element in that target.
If the user's clearance level satisfies these requirements, next, an inquiry is made as to whether the user has a need-to-know (NTK) authorization for the target/operation. Preferably, the analysis as to whether the user has proper NTK includes or consists of determining whether the user has the appropriate credentials (e.g., user name/password information). In addition, DSA checks to determine whether the target has been assigned an NTK which includes the user/operation within the request.
In addition, a target/operation/user rule may have a particular time constraint, and so a decision may be made regarding whether the request is received within any applicable time constraints. In addition, optionally, a decision can be made regarding whether the time that the user attempts to perform the operation in a granted request is within any applicable time constraint.

In addition, as discussed herein, roles can be employed to simplify NTK assignment. For example, if a group of people all has NTK with respect to performance of one or more operation on a group of targets, a role can be established which includes a rule stating that persons having such role are permitted to perform that one or more operation on that group of targets. If a user within the group of people to whom the role is established successfully performs I&A and provides the necessary credentials for such role (and has a clearance level which meets or exceeds the protection level assigned to any elements within the target), the user is entitled to perform any of such operations on any of such elements. Also, multiple roles can be assigned to particular users, e.g., a second role can be assigned, in addition to the first role, to provide such users access to information beyond that which is available to users within the first role.

Optionally, a user can be alerted at any time to all elements for which that user's clearance level meets or exceeds the various elements' protection levels. For example, the user's graphical user interface might display all elements for which the user's clearance level meets or exceeds such elements' protection levels, even though such user ultimately would be unable to perform any operations on some of such elements (e.g., because the user does not have NTK with respect to such elements). Accordingly, one preferred sequence is that the user can see an icon for a target on his or her screen (i.e., the user has a clearance level which meets or exceeds the protection level for the target), request an operation on the target, and supply his or her credentials for a role which has rights to perform that operation on the target.

Preferably, rules (protection level/NTK/any time constraints, etc.) applied to particular elements are stored as binary bitmaps in a virtual resource representation by the virtual resource manager process, thereby providing a method for rapidly determining whether a request should be granted or rejected. For example, if the bitmap does not match the request, the request is rejected; if the bitmap does match, that portion of the request is accepted.

It is widely recognized that different domains frequently employ differing protection level schemes. In order to facilitate handling requests which depend on determining whether particular users satisfy the protection levels in different domains, DSA preferably includes protection level mapping processes. Preferably, in such mapping, the system administrator for each domain performs initial mapping between protection levels with its domain relative to those in other respective domains. It is preferred that the domain that is sending an element to another domain perform mapping, such that it provides the receiving domain with information as to protection level within the protection level scheme of the receiving domain.

The inter-process location transparency (IPLT) of DSA, also known as the secure name server, restricts access between DSA functional components such that only those components having a defined functional responsibility to inter-communicate are allowed to determine the location information of another component. IPLT can thereby ensure, for example, that only specific domain processes can communicate with the inter-domain access control. Any DSA process must go to IPLT to obtain location information of other processes, and IPLT will not release such information to any process that is not designed to communicate with such other process.

One aspect of the present invention is directed to a method of processing a request from a requestor, comprising:

receiving from a requestor a first request comprising at least one desired operation set of indicia and at least one target identification set of indicia, the desired operation set of indicia comprising a set of indicia which is representative of at least one desired operation, each the target identification set of indicia comprising a set of indicia which is representative of a target, the target comprising at least one element, the element comprising an information set of indicia, the information set of indicia being representative of information;

determining whether a local domain contains all of the at least one element in the target, the local domain comprising at least one processor;

if the local domain contains all of the at least one element in the target:
(1) if the local domain contains a rule for each element in the target indicating that the requester is authorized to perform the desired operation on the element:
   (a) enabling a first agent to access the at least one element to perform the desired operation, and
   (b) transmitting to the requestor a first agent location set of indicia, the first agent location set of indicia enabling the requestor to access the first agent;
(2) if the local domain does not contain a rule for each element in the target indicating that the requestor is authorized to perform the desired operation on the target:
   (a) denying the request;

if the local domain contains at least one element in the target but does not contain all of the at least one element in the target:
(1) if the local domain contains a rule for each the element contained in the local domain indicating that the requestor is authorized to perform the desired operation on the at least one element in the target:
   (a) creating a second request, the second request comprising (1) the at least one desired operation set of indicia and (2) a secondary target identification set of indicia comprising a set of indicia which is representative of all elements which are both (i) contained in the target and (ii) not contained in the local domain; and
(2) if the local domain does not contain a rule for each element contained in the local domain indicating that the requestor is authorized to perform the desired operation on the target:
   (a) denying the request.

Another aspect of the present invention is directed to a method of processing a request from a requestor, comprising:

receiving from a requestor a first request comprising at least one desired operation set of indicia and at least one target identification set of indicia, the desired operation set of indicia comprising a set of indicia which is representative of at least one desired operation, each the target identification set of indicia comprising a set of indicia which is representative of a target, the target comprising at least one element, the element comprising an information set of indicia, the information set of indicia being representative of information;

determining whether a local domain contains all of the at least one element in the target, the local domain comprising at least one processor;

if the local domain contains all of the at least one element in the target:
(a) enabling a first agent to access the at least one element to perform the desired operation, and
(b) transmitting to the requestor a first agent location set of indicia, the first agent location set of indicia enabling the requestor to access the first agent; and

if the local domain does not contain all of the at least one element in the target:
(a) creating a second request, the second request comprising (1) the at least one desired operation set of indicia and (2) a secondary target identification set of indicia comprising a set of indicia which is representative of all elements which are both (i) contained in the target and (ii) not contained in the local domain.

Another aspect of the present invention is directed to a method of processing a request from a requestor, comprising:

receiving from a requestor a first request comprising at least one desired operation set of indicia and a requested target identification set of indicia, the desired operation set of indicia comprising a set of indicia which is representative of at least one desired operation, the requested target identification set of indicia comprising a set of indicia which is representative of a requested target, the requested target comprising at least one element, the element comprising an information set of indicia, the information set of indicia being representative of information;

determining whether a local domain contains all of the at least one element in the requested target, the local domain comprising at least one processor;

if the local domain contains all of the at least one element in the requested target:
(1) if the local domain contains a rule for each element in the target indicating that the requestor is authorized to perform the desired operation on the element:
   (a) enabling a local domain agent to access the at least one element to perform the desired operation, and
   (b) transmitting to the requestor a local domain agent location set of indicia, the local domain agent location set of indicia enabling the requester to access the local domain agent;
(2) if the local domain does not contain a rule for each element in the target indicating that the requestor is authorized to perform the desired operation on the at least one element:
   (a) denying the request;

if the local domain contains at least one element in the target but does not contain all of the at least one element in the target:
(1) if the local domain does not contain a rule for each element in the local domain indicating that the requestor is authorized to perform the desired operation on the at least one element contained in the local domain:
   (a) denying the request;
(2) if the local domain contains a rule for each the element contained in the local domain indicating that the requestor is authorized to perform the desired operation on the element contained in the local domain:
   (a) creating a second request, the second request comprising (1) the at least one desired operation set of indicia and (2) a secondary target identification set of indicia comprising a set of indicia which is representative of all elements which are both (i) contained in the target and (ii) not contained in the local domain; and
   (b) transmitting the second request to a second domain;
   (c) determining whether the second domain contains all of the at least one element in the secondary target, the second domain comprising at least one processor;
   (d) if the second domain contains all of the at least one element in the secondary target:
      (1) if the second domain contains a rule for each the element in the secondary target indicating that the requester is authorized to perform the desired operation on each the element in the secondary target:
         (a) enabling the second domain agent to access all elements which are both (i) contained in the requested target and (ii) contained in the second domain;
         (b) transmitting to the local domain a second domain agent location set of indicia, the second domain agent location set of indicia enabling a local domain agent to access the second domain agent;
         (c) enabling the local domain agent to:
         (i) access any elements which are both contained in the requested target and contained in the local domain; and
         (ii) access, via the second domain agent, all elements which are both contained in the requested target and contained in the second domain; and
         (d) transmitting to the requestor a local domain agent location set of indicia, the local domain agent location set of indicia enabling the requestor to access the local domain agent;
      (2) if the local domain does not contain a rule for each element contained in the local domain indicating that the requestor is authorized to perform the desired operation on the target:
         (a) denying the request;

if the local domain contains none of the at least one element in the target:
(1) creating a second request, the second request comprising (a) the at least one desired operation set of indicia and (b) a secondary target identification set of indicia comprising a set of indicia which is representative of all elements which are contained in the target; and
(2) transmitting the second request to a second domain;
(3) determining whether the second domain contains all of the at least one element in the secondary target, the second domain comprising at least one processor;
(4) if the second domain contains all of the at least one element in the secondary target:
   (a) if the second domain contains a rule for each the element in the secondary target indicating that the requestor is authorized to perform the desired operation on each the element in the secondary target:
      (1) enabling the second domain agent to access all elements which are contained in the requested target;
      (2) transmitting to the local domain a second domain agent location set of indicia, the second domain agent location set of indicia enabling a local domain agent to access the second domain agent;
      (3) enabling the local domain agent to access, via the second domain agent, all elements which are contained in the second domain; and
      (4) transmitting to the requestor a local domain agent location set of indicia, the local domain agent location set of indicia enabling the requester to access the local domain agent;
   (b) if the local domain does not contain a rule for each element contained in the local domain indicating that the requestor is authorized to perform the desired operation on the target:
      (1) denying the request.

Another aspect of the present invention is directed to a method of processing a request from a requestor, comprising:

receiving from a requestor a first request comprising at least one desired operation set of indicia and a requested target identification set of indicia, the desired operation set of indicia comprising a set of indicia which is representative of at least one desired operation, the requested target identification set of indicia comprising a set of indicia which is representative of a requested target, the requested target comprising at least one element, the element comprising an information set of indicia, the information set of indicia being representative of information;

determining whether a local domain contains all of the at least one element in the requested target, the local domain comprising at least one processor;

if the local domain contains all of the at least one element in the requested target:
(a) enabling a local domain agent to access the at least one element to perform the desired operation, and
(b) transmitting to the requestor a local domain agent location set of indicia, the local domain agent location set of indicia enabling the requestor to access the local domain agent;

if the local domain does not contain all of the at least one element in the requested target:
(a) creating a second request, the second request comprising (1) the at least one desired operation set of indicia and (2) a secondary target identification set of indicia comprising a set of indicia which is representative of a secondary target, the secondary target comprising all elements which are both (i) contained in the requested target and (ii) not contained in the local domain; and
(b) transmitting the second request to a second domain;
(c) determining whether the second domain contains all of the at least one element in the secondary target, the second domain comprising at least one processor;
(d) if the second domain contains all of the at least one element in the secondary target:
   (1) enabling the second domain agent to access all elements which are both (i) contained in the requested target and (ii) contained in the second domain;
   (2) transmitting to the local domain a second domain agent location set of indicia, the second domain agent location set of indicia enabling a local domain agent to access the second domain agent;
   (3) enabling the local domain agent to:
      (a) access any elements which are both (i) contained in the requested target and (ii) contained in the local domain; and
      (b) access, via the second domain agent, all elements which are both (i) contained in the requested target and (ii) contained in the second domain; and
   (4) transmitting to the requestor a local domain agent location set of indicia, the local domain agent location set of indicia enabling the requestor to access the local domain agent.

Another aspect of the present invention is directed to a method of processing a request from a requestor, comprising:

receiving from a requester a first request comprising at least one desired operation set of indicia and a requested target identification set of indicia, the desired operation set of indicia comprising a set of indicia which is representative of at least one desired operation, the requested target identification set of indicia comprising a set of indicia which is representative of a requested target, the requested target comprising at least one element, the element comprising an information set of indicia, the information set of indicia being representative of information;

determining whether a local domain contains all of the at least one element in the requested target, the local domain comprising at least one processor;

if said local domain contains all of said at least one element in said requested target and said local domain contains a rule for each element in said requested target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;

if said local domain contains all of said at least one element in said requested target and said local domain does not contain a rule for each element in said requested target indicating that said requestor is authorized to perform said desired operation on said element:
(a) denying said request;

if said local domain does not contain all of said at least one element in said requested target:
(a) if said local domain contains at least one of said at least one element in said requested target and said local domain does not contain a rule for each element in said requested target indicating that said requester is authorized to perform said desired operation on said element, denying said request; otherwise:
(b) creating a current request, said current request comprising (1) said at least one desired operation set of indicia, and (2) a current target identification set of indicia comprising a set of indicia which is representative of a current target set, said current target set comprising all elements (which can consist of one or more elements) which are both (i) contained in said requested target and (ii) not contained in said local domain; and
(c) transmitting said current request to a next domain, said next domain comprising at least one processor;

if said request has not been denied, repeating a sub-routine comprising:
(1) determining whether said next domain contains all elements in said current target set;
(2) if said next domain contains all of said elements in said current target set and said next domain does not contain a rule for each element in said current target set indicating that said requestor is authorized to perform said desired operation on said element, denying said request;
(3) if said next domain contains all of said elements in said current target set and said next domain contains a rule for each element in said current target set indicating that said requestor is authorized to perform said desired operation on said element:
   (a) enabling a first non-local agent to access said elements in said current target set,
   (b) transmitting to a next prior domain a first non-local agent location set of indicia, said first non-local agent location set of indicia enabling a next prior domain agent to access said first non-local agent;
   (c) unless said next non-local agent location set of indicia has reached said local domain, repeating a step of:
      (i) enabling said next prior domain agent to access any elements which are both contained in said requested target and contained in said next prior domain; and
      (ii) transmitting to said next prior domain a next non-local agent location set of indicia, said next non-local agent location set of indicia enabling said next prior domain agent to access said next non-local agent;
   until said next non-local agent location set of indicia reaches said local domain; and
   (d) enabling said local domain agent to access any elements which are both contained in said requested target and contained in said local domain; and transmitting to said requestor a local domain agent location set of indicia, said local domain agent location set of indicia enabling said requestor to access said local domain agent;
(4) if said next domain contains at least one of said elements in said current target set and said next domain does not contain a rule for each element in said next domain and in said current target set indicating that said requestor is authorized to perform said desired operation on said element in said next domain and in said current target set, denying said request; otherwise:
(5) if said next domain does not contain all of said elements in said current target set:
   (a) creating a next request, said next request comprising (1) said at least one desired operation set of indicia, and (2) a new current target identification set of indicia comprising a set of indicia which is representative of a new current target set, said new current target set comprising all elements which were (i) contained in said requested target, (ii) not contained in said local domain, and (iii) not contained in any domain to which a current request has been transmitted; and
   (b) transmitting said next request to a next domain,

until (1) a non-local agent location set of indicia is transmitted to said local domain agent, or (2) said repeating of said sub-routine is terminated.

In a representative example of a method according to this aspect of the present invention, assume that there are five domains (domain 1, domain 2, domain 3, domain 4 and domain 5), and a requestor in domain 1 requests a read operation on a target which has a total of six elements, including one element (element one) in domain 1, two elements (elements two and three) in domain 2, no elements in domain 3, three elements in domain 4 (elements four, five and six), and no elements in domain 5. Also, assume that each of the domains which contain one or more of the elements have rules which authorize the requestor to perform a read operation on the element(s) within the respective domain.

Domain 1 receives from the requestor a request (the “first request”) comprising at least one desired operation set of indicia and a requested target identification set of indicia, the desired operation set of indicia comprising a set of indicia which is representative of at least one desired operation (namely, a read operation), the requested target identification set of indicia comprising a set of indicia which is representative of a requested target (namely, the target including the six elements), each of the six elements comprising an information set of indicia, the information set of indicia being representative of information contained in such elements (e.g., transcribed text).

Domain 1 determines whether domain 1 contains all of the elements in the requested target—it does not, as it contains only the first element. (If domain 1 did contain all of the elements in the requested target and domain 1 contained a rule for each element in the requested target indicating that the requestor is authorized to perform the desired operation on the element, a local domain agent (local to domain 1, where the requester is located) would be created and enabled to access the element(s) in the target to perform the desired operation, and a local domain agent location set of indicia would be transmitted to the requester, the local domain agent location set of indicia enabling the requestor to access the local domain agent.) (If domain 1 contained all of the elements in the requested target and domain 1 did not contain a rule for each element in the requested target indicating that the requestor is authorized to perform the desired operation on the element, the request would be denied and no further communication would be sent to the requestor.)

Domain 1 then determines whether domain 1 contains at least one (but not all) of the elements in the requested target. It does—element 1. Domain 1 then determines whether domain 1 contains a rule for element 1, indicating that the requestor is authorized to perform the desired operation on the element. It does. (If it did not, the request would be denied and the requestor would receive no further communication.) Domain 1 then creates a current request, the current request comprising (1) the at least one desired operation set of indicia (indicating a read operation), and (2) a current target identification set of indicia comprising a set of indicia which is representative of a current target set, the current target set comprising all elements (which can consist of one or more elements) which are both (i) contained in the requested target and (ii) not contained in domain 1 (the local domain, i.e., the domain in which the request originated), namely, elements two, three, four, five and six; and domain 1 transmits the current request to a next domain, namely, domain 2.

Then, a sub-routine is repeated, as described below.

In the first iteration of the sub-routine, the second domain (now the “next domain”) will determine that it does not contain all of the elements in the current target set, that it contains one element of the current target set (i.e., element 2), and that it contains a rule authorizing the requestor to perform a read operation on that element of the current target set. The second domain creates a new request (now the “next request”), this request comprising (1) the at least one desired operation set of indicia (indicating a read operation), and (2) a new current target identification set of indicia comprising a set of indicia which is representative of a new current target set, the new current target set comprising elements 3-6, i.e., all elements which were (i) contained in the requested target, (ii) not contained in the first domain, and (iii) not contained in any domain to which a current request has been transmitted (i.e., the second domain). The second domain transmits this request (the “next request”) to a next domain (now the third domain), and another iteration of the sub-routine is performed.

In the second iteration of the sub-routine, the third domain (now the “next domain”)) will determine that it does not contain all of the elements in the current target set, and that it contains none of the elements of the current target set (i.e., none of elements 3-6). The third domain creates a new request (now the “next request”), this request comprising (1) the at least one desired operation set of indicia (indicating a read operation), and (2) a new current target identification set of indicia comprising a set of indicia which is representative of a new current target set, the new current target set comprising elements 3-6, i.e., all elements which were (i) contained in the requested target, (ii) not contained in the first domain, and (iii) not contained in any domain to which a current request has been transmitted (i.e., the second and third domains). The third domain transmits this request (the “next request”) to a next domain (now the fourth domain), and another iteration of the sub-routine is performed.

In the third iteration of the sub-routine, the fourth domain (now the “next domain”) will determine that does contain all of the elements in the current target set, and that it contains a rule authorizing the requestor to perform a read operation on each element of the current target set. The fourth domain then enables a first non-local agent (i.e., a fourth domain agent) to access the elements in the current target set, and it transmits to a next prior domain (i.e., the third domain) a first non-local agent location set of indicia, the first non-local agent location set of indicia enabling a next prior domain agent to access the fourth domain agent.

Then, until a next non-local agent location set of indicia reaches the first domain, a step is repeated, the step comprising (i) enabling the next prior domain agent to access any elements which are both contained in the requested target and contained in the next prior domain; and (ii) transmitting to the next prior domain a next non-local agent location set of indicia, the next non-local agent location set of indicia enabling a next prior domain agent to access the next non-local agent.

Thus:
the next prior domain agent (i.e., a third domain agent) is enabled to access any elements contained in the requested target and contained in the third domain (there are none) and a next non-local agent location set of indicia, i.e., the location of the third domain agent, is transmitted to the next prior domain, i.e., the second domain, enabling a next prior domain agent, i.e., a second domain agent, to access the third domain agent, and then
the next prior domain agent (i.e., now the second domain agent) is enabled to access any elements contained in the requested target and contained in the second domain (i.e., elements 2 and 3) and a next non-local agent location set of indicia, i.e., the location of the second domain agent, is transmitted to the next prior domain, i.e., the first domain, enabling a next prior domain agent, i.e., a first domain agent, to access the second domain agent (i.e., a next non-local agent location set of indicia has now reached the first domain).

Then, the first domain agent is enabled to access any elements which are both contained in the requested target and contained in the first domain (i.e., element 1); and a first domain agent location set of indicia is transmitted to the requestor, the first domain agent location set of indicia enabling the requestor to access the first domain agent and thereby obtain elements 1-6, thus completing the desired read operation.

Another aspect of the present invention is directed to a method of processing a request from a requestor, comprising:

receiving from a requestor a first request comprising at least one desired operation set of indicia and a requested target identification set of indicia, the desired operation set of indicia comprising a set of indicia which is representative of at least one desired operation, the requested target identification set of indicia comprising a set of indicia which is representative of a requested target, the requested target comprising at least one element, the element comprising an information set of indicia, the information set of indicia being representative of information;

determining whether a local domain contains all of the at least one element in the requested target, the local domain comprising at least one processor;

if the local domain contains all of the at least one element in the requested target and the local domain contains a rule for each element in the requested target indicating that the requester is authorized to perform the desired operation on the element:
(a) enabling a local domain agent to access the at least one element to perform the desired operation;

if the local domain contains all of the at least one element in the requested target and the local domain does not contain a rule for each element in the requested target indicating that the requestor is authorized to perform the desired operation on the element:
(a) denying the request;

if the local domain does not contain all of the at least one element in the requested target:
(a) if the local domain contains at least one of the at least one element in the requested target and the local domain does not contain a rule for each element in the requested target indicating that the requestor is authorized to perform the desired operation on the element, denying the request; otherwise:
(b) creating a current request, the current request comprising (1) the at least one desired operation set of indicia; and (2) a current target identification set of indicia comprising a set of indicia which is representative of a current target set, the current target set comprising all elements (which can consist of one or more elements) which are both (i) contained in the requested target and (ii) not contained in the local domain; and
(c) transmitting the current request to a next domain, the next domain comprising at least one processor;

if the request has not been denied, repeating a sub-routine comprising:
(1) determining whether the next domain contains all elements in the current target set;
(2) if the next domain contains all of the elements in the current target set and the next domain does not contain a rule for each element in the current target set indicating that the requestor is authorized to perform the desired operation on the element, denying the request;
(3) if the next domain contains all of the elements in the current target set and the next domain contains a rule for each element in the current target set indicating that the requestor is authorized to perform the desired operation on the element:
   (a) enabling a first non-local agent to access the elements in the current target set,
(4) if the next domain contains at least one of the elements in the current target set and the next domain does not contain a rule for each element in the next domain and in the current target set indicating that the requestor is authorized to perform the desired operation on the element in the next domain and in the current target set, denying the request; otherwise:
(5) if the next domain does not contain all of the elements in the current target set:
   (a) creating a next request, the next request comprising (1) the at least one desired operation set of indicia, and (2) a new current target identification set of indicia comprising a set of indicia which is representative of a new current target set, the new current target set comprising all elements which were (i) contained in the requested target, (ii) not contained in the local domain, and (iii) not contained in any domain to which a current request has been transmitted; and
   (b) transmitting the next request to a next domain,

until the repeating of the sub-routine is terminated.

Another aspect of the present invention is directed to a method of processing a request from a requestor, comprising:

receiving from a requestor a request comprising at least one desired operation set of indicia and at least one target identification set of indicia, the desired operation set of indicia comprising a set of indicia which is representative of at least one desired operation, each the target identification set of indicia comprising a set of indicia which is representative of a target, the target comprising at least one element, the element comprising an information set of indicia, the information set of indicia being representative of information;

determining whether a local domain contains all of the at least one element in the target, the local domain comprising at least one processor;

if the local domain contains all of the at least one element in the target:
(1) if the local domain contains a rule for each element in the target indicating that the requestor is authorized to perform the desired operation on the element:
   (a) enabling a local domain agent to access the at least one element to perform the desired operation, and
   (b) transmitting to the requestor a local domain agent location set of indicia, the local domain agent location set of indicia enabling the requestor to access the local domain agent;
(2) if the local domain does not contain a rule for each element in the target indicating that the requestor is authorized to perform the desired operation on the target:
   (a) denying the request; and

if the local domain does not contain all of the at least one element in the target:
(a) denying the request.

Another aspect of the present invention is directed to a method of transmitting at least one set of indicia representative of information from a first domain to a second domain comprising:

transmitting at least one set of indicia representative of information from a first virtual address in a first domain to a second virtual address in the first domain, the first domain comprising at least a first processor, and then

transmitting the set of indicia representative of information from the second virtual address in the first domain to a second domain via a first physical address in the first domain, the second domain comprising at least a second processor.

Another aspect of the present invention is directed to a method comprising determining whether a requestor is authorized to perform a desired operation on a target comprising at least one element, the element comprising an information set of indicia, by:

(1) comparing a stored clearance level for the requester with a stored protection level for the element;

(2) performing at least one step selected from among (a) determining whether a stored NTK for the requestor includes performing the desired operation on the at least one element and (b) determining whether a stored NTK for the element includes performance of the desired operation by the requester; and

(3) receiving from the requestor at least one credential set of indicia, the credential set of indicia comprising indicia selected from the group consisting of indicia input by the requestor and indicia derived from the requester, and comparing the credential set of indicia with at least one set of stored credential indicia for the requestor.

Another aspect of the present invention is directed to a method of processing a request from a requester, comprising:

receiving from a requestor a request comprising at least one desired operation set of indicia and at least one target identification set of indicia, the desired operation set of indicia comprising a set of indicia which is representative of at least one desired operation, each the target identification set of indicia comprising a set of indicia which is representative of a target, the target comprising at least one element, the element comprising an information set of indicia, the information set of indicia being representative of information;

enabling an agent in a first domain to access the at least one element in the first domain to perform the desired operation, and

transmitting to the requestor a first domain agent location set of indicia, the first domain agent location set of indicia representing a location of the first domain agent;

wherein no application which is not an agent can access protected data within the first domain.

The present invention is further directed to any of the methods described herein, wherein the methods are computer-implemented.

The present invention is further directed to apparatus for carrying out any of the methods described herein.

The present invention is further directed to computer-readable media having computer-executable commands for performing any of the methods described herein.

The present invention is further directed to computer-readable media comprising computer instructions which, when executed by a computer, perform any of the methods described herein.

The present invention is further directed to processors on which is stored software for carrying out any of the methods described herein.

As can readily be appreciated, the methods and apparatus in accordance with the present invention can be used in connection with any information storage scenario, regardless of the precise kind of information, form of information, and regardless of whether, and/or the precise way in which, different groups of people are desired to be granted different access privileges with respect to the information.

The invention may be more fully understood with reference to the accompanying drawings and the following detailed description of the invention.

### BRIEF DESCRIPTION OF THE DRAWING FIGURES

FIG. 1 is a schematic representation illustrating the theory of operation of a particular example of a DSA system in a single domain.

FIG. 2 is a schematic representation illustrating the theory of operation for an embodiment of a multiple-domain DSA system according to the present invention.

FIG. 3 is a schematic representation illustrating the nature of an example of a client access layer for network-aware application integration.

FIG. 4 is a schematic representation illustrating the nature of an example of a thin data layer for database application integration.

FIG. 5 is a schematic representation illustrating an example of a DSA interface with a host having a filesystem upon which protected data resides.

FIG. 6 is a schematic representation illustrating an example of a DSA interface with a host having a database upon which protected data resides.

FIG. 7 is a schematic representation illustrating an example of a DSA request handling and processing interface.

FIG. 8 is a schematic representation illustrating an example of a DSA inter-domain interface.

FIG. 9 is a schematic representation illustrating preferred sequenced flows among the DSA functions that participate in the system's initialization state in a representative embodiment.

FIG. 10 is a schematic representation illustrating preferred sequenced flows among the DSA functions that participate in the system's request processing mode during an enabled state in a representative embodiment.

FIG. 11 is a schematic representation illustrating the physical architecture for a representative embodiment of a DSA system.

### DETAILED DESCRIPTION OF THE INVENTION

The following is a description of the features and components that can be included in apparatus and software in accordance with the present invention, and a description of methods which can be performed in accordance with the present invention. This description establishes functional, performance, and design requirements which can be included in a Distributed Security Architecture (DSA) according to the present invention.

As reflected below, the apparatuses, software packages and methods according to the present invention (referred to herein as “DSA”, “DSAs and/or “the DSA”) can generally include any desired combination of the features, components and method steps described herein, and for many of the features, components and method steps described herein there are alternative choices from which selection can be made, even though there is a description below of a specific embodiment of a system which falls within the scope of the present invention.

The DSAs according to the present invention are a high-assurance data security product whose purpose is to provide the following services:
data protection via enforcement of policy-based access control. The DSA explicitly grants permission to perform read/write and subscribe/publish operations on data that concurrently resides in one or more protected domains, where in the latter case the data is distributed across multiple security domains;
identification and authentication of requestors; and
confidentiality of source(s), and of data.
   The DSAs according to the present invention are unique in their ability to perform a single, distributed access control decision across multiple protected domains without compromising confidentiality of sources and data across domain boundaries. In a multiple-domain scenario, one access control decision is distributed such that partial decisions are independently made in each domain that owns a portion of the required information. The result is a securely coordinated end-to-end access control decision that protects the confidentiality of each participating domain's sources and data.

Because the DSA internal architecture is comprised of a set of distributed software components, the entire architecture is designed such that the security of the DSA system itself is highly assured.

Glossary of Terms

Clearance Level—The Clearance Level is a label assigned to a user that represents the highest Protection Level of data that the user is allowed to access in DSA. To access data, a user's Clearance Level must be greater than or equal to the Protection Level of the data requested. The definition of “greater than” refers to the level of sensitivity of data. (See Protection Level).

Domain—A Domain in the DSA is a collection of one or more processors, preferably including all Requestors, data Targets, network devices, and physical network paths for which a Security Policy is defined and enforced. All data Targets in a Domain are physically reachable via paths within the Domain. The Targets in a Domain are highly protected from being viewed and accessed by unauthorized Requestors. Different Domains can have their own Security Policies running different instances of DSA.

Element—The smallest unit of data that can be protected in a DSA system, and as such, the most granular type of data Target in the system.

Indicia—“Indicia,” as used herein, refers to anything that can be used to convey information, e.g., an electronic signal (such as a digital sequence), an analog item or sequence (e.g., a bar code or a biometric representation), a chemical (e.g., a DNA strand) or sequence of chemicals, a biological entity or sequence of entities, a morse code transmission, a sequence of keystrokes, etc.

Information—“Information” as used herein broadly refers to any desired kind of information in any form (e.g., documents, images, recordings, facts, records, data, databases, formulae, computer programs, software, lists, samples, etc.).

Input—“Input” refers to something entered by or on behalf of an entity, e.g., a user, an application residing on a machine, etc.

Need To Know—“Need To Know” is a data security attribute that allows the system to further restrict data access to only users that are uniquely associated (via Credentials) with a “Need To Know” attribute. The use of “Need To Know” allows the system more granularity of access control to data Targets within a Protection Level. A practical example of its use is to assign a “Mission”-based Need to Know to a data Target, so that only users associated with that “Mission” are considered as eligible for access when the system ultimately makes its access decision based on all other conditions/rules that apply.

Operation—The “Operations” in security policy rules are the operations that the system specifically defines as valid (or invalid) to be performed on particular “Targets” in the system. Examples of requested data transfer Operations in a DSA-controlled system include “Publish”, “Subscribe”, “Read”, and “Write”. “Subscribe” and “Read” are both “pull” in nature, whereas “Publish” and “Write” both “push” a Target to a location in a system.

Protection Level—A Protection Level is a hierarchical level of sensitivity of the data Targets protected in DSA. Preferably, the “highest level” of a Protection Level hierarchy is the label that is assigned to the “most sensitive” data to be protected (i.e., the more sensitive data is, the higher the Protection Level assigned to it).

Request—A Request is an object issued by a Requestor to DSA that formally declares the Operation that the Requestor desires to perform and the data Target on which the Requestor wishes to perform the operation. DSA processes each Request and must explicitly grant the Request before the Requestor is given privilege to perform the desired Operation on a data Target.

Requestor/User—The “Requestor” in a security policy rule is the entity requesting access to protected resources. Some embodiments of DSAs require that all Requestors must have credentials that uniquely identify and authenticate them to the system. Requestors in DSA may be individuals or systems, but preferably are software processes or applications that operate on behalf of the individuals or systems to which they belong. Alternatively, a Requestor may be a trusted proxy that makes requests on behalf of other software application(s) that cannot make their own requests. Requestors may be associated with Roles (described below) for streamlining policy rule declarations. A requestor can be any entity, e.g., an individual, a software application, a machine, etc.

Security Policy—A Security Policy contains explicit rules that state the mandatory conditions that must be met prior to granting a Requestor access to a particular data target in a system. Security policy rules may be expressed using any one of several formal security policy specification languages.

DSA Security Policy Rule—A DSA Security Policy Rule specifies that a particular “user” or “Role” can perform an “Operation” on a data “Target”, with an optional constraint on “Time”. Valid Operations include “Read”, “Write”, “Publish”, and “Subscribe”. Valid “Time Constraints” include options for “granted between two specified date/times”, “granted before a specified date/time”, or “granted after a specified date/time”.

DSA System Access Control Policy—A collection of rules which form the basis for granting or denying a Request. For example, a DSA System Access Control Policy for a specific embodiment can include the following rules:
A user is granted access to perform an Operation on a Target if and only if all of the following conditions are TRUE:
1. The user's Authentication Token is valid in the Domain at the Time of the Request, and at the Time of the Operation.
2. The user provided all valid additional identification Credentials that the system required for their session.
3. The system gives the user the privilege of performing the requested Operation on the specified data Target, at the Time of the enforcement decision, and at the time of the Operation.
4. There are no Time Constraints associated with access to the requested data Target that prevent the user from accessing the Target at the Time of the Operation.
5. The user's Clearance Level is greater than, or equal to, the hierarchical Protection Level assigned to the requested data Target, at the Time of the Request and at the Time of the access Operation.
6. The data Target exists in the Domain, at the Time of the Request, and at the Time of the access Operation.

Target—A data “Target” in a security policy rule is identified by a named Descriptor for an access-controlled data entity in the system. A Target has greater granularity than a file, because a file may be comprised of multiple Elements. Target Descriptors are only limited by the most granular Element that must be individually protected in a system. A data Target may be physically distributed over multiple security Domains, each Domain having its own Security Policy.

Purposes and Objectives of DSA Systems, and Operational Concepts of DSA Systems

Top Level Description

Providing security to prevent unauthorized access to user data in a distributed system is quite different from that in centralized systems. Preferably, the trust management system not only provides security, but also is able to scale to huge environments. The system preferably supports authentication and delegation of rights.

The DSA preferably provides a strong security enforcement layer placed between a system's data and the potential producers and consumers of that data. In a multi-domain system, the security layer provided by the DSAs strictly controls access to all data in a distributed system by enforcing the explicit security policy rules of each domain in the distributed system. A DSA can perform a single access control decision within one domain, or across multiple domains where each domain is under the control of its own security policy. The DSAs according to the present invention are designed to process access requests from requesters wishing to perform operations on data targets in single or multiple-domain systems.

The defined operations in DSA preferably include at least read, write, publish, and subscribe.

The smallest unit of information that may be protected in a DSA system is an “element” (which is smaller in granularity than a “file”). An element is a user-defined piece of data that the domain owner wishes to protect differently than other elements in a target. A target may therefore be comprised of multiple elements, and the elements of a target may physically be distributed across multiple domains. In multiple-domain systems that utilize this architecture, a separate instance of DSA is preferably the security framework for each domain.

DSA must explicitly and completely grant a request prior to any operations being allowed on any targets, including the case where the target of a request may have elements that are physically distributed across multiple domains. To achieve this, DSA must explicitly enforce the security policy rules of each domain in a multi-domain system. Because a requester is never allowed to have explicit location information for a requested target, either within or outside of its local domain, each DSA Domain must securely manage this location information without divulging it to any user, or to another DSA domain.

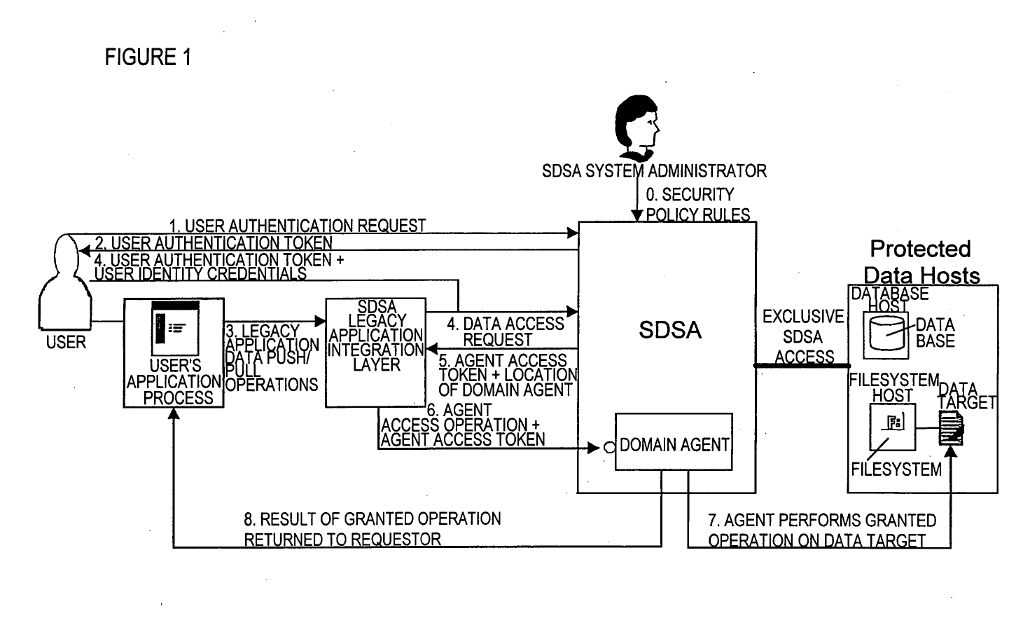

FIG. 1 illustrates the theory of operation of an example of a DSA system in a single domain. Information flows are numerically labeled to correspond with the required sequence of operational events. DSA provides an enforcement barrier between users and protected data that cannot be bypassed by unauthorized users. This is because DSA requires protected data to reside on hosts with secure operating systems that are configured with Mandatory Access Control policies of their own that allow exclusive access to data only through a DSA host. Therefore, a user can get access to protected data if and only if a security policy rule exists in DSA granting such access.

In accordance with preferred embodiments:
users must first access DSA to unequivocally identify and authenticate their identity to the system;
to request access to a data target, a user must then submit a user authentication token they were provided by the system (after identifying and authenticating their identity), along with a set of specific identity credentials unique to them and known by the system, along with their request to perform an operation on a target. This Request may originate from two possible sources:
   1. The user may have an existing (legacy) network-aware application that is integrated transparently using a DSA application integration layer component to generate and issue the request to DSA on the application's behalf; and
   2. A DSA-native application that was designed for the customer may issue requests directly from the application.
DSA receives the request, authentication token, and credentials, and verifies that the user is authorized to perform the requested operation on the target within any specified constraints in the domain's security policy. When the operation is granted, DSA then generates a special entity called an “Agent” that is one of the most powerful differentiators of this system. By design, an Agent is given the ability to perform the granted operation on a specific target on behalf of the authorized user. This design construct prevents the user from being given the opportunity to know where the target is actually located. This is intended to prevent one of the most common system security vulnerabilities in today's environment—insider attacks, by never allowing a user to know the location where granted data is coming from, or going to. In DSA, trust is placed in the Agent, not the user. An Agent is allowed to execute any operation that it has the permission to execute. DSA provides the infrastructure to secure all of its Agents. DSA creates and destroys the Agents, including adding and revoking their attributes.

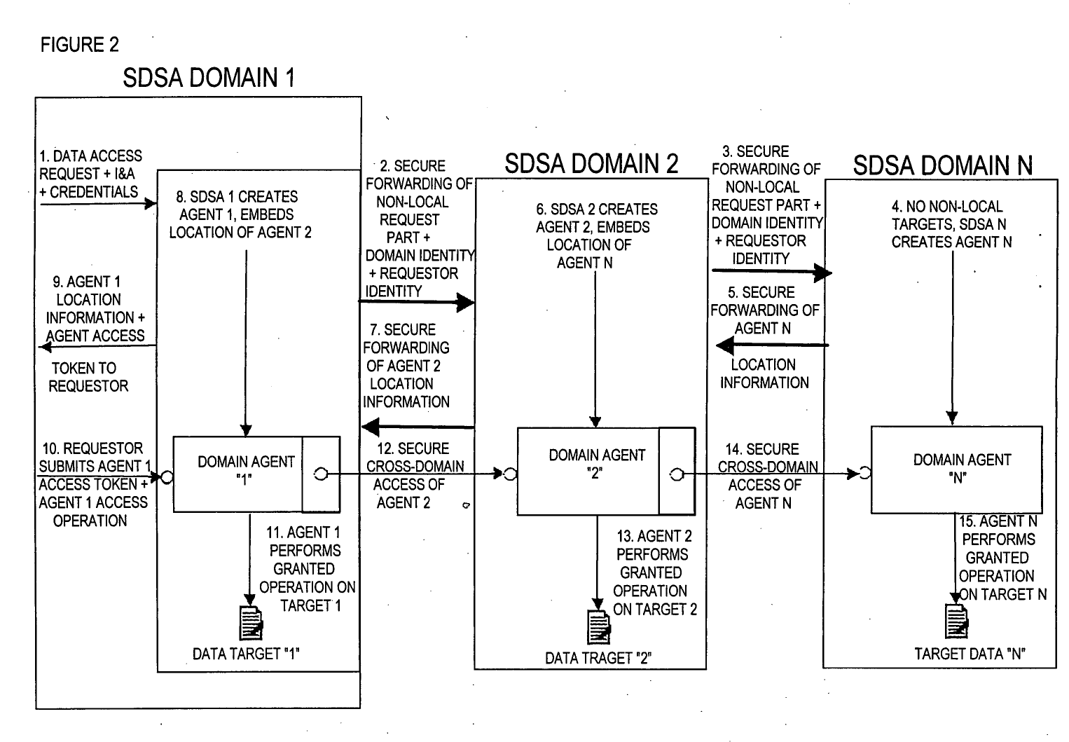

FIG. 2 illustrates the theory of operation for an embodiment of a multiple-domain DSA system. Information flows are numerically labeled to correspond with the required sequence of operational events. DSA restricts all communication between domains to occur only through highly secure DSA-controlled connections that are dynamically established and torn down in each direction, for each instance of communication (shown with bold arrows in FIG. 2). A user never knows that their request may have a target that is physically distributed across multiple domains as illustrated in FIG. 2. Each DSA domain operates independently with its own security policy, and is allowed to instantiate secure cross-domain communications only with other domains that are trusted. Even so, a DSA domain never divulges location information of its local targets across a domain boundary. For the multiple domain case, a request is granted either entirely or not at all. Once all portions of a target are granted in each domain, the last domain in the chain initiates construction of its Agent, and back-propagates the chain all the way to the first domain that issued the original request. The user then may access their local Agent, without knowledge that there is a chain of multi-domain Agents that are actually fulfilling the request in its entirety, across domain boundaries. In this manner, DSA provides cross-domain trust management based upon a chain of trust of an “Agent”, not the user.

External Interfaces

External communication to DSA originates from the user, the user's application process, and/or from external DSA domains that are trusted. All communication external to DSA preferably occur over a network connection to a DSA host, to a DSA process residing on an administrator-selected TCP/IP (transmission control protocol/internet protocol) port above 1000. For example, network connections in the entire system can emanate from standard off-the-shelf computers running a TCP/IP protocol stack, and connected to their respective subnets via standard ethernet interfaces.

In accordance with a preferred aspect of the invention, DSA can accept communication from users in its local domain to identify and authenticate themselves, and to communicate their unique credentials to the system for further identity validation when submitting specific requests for targets. Preferably, users are prompted for their unique identification and authorization (I&A) information, and upon system verification, an authentication token is provided back to the user, who can use this authentication token to initiate secure sessions with the system for data access request processing.

A variety of identification and authentication software packages are well known to those of skill in the art and any of these would be suitable for use according to the present invention. Representative commercially available examples which would be suitable include Kerberos and Session Manager.

In addition, a request can be analyzed to determine whether it is “valid”. Reasons for which a request might be invalid include improper syntax and/or combining push and pull operations in a single request.

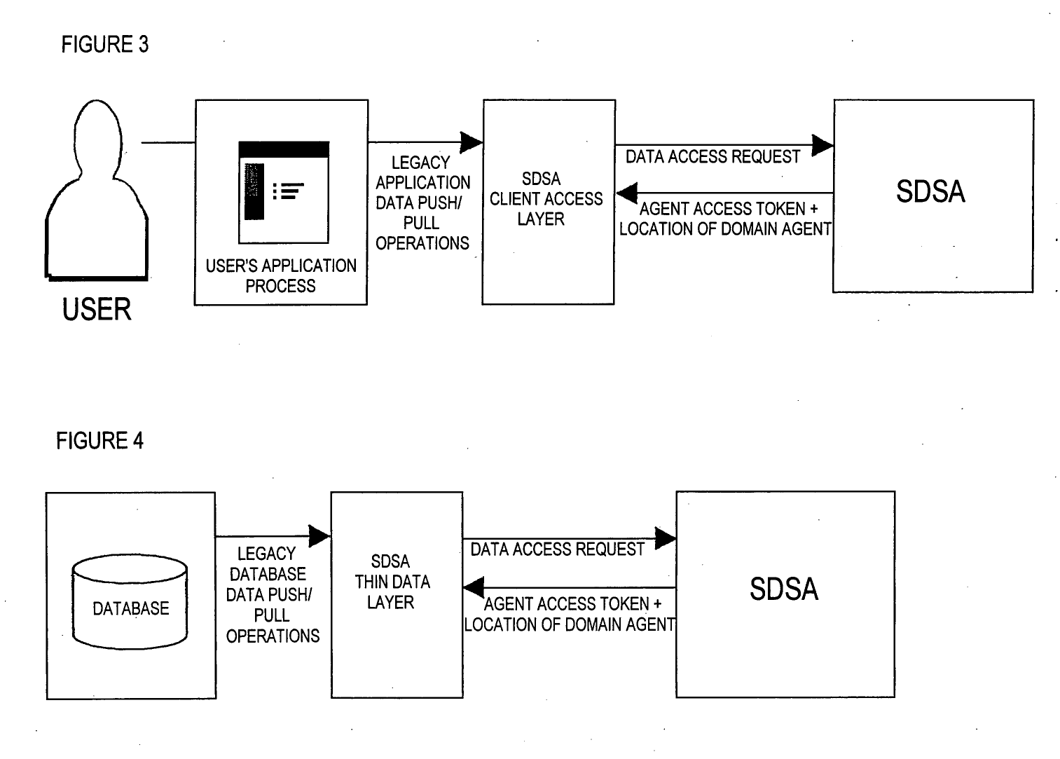

DSA preferably can accept data access requests from user applications running on a user's host computer. In such situations, user applications are preferably not aware of the DSA request processing application programming interface (API), so DSA preferably provides a transparent interface, called a legacy application integration layer, for integration of user applications. The legacy application integration layer is comprised of two types of integration components, namely, network-aware applications and database applications as follows:
Network-Aware User Applications—User applications that are network-aware are already designed to perform push and pull-type operations on data over a network. To integrate these applications, DSA provides a DSA client access layer (CAL). The client access layer is composed of a set of processes that are customized to the individual user application so that the application's native method for accessing data is transparently mapped into the DSA request processing API. The application (and user) is essentially unaware that the DSA is controlling its access to the protected data. FIG. 3 illustrates the nature of a client access layer for network-aware application integration. Each client access layer process may, but does not have to, reside on the same host computer as the user's application process. Representative examples of suitable candidate applications for use as the CAL include the Microsoft Windows Desktop Applications, including Windows Explorer, Microsoft Word, Excel, and PowerPoint, to name a few.
Integration of Database Applications as a User Application—There may be instances where a customer requires that a database application be set up on the user's side of the system and integrated in a manner that allows the database to act like a user application, where it is allowed to push and pull information to and from the system. In order to integrate databases as a user in this manner, DSA can include a DSA thin data layer (TDL), which is composed of a set of processes that are customized to the individual database APIs so that the database's native method for accessing data is transparently mapped into the DSA request processing API, and the database application (and user) is essentially unaware that the DSA is controlling its access to the protected data. FIG. 4 illustrates the nature of a thin data layer for database application integration. Each thin data layer process may, but does not have to, reside on the same host computer as the user's database application process. Representative examples of suitable candidate applications for use as the CAL include Oracle and MySQL, to name a few.

DSA interfaces over a network with the host computers on which the data protected by DSA resides. These protected data hosts may host data that resides on a native file system on the host, or within a database installed on the host. DSA accounts for both of these cases in its interface architecture.

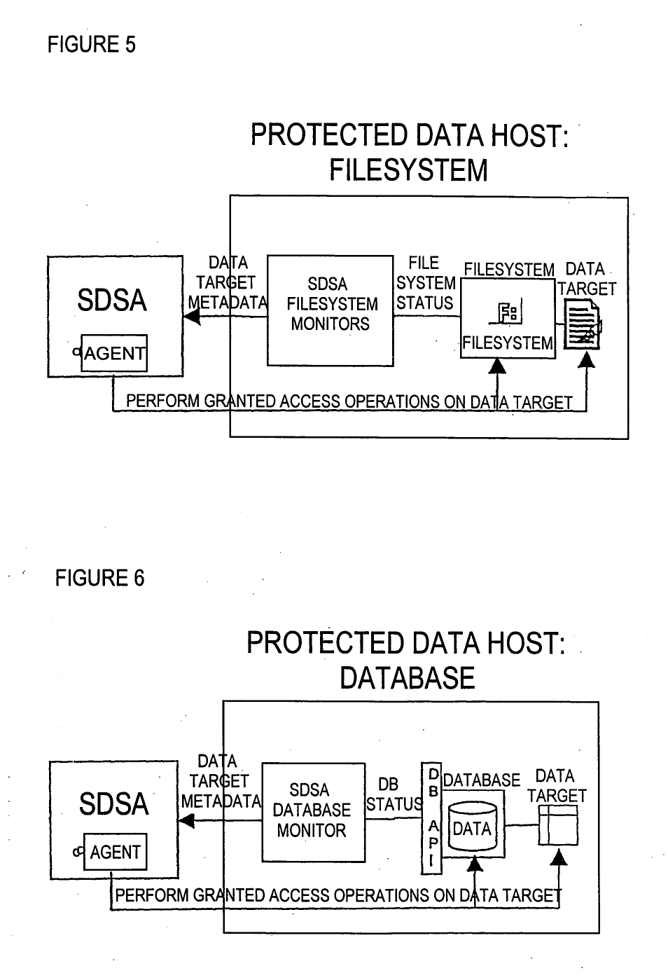

In order to generate and maintain an accurate and current view of the data that it must protect that resides within a host's native filesystem, DSA preferably provides a set of filesystem monitor processes. These processes can transparently access and interpret the contents of the filesystem so that DSA can create its own internal metadata representation of information about the data Targets, including their security attributes and location information. FIG. 5 illustrates the DSA interface with a host having a filesystem upon which protected data resides.

The requirements for, and design of, each filesystem monitor component depends upon the nature of the filesystem(s) that a customer wishes to host their protected data upon. Representative examples of suitable filesystems for such use include ext2 (standard), swap (standard), ext3 (journaled), reiserfs (journaled), jfs (journaled), xfs (journaled), fat16 (Dos/Windows), fat32 (Windows), vfat (Windows), ntfs (Windows), ufs (bsd, SunOs, NetBsd, FreeBSD, NeXtStep), hfs (Macintosh), md (Multiple Device—RAID systems) and lvm (Logical Volume Manager).

For granted operations, only DSA Agents have the privileges to perform the authorized operations on the data targets in the protected data host computer, on behalf of the user. This interface is shown in FIG. 5.

To generate and maintain an accurate and current view of the data that it must protect that resides within a host's database, DSA preferably includes a set of database monitoring components. These processes preferably can transparently access and interpret the contents of the database so that DSA can create its own internal metadata representation of information about the data targets, including their security attributes and location information. FIG. 6 illustrates the DSA interface with a host having a database upon which protected data resides.

The requirements for, and design of, each database monitoring component depends upon the nature of the database(s) upon which a customer wishes to host its protected data. Representative examples of suitable databases include MySQL 4.x and 5.x, PostgreSQL 8.x and Oracle 10.x.

Identical to the filesystem host case for granted operations, only DSA Agents have the privileges to perform the authorized operations on the data targets in the protected data host computer, on behalf of the user. This interface is also shown in FIG. 6.

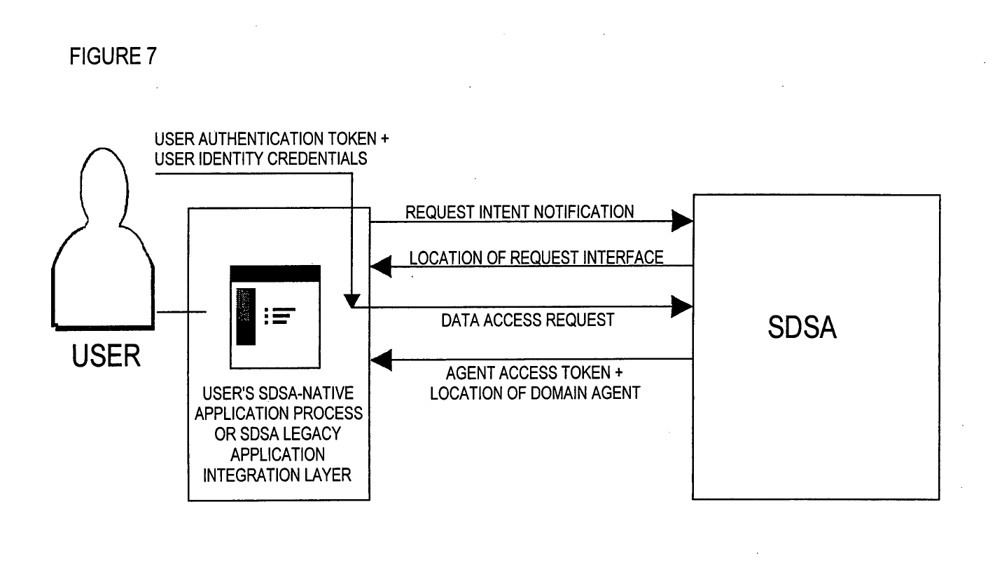

As illustrated in FIG. 7, DSA preferably provides a single interface to its local domain users for processing their requests for access-controlled data targets, regardless of whether the request is coming from a DSA-native application or is issued via a DSA legacy application integration layer process. The DSA request processing API preferably requires an initial notification of intent to issue a request, to which it responds with the location of the interface to which the request will be sent. This feature enables DSA to dynamically perform load balancing of its internal request processing, by determining which of several possible internal request processors should receive each request. Where an authentication token is employed, the user's application sends the user's authentication token (received from DSA during the I&A phase when the user authenticated himself) to the request processing interface. The system preferably then asks the user to provide an additional set of identity credentials (defined by the customer for its domain), which the system verifies. The requesting application subsequently issues to DSA the request to perform an operation on a data target. If the request is granted, DSA preferably returns an encrypted Agent access token and the location of the Agent that has been created to execute the requested operation.

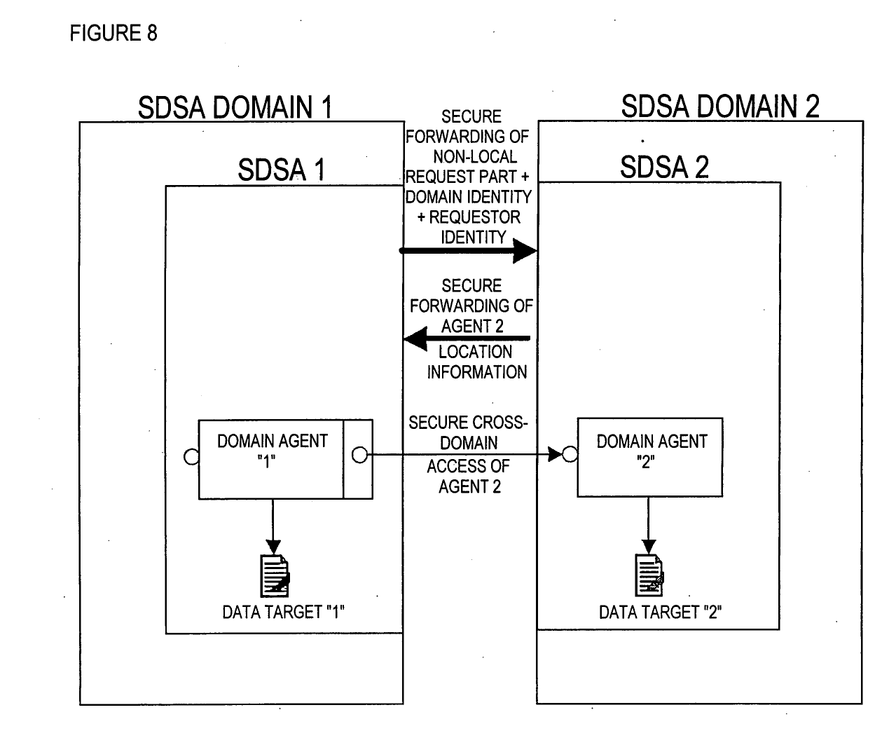

As illustrated in FIG. 8, DSA provides an inter-domain interface to other external DSA domains for the purpose of processing requests having targets that span more than one domain. As noted above, preferably, the DSA system in each domain creates a dynamic virtual channel through the hosts at each domain boundary, such that the DSA-addressable endpoints in each domain are “behind” the boundary-addressable endpoints of each domain's boundary host. Preferably, these virtual channels are established and torn down for each instance of a communication across a domain boundary. This mechanism is a highly secure method of cross-domain communication because no domain-specific physical addresses are exposed across a domain boundary. Information sent across these inter-domain channels is preferably also encrypted for further protection.

FIG. 8 shows instances of cross-domain communication are required for secure forwarding of non-local request targets, for secure forwarding of Agent location information back, and for secure cross-domain access operations among Agents.

Major System Components

A typical DSA single-domain system comprises the components listed in Table 1. The quantity of hosts in the system is entirely driven by a customer's environment and the number of users it must support.

TABLE 1

| Qty | Component | Description | Type |
|---|---|---|---|
| 1 | DSA Core | The core internal DSA system software | Developed in |
| | System | components required to perform access request | accordance |
| | Software | processing and security policy enforcement for a | with the |
| | | single domain. Internal design is scalable, with | description |
| | | the ability to add additional internal processing | herein |
| | | components to satisfy processing load in large | |
| | | scale customer networks. | |
| Customer- | DSA Host | DSA host platforms running security-enhanced | Available |
| Dependent | Computer(s) | Linux extensions to a Linux Operating System, | commercially |
| | | configured with TCP/IP protocol stack and | off the shelf |
| | | associated network interface. Provide I/O, | (COTS) |
| | | processing, and storage for DSA system | |
| | | functions. Customer environment drives the | |
| | | number of hosts over which DSA core internal | |
| | | processes must be distributed. | |
| Customer- | Data Host File | These processes can transparently access and | Developed in |
| Dependent | System | interpret the contents of the filesystem so that | accordance |
| | Monitors | DSA can create its own internal metadata | with the |
| | | representation of information about the data | description |
| | | targets, including their security attributes and | herein |
| | | location information. Developed on an as-needed | |
| | | basis, depending upon the nature of the | |
| | | filesystems on the protected data hosts. | |
| Customer- | Data Host | These processes can transparently access and | Developed in |
| Dependent | Database | interpret the contents of the database so that DSA | accordance |
| | Monitors | can create its own internal metadata | with the |
| | | representation of information about the data | description |
| | | targets, including their security attributes and | herein |
| | | location information. Developed on an as-needed | |
| | | basis, depending upon the nature of the databases | |
| | | on the protected data hosts. | |
| Customer- | DSA Legacy | A DSA interface for providing transparent | Developed in |
| Dependent | Application | integration of user applications that are not aware | accordance |
| | Integration | of the DSA request processing API. developed | with the |
| | Layer | on an as-needed basis, depending upon the nature | description |
| | | of the user-side applications and databases that | herein |
| | | must access DSA-protected data. | |
| Customer- | User | Commercial computing platforms hosting the | COTS |
| Dependent | Application | user applications that will access DSA to request | |
| | Hosts | data. No specialized operating system | |
| | | requirements. Configured with TCP/IP protocol | |
| | | stack and network interface. | |
| Customer- | Protected Data | Commercial computing platforms hosting the | COTS |
| Dependent | Hosts | filesystems or databases upon which DSA- | |
| | | protected data resides. Require secure Linux | |
| | | extensions to the host Operating System. | |
| | | Configured with TCP/IP protocol stack and | |
| | | network interface. | |
| 1 | TCP/IP | For a single domain, all hosts in the system must | COTS |
| | Network | be network-reachable, and running a standard | |
| | | TCP/IP protocol stack. | |

System Operation

This section describes how the system is intended to be used by the (or each, in the cases of multi-domain systems) DSA system administrator, and is centered primarily on the administrator's operator-machine interface functionality. The DSA system administrator is an authenticated role in DSA that is granted access to all configuration parameters and audit logs in the system.

Administrator Configuration of Initial Operational Capability

Prior to the system's initial operational capability, preferably the system administrator must perform the following configuration operations to initialize users, protected data, and system security parameters.

Data protection levels represent a hierarchical labeling and implied separation between groups of data that a customer wishes to protect differently in their domain. The system administrator preferably must initialize the number of domain data protection levels defined in the system and assign named labels to those levels.

The system administrator preferably must specify location information for data target hosts, initialize filesystem and database monitors on the data target hosts, and instantiate the initial DSA-internal representation of all data targets in the system's initial operational capability. While policy typically dictates that it is the responsibility of the creator of a data target to label the target with its protection level label during system operation, preferably prior to a system's initial operational capability, the system administrator ensures that all pre-existing data targets are labeled with appropriate DSA protection level tags.

An optional configuration step which can be provided to the system administrator is the ability to define data set aliases, which are symbolic names for groups of targets that can be defined by the system administrator. Data targets may then be assigned to target groups to simplify the security policy rule specification process. “Need To Know” is a data security attribute that allows the system to further restrict data access to only users that are verifiably associated (via user-submitted Credentials) with a specific “Need To Know” attribute. The use of “Need To Know” allows the system more granularity of access control to data Targets within a protection level. A practical example of its use is to assign a “Mission” or “Project”-based Need to Know label to a data target, so that only users associated with that “Mission” are considered as eligible for access to that data target when the system ultimately makes its access decision based on all other conditions/rules that apply. The system administrator may optionally define the existence of, and labels for, the Need To Know attributes that must be enforced in a domain.

A role is an administrative label that the system administrator preferably has the option of defining in order to simplify security policy rule administration for the many users in a domain. In systems which provide such functionality, the system administrator preferably first defines roles and their relationships, then security policy rules are assigned to roles (giving “privileges” that specify the allowed operations that users who have specific roles can perform on particular targets), and then such roles may be assigned to users in the system. This process significantly eases the burden of individually assigning security policy rules to each user in the system.

The system administrator preferably defines all user identification and authentication information, user-specific credentials (including need to know) for further identity verification (possibly using a configuration file rather than individually assigning all credentials via a graphical interface), and assigns clearance levels to users. A clearance level represents the highest data protection level in the system that a user is allowed to access.

The system administrator preferably defines all domain security policy rules prior to initial operational capability. In DSA, the default is that no access is allowed to any target unless a user is explicitly given privilege to perform a particular operation on the target. The administrator may assign users to roles to simplify security policy rule administration, or assign individual rules for users as needed.

Administrator Configuration During System Operation

The system preferably can provide to the administrator the ability to perform any the following activities during system operation, via the system administration graphical user interface (GUI). Upon committing any changes, the system adapts its enforcement mechanisms to coincide with the new configuration parameters.

During system operation, the system administrator preferably may add and remove users, add and remove authentication privileges, and add and modify clearance levels.

The system administrator preferably may view the metadata attributes in the system's internal representation of the active data targets, modify protection level labels on the targets, add and or remove need to now attributes for data targets, and add or remove targets from the system.

The system administrator preferably may add and remove roles, modify relationships between roles, and add new relationships between roles.

The system administrator preferably may add and remove security policy rules during operation. The system always ensures that access to data is denied unless a rule exists that grants access.

The system administrator preferably may view the system's security audit logs at any time during system operation.

System States and Modes

This section describes how the system preferably can used, by describing preferable states in which it can exist and preferable modes of operation that can occur within each state. A system can include any combination of the functions described below.

The system administrator's configuration of an initial operational capability as described above preferably occurs only once, and is not associated with the initialization state of the system. The initialization state is comprised of the sequential initialization of the or each of the DSA internal system components on its or their respective hosts. Full system initialization is successful when all DSA component processes have verified their unique identities and active status to the system control process.

The enabled state is explicitly instantiated by the DSA system administrator, and can only be done if the initialization state was successful, and the system has determined that an initial configuration is present. The enabled state has two modes of operation that can co-exist; a request processing mode and an administration mode. If an initial configuration is not present, the system preferably requires an administration mode session be completed before entering request processing mode.

The request processing mode is the normal operational mode of the system. During this mode, the system performs its primary long-term functional responsibility—processing data access requests and enforcing the domain's security policy rules.

During the enabled state, the system administrator may instantiate a session with the system to perform any of the activities described above under the “administrator configuration during system operation” section. This administrative session does not interfere with the request processing mode, but committed changes to security parameters made by the administrator preferably impact the system's enforcement of rules during the request processing cycle for requests that are affected by the administrator's changes.

The system may leave the enabled state and transition into the disabled state for the following reasons:
whenever any non-redundant, critical DSA component process fails to respond to the system controller (described below) with a “heartbeat” within an administrator-defined grace period. This may occur for several reasons, including loss of a communication link, failure of a DSA host computer, or malfunction of a DSA component process;
whenever a critical DSA component process fails to successfully authenticate itself to the system controller within an administrator-defined number of attempts. Such failure may occur due to malicious tampering with a component, or other unforeseen reasons; or
the system determines via its security audit logs that a component process has malfunctioned in its request processing behavior, and needs to be re-started.
   Normal operation may still take place in all DSA component processes that are not affected by the disabled component, but if the component remains disabled, preferably, at some point shortly after the component became disabled, the system as a whole will be unable to function until the disabled component becomes operational.

The shutdown state is a state where the system controller explicitly stops all responsive system components. The system may transition to the shutdown state either from the enabled state or the disabled state. Transition from enabled to shutdown state may be administrator-initiated intentionally, or may occur if a critical security violation is detected by the system from its security audit logs. Transition from disabled to shutdown state may occur when any of the administrator-defined grace periods or thresholds for automated recovery of a disabled component has been exceeded without success. The shutdown state may only transition to the initialization state, via manual administrator initiation.

System Configuration Requirements

This section describes how the system preferably is physically configured at start-up time, and how the configuration may be altered during operation as a result of state or mode changes or a failure occurrence. The following subsections provide a description of a number of processes that can be performed in the system configuration process, with some references to relevant portions of the process that were already described above. Systems according to the present invention can include any combination of the functions described below.

The following set of activities are preferably performed once at the time of initial system deployment.

The system administrator preferably must manually configure the following parameters on the secure hosts upon which each DSA component process resides.

Preferably, the system administrator must manually set mandatory access control (MAC) policy parameters such that all DSA processes on each DSA host have equal process priorities, and such that no other application processes have higher process priority than DSA.

Preferably, to further reduce potential system vulnerabilities to network attacks, all DSA hosts have their network access restricted via administrator-initiated disabling of all TCP/IP network ports below 1000, except for Port 22 (SSH login).

Preferably, the system administrator must also manually configure the following parameters on the secure hosts upon which protected data targets reside:
for DSA-protected data hosts, the system administrator preferably must manually set the mandatory access control (MAC) policy parameters such that only DSA processes are able to access protected data; and
if a protected data host houses its data in a database rather than a filesystem, preferably the system administrator must configure the database such that DSA is an authorized user of the database—in this case, DSA can only add additional restrictions (to what the database's native access control mechanism already is configured to allow) on operations that can be performed on data targets in the database (DSA can therefore be configured to further narrow what a database's native access control mechanism is configured to allow, but the two must not conflict—most preferably, DSA is configured as the only authorized “user” of the database); and
the administrator preferably must restrict network access to protected data hosts by disabling all TCP/IP network ports below 1000, except for port 22, (SSH login).

The system administrator preferably must define the physical topology (i.e.—DSA host addressing information) for all DSA hosts in the domain and save this in a secure configuration file—the administrator preferably must manually initialize the DSA System Controller process, which utilizes the configuration file to initialize all DSA component processes with their associated identity and configuration parameters—preferably, upon verification of successful initialization of all DSA component processes via receipt of valid “heartbeats” from each component by the system controller, the system allows the administrator to transition the system into the enabled state.

Preferably, prior to going into request processing mode, the system must verify that an initial configuration has been established for the system. If no initial configuration exists, then the system preferably requires an administrative mode session where the configuration steps for initial operation capability described above must be performed.

Upon successful completion of an initial administrative configuration, the system preferably may enter request processing mode and begin processing requests. From this point forward, the system preferably may enable administrative mode sessions as needed and enable the system administrator to perform activities during system operation as described above during normal operation in request processing mode.

The conditions under which the system can enter and exit the disabled state are preferably as described above.

The conditions under which the system can enter and exit the shutdown state are preferably as described above.

System Requirements

This section describes all preferred and/or required DSA system-level capabilities and their purposes, and itemizes the requirements associated with each capability. All capabilities described in this section specify the behavior of the system, including any relevant performance measures and procedures to be adhered to under unexpected conditions.

Life Cycle Support Requirements

This subsection specifies preferred life cycle factors for the DSA system.

DSA preferably allows access to its system administration capability only through the system administrator role.

DSA preferably provides normal operations on a 24 hours per day, 7 days per week basis.

All DSA system components are preferably designed to operate independently in a distributed configuration. For reasons that include communication link failure, DSA host computer failure, or malicious security behavior, an individual system component may enter a disabled state. The disabled state of operation, along with the criteria for which a component is transitioned into a disabled state, are described above. The system is defined as entering the disabled state whenever any non-redundant, critical DSA component enters a disabled state.

Preferably, if a DSA system controller component enters into a disabled state, the DSA system is immediately transitioned into a shutdown state.

Preferably, if a DSA component other than a system controller enters into a disabled state of operation, the system controller shall attempt to re-start the component an administrator-configurable number of times before transitioning the component to a shutdown state.

Preferably, if a DSA component enters a disabled state of operation because the component fails to respond to a system controller with a “heartbeat” within an administrator-defined grace period, the system controller shall transition the component into a shutdown state and attempt to re-start it.

Preferably, if a DSA component fails to successfully authenticate itself to a system controller within an administrator-defined number of attempts, the system controller shall transition the component to a shutdown state and attempt to re-start it.

Preferably, if a DSA security audit log event processing determines that a component has malfunctioned in its request processing behavior, as determined by a mismatch in input and output requests, a system controller shall transition the component to a shutdown state and attempt to re-start it.

Preferably, if a DSA security audit log event processing determines that the system has malfunctioned in its aggregate request processing behavior, as determined by a mismatch in input and output requests, a system controller shall transition the system to a shutdown state and attempt to re-start all components.

Preferably, the DSA core system component processes shall be portable to host computers running at least the following representative operating systems: Fedora Linux 32 bit—with Security-Enhanced Linux extensions, Fedora Linux 64 bit—with Security-Enhanced Linux extensions, and FreeBSD 6.0.

External Interfaces

This subsection describes preferred interfaces external to DSA, and provides the requirements imposed on the system to achieve those interfaces.

Preferably, all DSA host component computers shall be configured with standard off-the-shelf ethernet network interfaces as their means of network communication.

Preferably, all external network communication to and from DSA component host computers shall occur on administrator-selected TCP/IP Ports above 1000.

Preferably, DSA shall provide a network-accessible external interface to an identification and authentication function, for users to authenticate themselves and establish a secure session with DSA.

Preferably, DSA will provide external interfaces for integration of customer (user) desktop applications and (user) database applications on a customer-driven basis, and these external interfaces will be designed and documented in separate IDDs as needed for future customers.

Preferably, DSA interacts over a network with the host computers on which the data protected by DSA resides. These protected data hosts may host data that resides on a native filesystem on the host, or within a database installed on the host. DSA preferably provides interfaces for both of these cases in its interface architecture.

Preferably, DSA provides a filesystem monitor interface to at least each of the following representative filesystem types: ext2 (standard), swap (standard), ext3 (journaled), reiserfs (journaled), jfs (journaled), xfs (journaled), fat16 (Dos/Windows), fat32(Windows), vfat (Windows), ntfs (Windows), ufs (bsd, SunOs, NetBsd, FreeBSD, NeXtStep), hfs (Macintosh), md (Multiple Device—RAID systems) and lvm (Logical Volume Manager).

The requirements for, and design of, additional filesystem monitor components depends upon the nature of the filesystem(s) upon which a customer wishes to host its protected data.

Preferably, DSA provides a Database Monitor interface to at least each of the following representative database types: MySQL 4.x and 5.x, PostgreSQL 8.x and Oracle 10.x.

The requirements for, and design of, additional database monitor components depends upon the nature of the database(s) upon which a customer wishes to host their protected data.

Preferably, DSA provides an access request handling API that receives notification of intent to submit access requests from user applications.

Preferably, an access request handling interface shall receive the following data: an attribute for notification of intent to submit a request, and a call-back interface to the user's application process.

Preferably, an access request handling interface shall provide to the requester the location of its access request processing interface.

Preferably, DSA provides a location-transparent access request processing API that receives access requests from user applications.

For a location-transparent interface, the address of the interface component is not provided to the user in advance.

Preferably, the access request processing interface shall receive the following data: (1) a call-back interface to the user's application process, (2) a user's authentication token, (3) a user's identity credentials, and (4) a DSA data target access request which includes user ID, requested operation (e.g., publish, subscribe, read or write), and an identifier for the desired data target.

Preferably, an access request processing interface shall provide the following data to the requester: (1) a request identifier (preferably if and only if the submitted request was valid in its structure, and the user is known to the system), (2) an encrypted Agent access token (if and only if the request was granted), and (3) location information for the domain Agent created to satisfy the request (if and only if the request was granted).

Preferably, for each access attempt to a data target that has a need to know security attribute associated with it, DSA shall dynamically provide a graphical interface to the user requesting the user to provide their unique (administrator-defined) credentials that verify their need to know for that data target.

Preferably, DSA shall provide an inter-domain access interface that is externally accessible only to other instances of the inter-domain access interface in other DSA domains.

Preferably, the DSA inter-domain access interface shall be capable of dynamically responding to the inter-domain access interface of another domain on its trusted domain list, when contacted to establish a secure connection or when contacted to terminate a secure connection.

Preferably, because the inter-domain access interface is only involved with secure transport of information between DSA domains, there are no external data-specific requirements.

Operational Requirements

This section describes the operator-machine requirements of the system, including the information to be displayed and the manual operations required to operate the system in each state and mode.

Preferably, DSA shall provide a graphical user interface (GUI) to its system administration function.

Operating in the system's administrative mode of the enabled state, a system administration GUI:
preferably shall enable the administrator to transition any of the DSA components, except the system controller, into a shutdown state;
preferably shall enable the administrator to specify the number of hierarchical data protection levels required in the domain, up to the system-defined maximum limit (the assignment of a single protection level signifies that all data targets and users in that domain are at the same level);
preferably shall enable the administrator to assign labels for each hierarchical protection level defined in the domain;
preferably shall enable the administrator to add and remove users from the domain, and view a summary of active users and their associated “clearance level” attribute;
preferably shall, for every new user added to the system, assign a default value for the user's clearance level attribute to be the lowest defined protection level in the domain (preferably, the default value may be overwritten by a value that is entered by the administrator);
preferably shall enable the administrator to view a summary of the contents of the system's internal metadata representation associated with data targets in the domain, including protection level labels as a minimum;
preferably shall enable the administrator to assign hierarchical protection level labels to data targets in the system's internal representation;
preferably shall enable the administrator to open and delete any data targets in the domain;
preferably shall enable the administrator to define aliases (labeled names) for groups of data targets in the domain;
preferably shall enable the administrator to associate data targets in the domain with an existing data target group alias;
preferably shall enable the administrator to define the labels for user roles in the system (a role being a label that the administrator can define to simplify future security policy rule administration for the many users in a domain);
preferably shall enable the administrator to define “lattice” relationships between the roles in the system, where roles in the lattice may be assigned in both a peer and hierarchical relationship to each other (the roles in each successively lower tier in a role lattice preferably shall only be allowed to inherit an administrator-specified subset from the set of privileges assigned to the tier directly above it);
preferably shall enable the administrator to assign security policy rules to roles;
preferably shall enable the administrator to assign a clearance level to users in the domain, with the option to assign a clearance level to “all”, to “roles”, and to individual users;
preferably shall enable the administrator to assign roles to users in the domain;
preferably shall enable the administrator to define security policy rules that apply to a data target group;
preferably shall enable the administrator to create, modify, and delete security policy rules for the DSA domain—a rule specifies that a (“user” or “role”) can perform an “operation” on a data “target”, with an optional constraint on “Time”—valid operations include, for example, “read”, “write”, “publish”, and “subscribe”—valid “time constraints” include options for “granted between two specified date/times”, “granted before a specified date/time”, or “granted after a specified date/time”;
preferably shall enable the administrator to review the security audit logs for each of the DSA components in the domain;
preferably shall enable the administrator to filter their view of an audit log based on messages entering the process, messages exiting the process, request ID, requestor identity, and request timestamp;
preferably shall enable the administrator to generate and view a statistical representation of data in a security audit log, including requests received and requests forwarded;
preferably shall enable the Administrator to create, modify, and delete labels for the need to know security attributes that must be enforced in the domain; and
preferably shall enable the administrator to associate need to know labels with the data targets in the domain.
   Performance Requirements

This section lists preferred performance requirements associated with the DSA system.

Preferably, DSA shall modularly be able to scale its access request processing function to operate under a loading of at least 200 Requests per second.

Preferably, DSA shall modularly be able to scale its security policy rule enforcement function to operate under a loading of at least 200 Requests per second.

Preferably, DSA shall be able to control the individual loading assigned across each of its access request processing components, in configurations where this function is modularly scaled.

Preferably, DSA shall explicitly control the authentic identities of every DSA core functional component in the system. This requirement provides enhanced system security, and significantly helps to prevent insider attacks. Representative methods available to provide this capability include hashed identification codes, inter-process heartbeats, and event-notification based activity logging.

Preferably, in order to provide the inter-process heartbeat functionality, each core functional component in the DSA system within each domain is given (by system control) a unique identification code which is created by the system control and encrypted. If such a functionality is provided, when the system is in an enabled state, preferably within each unit of time, e.g., one second, each functional component sends the identification code (heartbeat) to the system control. If an invalid heartbeat is received from any particular process, that process can be shut down. If any particular process misses a particular number of heartbeats in succession (e.g., three consecutive heartbeats), that process can be shut down. If a heartbeat from a particular process is received from an incorrect location, that process can be shut down. Preferably, a “child” system control component can be installed on each process, such that the respective processes can be shut down upon the occurrence of any specified event (e.g., missing a particular number of heartbeats) even when communication with the system control has been lost. Preferably, the encrypted code is a hash code which is transparent to the process—if the process is shut down, it would no longer have the hash code and would need to receive a new code from system control in order to resume functioning.

Upon the occurrence of any particular combination of events, the system can be configured such that the system control shuts down the entire DSA system.

Preferably, DSA shall be able to explicitly and securely control (startup and shutdown) each of its core functional components from its system control function. This requirement addresses the need for exclusive system control over all core functional components in the distributed security architecture, providing additional security in situations dealing with unexpected events, such as network and host failures, and malicious security behavior.

In cases where a core DSA system functional component becomes isolated from the remainder of the system, preferably the component shall continue to perform its functional responsibility and attempt (for an administrator-defined interval) to communicate with the system. This requirement addresses operation under conditions of unexpected network connectivity anomalies (including link and network failures, and failures of other components or their hosts).

Preferably, all communication between core DSA system functional components shall be encrypted.

Preferably, in order to provide dynamic and secure peer-to-peer domain connectivity for processing of cross-domain access requests:
preferably, for any instance of communication required across a security domain boundary to another domain, DSA shall for each request dynamically establish a secure tunnel to another peer DSA domain (without exposing any subnet nodes); and
preferably, DSA shall dynamically release the secure tunnel after the transfer is completed.

Preferably, DSA utilizes location transparency in two unique ways to support scalability and provide an additional level of security throughout the system:
Preferably, DSA shall require each of its core system functional components to dynamically determine the physical location (address) of another system component to which it must communicate. Preferably, DSA shall control access between its core system functional components such that only those components having a defined functional responsibility to inter-communicate are allowed to determine the location information of a component to which it must communicate.
Preferably, DSA shall explicitly hide all data target location information from its requestors (users) during access request processing, after requests have been granted, and during the granted access operation. This is a critical requirement of the system, and also one of its most important unique differentiators. In DSA, there are no “direct” connections allowed between the source of a request and the target data (for pull operations), or location of the target (for push operations). All target location information is “hidden” by DSA, even after access has been granted. Users do not need to know where their granted data resides, or where their published data will be stored.

DSA is able to enforce access control decisions where the target of a request resides in a single domain, or is distributed across multiple domains. Preferably, DSA is able to enforce access control decisions with multiple targets specified in a request, where each target may have its own source or destination, but only if all targets are either “push” or “pull” in nature.

Preferably, DSA shall enable the owner of a data target to retain permanent access control, even for granted transactions. Even after access has been granted to a target, and Agent interfaces are created by DSA, local security policy changes that occur during system operation may result in Agent or certificate destruction. This means that the “owners” of target data in each domain always have final control over access, independent of issued permissions.

Preferably, DSA shall be able to dynamically create and destroy location-transparent interfaces to granted data targets.

Preferably, DSA shall be able to dynamically link the interfaces to granted data targets across each domain of a multi-domain request.

The Agent “chain” (for a multi-domain request) created by DSA consists of distributed, linked Agent “interfaces” created on-the-fly for granted requests. A secure token preferably provided back to a Requestor enables transparent access to approved Agent interfaces. In addition to DSA-unique security certificates, granted permissions may also contain third party security certificates in a DSA token.

Adaptation

This section specifies preferred requirements concerning installation-dependent data that the system is required to provide, and operational parameters that the system is required to use that vary according to operational needs.

Preferably, DSA shall support flexible initialization of its core system functional components on their individual host platforms each having locations (addresses) specified by a customer at the time of installation.

Preferably, individual customers can specify their requirements for the user-side applications and databases that they wish to integrate as “requestors” in a DSA domain. On a case-by-case basis, this will dictate which DSA client access layer (described above) and thin data layer (described above) processes are required to complete user application integration with a DSA core system.

Preferably, individual customers will specify their requirements for the data (target)-side applications and databases that they wish to integrate as “datastores” to host the data targets in a DSA domain. On a case-by-case basis, this will dictate which DSA filesystem monitor (described above) and database monitor (described above) processes are required to complete data target integration with a DSA core system.

Utilization

This section specifies the computer hardware and software utilization requirements for the system.

Preferably, DSA software components shall be hosted on any choice of standard commercial-off-the-shelf (COTS) computing hardware platforms that are capable of running a suitable operating system, e.g., a Linux operating system kernel.

Preferably, each DSA host computer shall be configured with a commercially available ethernet network interface card that is compatible with the host operating system.

Preferably, DSA software components are hosted on computing platforms running a suitable operating system, e.g., one of the operating systems specified above.

Preferably, all network communications between DSA hosts shall utilize a standard TCP/IP protocol stack, e.g., one available in the host operating systems specified above.

System Functional Architecture

This section describes the overall DSA functional architecture, and the concept of execution among the system functions.

System Functional Description

Table 2 lists representative preferred DSA system functions and summarizes their responsibilities and major subfunctions. Any suitable desired combination of the processes described in Table 2 can be employed in a DSA system.

TABLE 2
DSA System Functions

| System Function | Description/Subfunctions |
|---|---|
| System Control | Initiates & terminates all DSA components |
| | Establishes unique identities for all components |
| | Monitors the state of all components |
| | Collects security audit data from all components |
| | Collects its own security audit data |
| | Encrypts its communications with other components |
| Inter-Process | Restricts access between DSA core system functional components such |
| Location | that only those components having a defined functional responsibility to |
| Transparency | inter-communicate are allowed to determine the location information of |
| | a component to which it must communicate |
| | Returns a reference to the physical location (address) of a system |
| | component to which another component is requesting to communicate |
| | with. |
| Identification & | Performs an Identification & Authentication function for users to |
| Authentication | authenticate themselves and establish a secure session with DSA. |
| System | Provides a Graphical User Interface to the System Administrator to |
| Adminstration | perform the system administration subfunctions. |
| Access Request | Provides a network-accessible interface to users that notify their |
| Handling | intent to submit a data target access request to the system. |
| | Responds with the location of the interface to which the Request has |
| | to be sent. Dynamically performs load balancing of DSA internal |
| | request processing, by determining which of several possible internal |
| | request processors should receive each request. |
| Access Request | Processes requests from user applications requesting access to |
| Processing | protected data targets. |
| | Verifies receipt of a valid user authentication token, valid identity |
| | credentials, and a valid request. |
| | Forwards multi-domain requests to inter-domain access controller. |
| | For requests that have been granted, returns to the requestor an |
| | encrypted Agent access token, and location of the domain's data target |
| | access Agent that has privilege to perform the granted operation on |
| | behalf of the requestor. |
| | Creates and maintains all data target access Agents in the domain. |
| | Verifies requestor-submitted Agent access token prior to allowing a |
| | requestor to access an Agent that was created in response to a granted |
| | request. |
| Data Access | Performs granted operation on a data target and returns result (for pull |
| Location | operations), or moves data to an approved target location (for push |
| Transparency | operations). |
| Security | Dynamically monitors data targets for user-driven changes to security |
| Attribute | attributes. |
| Updating | Notifies policy enforcement of changes to security attributes. |
| Security Policy | Enforces all security policy rules in a domain. For each request, |
| Rule | verifies that the request is not violating a rule prohibiting the |
| Enforcement | requested operation on a data target. |
| Virtual Resource | Verifies the existence of a data target in a domain. |
| Management | Verifies the security metadata attributes associated with data targets in |
| | a domain. |
| Virtual Resource | Maintains a metadata summary of a domain's data target security |
| Representation | attributes and location information. |
| Inter-Domain | Provides an inter-domain access interface that is externally accessible |
| Access Control | only to other instances of the inter-domain access interface in other |
| | DSA domains. |
| | Dynamically responds to the inter-domain access interface of another |
| | domain on its trusted domain list, when: |
| | 1. contacted to establish a secure connection |
| | 2. contacted to terminate a secure connection |
| | Provides secure transport of information between domains. |
| Protected Data | Provides transparent access to, and interpretation of, the file contents |
| Filesystem | for a specific filesystem type that resides on a data target host. |
| Monitoring | Interprets requests for access to data targets, from Agents in the |
| | domain. |
| Protected Data | Provides transparent access to, and interpretation of, the database |
| Database | contents for a specific database type that resides on a data target host. |
| Monitoring | Interprets requests for access to data targets, from Agents in the |
| | domain. |
| Client | Provides an interface for transparent integration of user network- |
| Application | aware applications that are not aware of the DSA request processing |
| Integration | API. Developed on an as-needed basis, depending upon the nature of |
| Interface | the user-side applications that must access DSA-protected data. |
| Client Database | Provides an interface for transparent integration of user database |
| Integration | applications that are not aware of the DSA request processing API. |
| Interface | Developed on an as-needed basis, depending upon the nature of the user- |
| | side databases that must access DSA-protected data. |

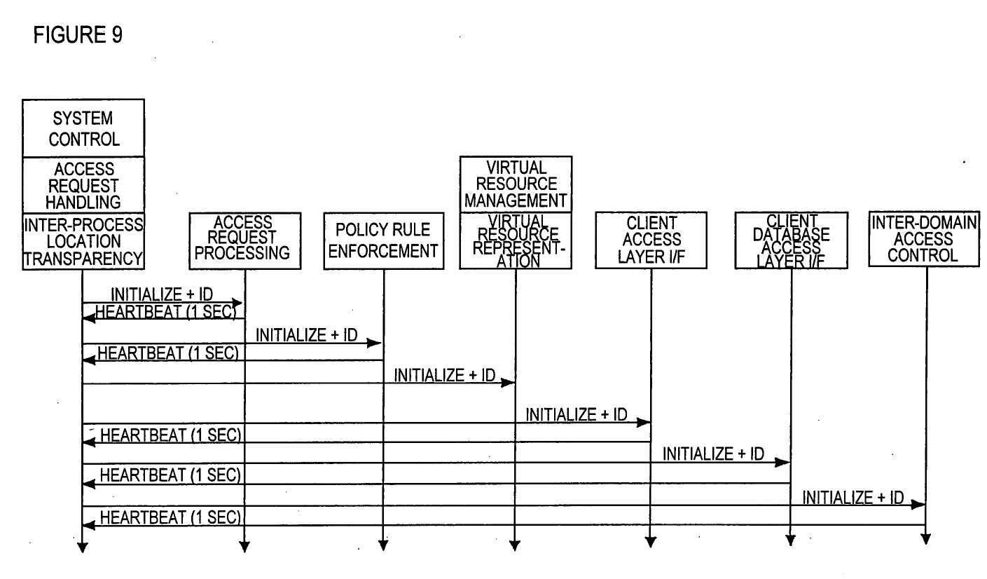

FIG. 9 illustrates preferred sequenced flows among the DSA functions that participate in the system's initialization state.

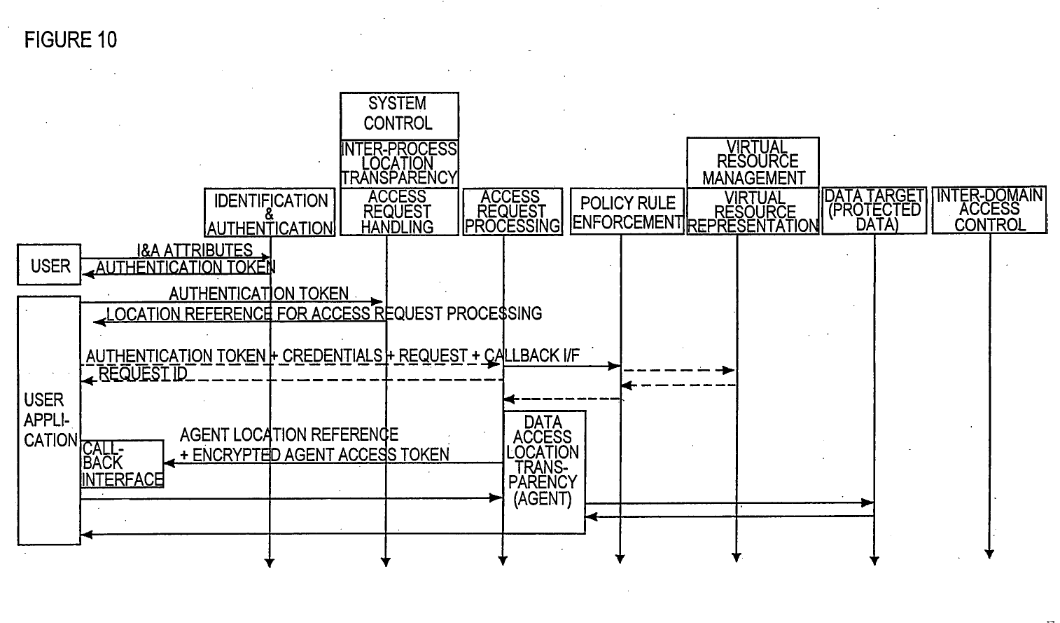

FIG. 10 illustrates preferred sequenced flows among the DSA functions that participate in the system's request processing mode during an enabled state. A preferred single-domain request processing and fulfillment cycle is shown, along with a user application's data target access operation via an Agent.

System Physical Architecture

This section describes preferred aspects for the physical system architectural design of DSA, including a block diagram of the system. The DSA is preferably comprised of a single computer software configuration item (CSCI). Preferably, there is no hardware configuration item (HWCI) for DSA.

System Physical Description

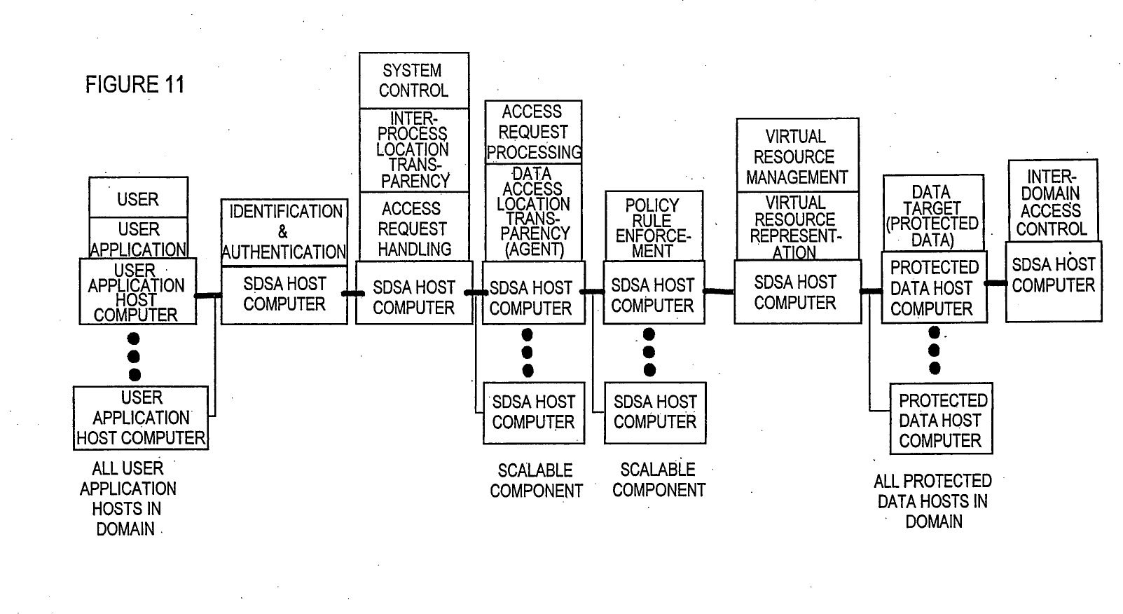

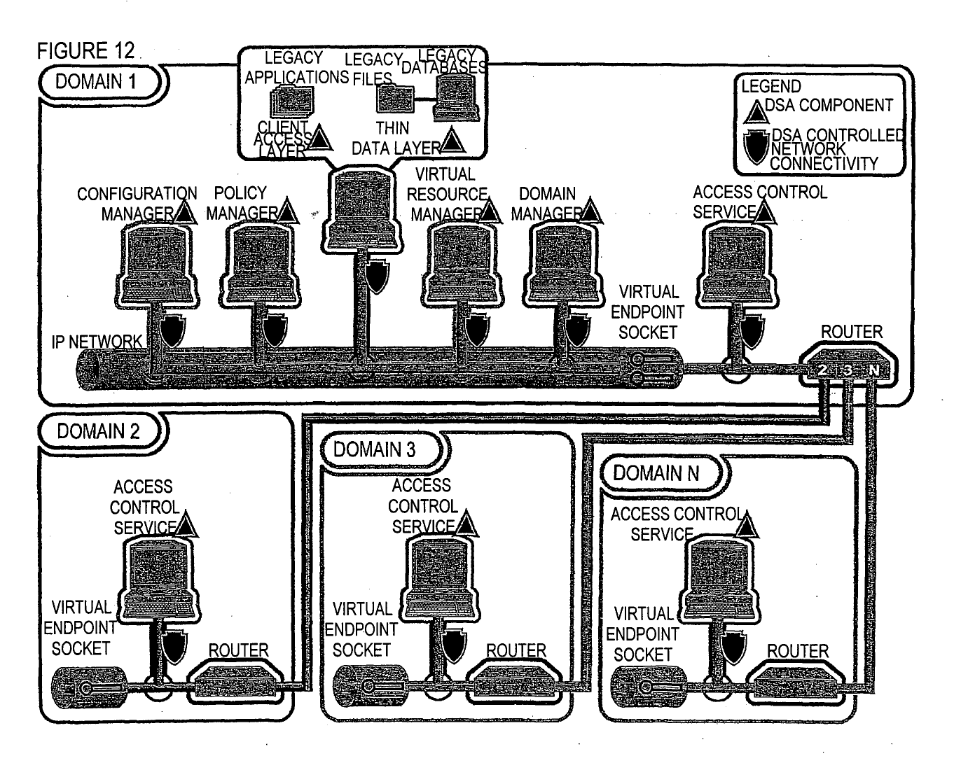

A diagram of a preferred DSA physical system is shown in FIG. 11. All host computers, including user application hosts, DSA hosts, and data target hosts, are on a domain TCP/IP network.

The various processes of DSA within any particular domain can be stored on any desired number of host computers. Preferably, each of the vertical groupings shown in FIG. 11 is hosted on a separate host. In addition, in FIG. 11, the four sets of three vertically-aligned circles represent the possibility of including a plurality of hosts which each perform the function listed in the boxes above and below the respective sets of circles—the provision of multiple hosts for performing similar functions provides scalability with respect to the performance of such functions. Preferably, protected data elements are stored on hosts which are separate from hosts on which DSA processes are hosted.

System Internal Data Description

Preferably, internal to the DSA CSCI, between the core functional components, the component-to-component messages are all defined and encrypted between components for system security purposes. This is preferably also true for inter-domain communications between DSA peer systems. The external API to user applications is preferably an open API for developers to use in designing interfaces that connect either DSA native applications or user-legacy applications to the DSA core system.

CSCI Requirements

This section specifies preferred computer software configuration item (CSCI) requirements for DSA, which capture the characteristics of the system that are the conditions for its acceptance. The DSA is preferably composed of a single CSCI, and the DSA CSCI requirements are preferably the software requirements that are generated to satisfy the system requirements defined above. The CSCI requirements are organized into groups of system capabilities, described below.

Required States and Modes

Preferably, DSA shall be capable of operating in the following states and modes, as described above: initialization state, enabled state (including administration mode and request processing mode), disabled state and shutdown state.

Preferably, DSA shall transition its operation between states in accordance with the conditions specified above.

Capability Requirements

Preferably, DSA shall detect when an (administrator-configurable positive integer within a range of acceptable values) number of unsuccessful user and administrator authentication attempts occur to DSA, and preferably, if the defined number of unsuccessful authentication attempts has been met or surpassed, DSA shall mark the user and add them to a rejection list.

Preferably, DSA shall maintain the following list of security attributes belonging to individual users: name, password and a domain-dependent, administrator-specified, dynamic list of user identification credentials (including need to know credentials, if applicable).

Preferably, DSA shall provide a mechanism to verify that secrets (credentials) meet all administrator-predefined user credentials.

Preferably, DSA shall provide a mechanism to generate secrets that meet domain-defined security requirements.

Preferably, DSA shall be able to enforce the use of DSA-generated secrets for authentication based on user credentials.

Preferably, DSA shall require each user to be successfully authenticated before allowing any other DSA security function-mediated actions on behalf of that user.

Preferably, DSA shall prevent use of authentication data that has been forged by any user of DSA.

Preferably, DSA shall prevent use of authentication data that has been copied from any other user of DSA.

Preferably, DSA shall prevent re-use of authentication data related to a granted request.

Preferably, DSA shall require that a user re-authenticate if a system-defined timeout period expires.

Preferably, DSA shall associate the appropriate user security attributes with subjects acting on behalf of that user.

Preferably, DSA shall be able to deny session establishment based on determination that a user has provided incorrect identity credentials with their access request.

Preferably, if a need to know attribute is associated with a requested data target, DSA shall require the requestor to provide additional identity credentials verifying their need to know for that data target.

DSA shall be able to deny session establishment based on determination that a user has provided incorrect need to know identity credentials in response to system prompts during request processing.

Preferably, DSA shall enforce its system access control policy on all users and all data targets, and all operations among users and data targets covered by the system access control policy.

Preferably, DSA shall ensure that all operations between any user in the domain and any data target in the domain are covered by the DSA system access control policy.

Preferably, DSA shall enforce the DSA system access control policy to its protected data targets based on the following user and data target security attributes specified in Tables 3 and 4:

TABLE 3
Requestor/User Security Attributes

| Subject | Attributes |
|---|---|
| Requestor/User | Authentication Token |
| | Credentials (including for Need to Know) |
| | Clearance Level |

TABLE 4
Data Target Security Attributes

| Object | Attributes |
|---|---|
| data Target | Protection Level |
| | Need To Know |
| | Time (of access attempt) |

Preferably, DSA shall enforce all of the rules in Table 5 to determine if an operation among controlled users and controlled data targets is allowed:

TABLE 5
Rules to Allow Requested Operations in DSA

| Operations | Rules to Allow Requested Operation |
|---|---|
| Read, | 1. The user has an authentication token which is valid in the domain at the time of the |
| Write, | request. |
| Publish, | |
| Subscribe | |
| Read, | 2. The user provided all valid additional identification credentials that the system |
| Write, | required for their session, at the time of the request. |
| Publish, | |
| Subscribe | |
| Read, | 3. The user's clearance level is greater than, or equal to, the hierarchical protection level |
| Write, | assigned to the requested data target, at the time of the request. |
| Publish, | |
| Subscribe | |
| Read, | 4. If need to know is applicable to a requested data target, the user provided all valid |
| Write, | additional identification credentials that the system required to verify their need to know, |
| Publish, | during request processing |
| Subscribe | |
| Read, | 5. The system verifies that the user has the privilege of performing the requested |
| Write, | operation on the specified data target, at the time of the enforcement decision. |
| Publish, | |
| Subscribe | |
| Read, | 6. The user's authentication token is valid in the domain at the time of the access |
| Write, | operation. |
| Publish, | |
| Subscribe | |
| Read, | 7. The user's additional identification credentials are still valid at the time of the access |
| Write, | operation |
| Publish, | |
| Subscribe | |
| Read, | 8. The user's clearance level is greater than, or equal to, the hierarchical protection level |
| Write, | assigned to the requested data target, at the time of the access operation. |
| Publish, | |
| Subscribe | |
| Read, | 9. The system has not revoked the user's privilege of performing the requested operation |
| Write, | on the specified data target, between the time of the enforcement decision and the time |
| Publish, | of the access operation. |
| Subscribe | |
| Read, | 10. There are no time constraints associated with access to the requested data target that |
| Write, | prevent the user from accessing the target at the time of the access operation. |
| Publish, | |
| Subscribe | |

Preferably, DSA shall explicitly deny access of users to data targets if any of the following seven (7) conditions are TRUE:
1. The user provided an invalid authentication token with their request.
2. The user's authentication permissions were revoked, between the time of the request and the time of the operation to access the data target.
3. The user provided an invalid set of additional identification credentials that the system required for their session, including need to know for a specific data target.
4. The system does not give that user/role the privilege of performing the requested operation on the specified data target, at both the time of the request, and the time of the access operation.
5. There are time constraints associated with access to the requested data target that prevent the user from accessing the target at the time of the access operation.
6. The user's clearance level is lesser than the hierarchical protection level assigned to the requested data target, at the time of the request, or at the time of the access operation.
7. The data target no longer exists in the domain at the time of the access operation.

Preferably, DSA shall provide the capability to detect changes in the protection level attribute associated with a data target, when a data target is written or published.

Preferably, DSA shall provide the capability to dynamically update its policy enforcement function upon determination that a data target's protection level attribute has been modified.

Preferably, DSA shall provide the capability to dynamically update its policy enforcement function upon determination that a data target's need to know attribute has been modified.

Preferably, DSA shall provide the capability to verify the existence of all protected data targets in its domain.

Preferably, DSA shall provide the capability to associate all data targets in a domain with their relevant security attributes.

Preferably, DSA in each domain of a multi-domain request shall enforce its system access control policy when importing a data target.

Preferably, the DSA in each domain of a multi-domain request that must export a data target during an access operation, shall export the local data target with the target's protection level security attribute mapped to the protection level security attribute of the receiving domain. Protection level mappings between domains are preferably administratively provided between each trusted neighbor domain during DSAs initialization state in each domain.

Preferably, DSA shall ensure that the protection level security attribute, when exported outside the local domain, is unambiguously associated with the exported data target.

Preferably, DSA shall encrypt the transmission of all data targets during export from a local domain.

Preferably, DSA in each domain of a multi-domain request shall enforce its system access control policy when exporting a data target.

Preferably, DSA in each domain of a multi-domain request that must import a data target during an access operation, shall use the security attributes associated with the imported data target.

Preferably, DSA shall ensure that the protocol used provides for the unambiguous association between the security attributes and the user data target received.

Preferably, DSA shall ensure that interpretation of the security attributes of the imported user data target is as intended by the source of the user data.

Preferably, DSA shall utilize an Administrator-configurable encryption method to prevent the disclosure of user data when it is transmitted between physically-separated parts of the system in a single domain.

Preferably, DSA shall separate data targets controlled by the DSA System Access Control Policy when transmitted between physically-separated parts of the system, based on the value of the protection level of the data target.

Preferably, DSA shall ensure that any previous information content of a resource is made unavailable upon the allocation of the resource to, and deallocation of the resource from all objects.

Preferably, DSA shall in the enforcement of its DSA System Access Control Policy, be able to transmit and receive objects in a manner protected from unauthorized disclosure.

Preferably, DSA shall restrict the ability to determine the behavior of, and disable (except for the System Controller), the DSA core functional components to the System Administrator Role.

Preferably, DSA shall restrict the ability to change, default, query, modify, or delete, the clearance level and protection level security attributes in the system to the System Administrator Role.

Preferably, DSA shall ensure that only secure values are accepted for security attributes.

Preferably, DSA shall provide restrictive default values for the clearance level security attribute.

Preferably, DSA shall allow the System Administrator to specify alternative initial values to override the default values when an object or information is created.

Preferably, DSA shall restrict the ability to query, delete, and clear, the system security Audit Log data to the System Administrator Role.

Preferably, DSA shall ensure that only secure values are accepted for DSA security function data.

Preferably, DSA shall restrict the ability to revoke security attributes associated with its users within a domain to the System Administrator Role.

Preferably, DSA shall enforce System Administrator-initiated revocation of user security attributes immediately following a committed change.

Preferably, DSA shall restrict the capability to specify an expiration time for time-limited access to a data target, to the System Administrator Role.

Preferably, for the time-limited security attribute on a data target, DSA shall be able to revoke a user's access rights after the expiration time for the indicated security attribute has passed.

Preferably, DSA shall be capable of performing all of the security management functions to which an Administrator interface was specified above.

Preferably, DSA shall maintain the Role: System Administrator.

Preferably, DSA shall be able to associate users with Roles.

Preferably, DSA shall ensure that the conditions for lattice-based Role relationships described above are satisfied.

Preferably, DSA shall require an explicit request to assume the System Administrator Role.

Preferably, DSA shall provide the System Administrator with the capability to observe the data target request and data target access behavior of all users in the domain.

Preferably, DSA shall preserve a secure state when the following types of failures occur:

identity or correct operation of a component fails; network congestion or interruption; or host system failure.

Preferably, DSA shall ensure the availability of all DSA inter-domain data provided to an external trusted domain, if connectivity is available, and both peer DSA inter-domain access controllers are operating correctly.

Preferably, DSA shall protect all DSA data transmitted from the local DSA domain to a remote trusted domain from unauthorised disclosure during transmission.

Preferably, DSA shall protect DSA data from disclosure and modification when it is transmitted between separate parts of the system.

Preferably, DSA shall separate user data from DSA data when such data is transmitted between separate parts of the system.

Preferably, DSA shall be able to detect modification of data, substitution of data, re-ordering of data, deletion of data, and encryption errors for DSA data transmitted between separate parts of the system.

Preferably, upon detection of a data integrity error, DSA shall write the error into the security Audit Log and move the system into Administrative mode until integrity is restored.

Preferably, DSA shall provide unambiguous detection of physical tampering that might compromise the DSA Security Function.

Preferably, DSA shall provide the capability to determine whether physical tampering with DSAs devices or DSAs elements has occurred.

Preferably, DSA shall monitor all of its DSA hosts and functional components and notify the System Administrator when physical tampering with DSAs hosts or components has occurred.

Preferably, DSA shall resist physical tampering scenarios to any DSA host or functional component by responding automatically such that system security is not violated.

Preferably, when automated recovery from interface intrusion attempt is not possible, DSA shall enter the Administrative mode where the ability to return to a secure state is provided.

Preferably, for interface attack and component identity failures, DSA shall ensure the return of the system to a secure state using automated procedures.

Preferably, The functions provided by DSA to recover from failure or service discontinuity shall ensure that the secure initial state is restored without exceeding the Administrator-configured thresholds for loss of system data or objects within the system.

Preferably, DSA shall provide the capability to determine the objects that were or were not capable of being recovered.

Preferably, DSA shall ensure that the following Security Functions and associated failure scenarios have the property that the Security Function either completes successfully, or for the indicated failure scenarios, recovers to a consistent and secure state:
1. Security Function: component identity checking.
   Failure Scenario: component identity check failure.
2. Security Function: component request processing.
   Failure Scenario: mismatches between individual component request handling statistics and overall system audit trail summary.
3. Security Function: component inter-process communications.
   Failure Scenario: reachability of a minimum number of DSA components will send the system into a secure state, and return to full operation if the domain-defined threshold is not exceeded.

Preferably, DSA shall ensure that security policy enforcement functions are invoked and succeed before each function within the system is allowed to proceed

Preferably, the unisolated portion of DSA shall maintain a security domain for its own execution that protects it from interference and tampering by untrusted subjects.

Preferably, DSA shall enforce separation between the security domains of subjects in the system.

Preferably, DSA shall maintain the part of the system that enforces the access control functional processing in a security domain for its own execution that protects them from interference and tampering by the remainder of the DSA security functions and by subjects untrusted with respect to the system.

Preferably, DSA shall be able to provide reliable time stamps for its own use

Preferably, DSA shall ensure the operation of all the system's capabilities when the following failures occur:
Loss of inter-component communication for less than an Administrator-defined time limit; and
Failure to verify component identity for less than an Administrator-defined maximum number of re-try attempts.

Preferably, DSA shall assign a priority to each user in the system.

Preferably, DSA shall ensure that each access to data targets shall be mediated on the basis of the user's assigned priority.

Preferably, a DSA domain shall be able to provide a communication channel between itself and an external trusted DSA domain that is logically distinct from other communication channels and provides assured identification of its end points and protection of the channel data from modification or disclosure.

Preferably, DSA shall permit its own local domain access controller to initiate communication via the trusted channel that it instantiates.

Preferably, DSA shall initiate communication via the trusted channel for inter-domain access request Processing functions or data target access operations.

Preferably, DSA shall provide a communication path between itself and local users that is logically distinct from other communication paths and provides assured identification of its end points and protection of the communicated data from modification or disclosure.

Preferably, DSA shall permit local users to initiate communication via the trusted path.

Preferably, DSA shall require the use of the trusted path for initial user authentication, any request processing operation, and any data target access operation.

Preferably, DSA shall initialize following actions upon detection of a potential security violation:

Shutdown a component, if the component had an identity violation, and generate an alarm;

Restart the component with a new instance of identity information; and

After the second violation in sequence, shutdown the entire system in the domain.

Preferably, DSA shall be able to generate an audit record of the following auditable events:
1. Start-up and shutdown of the audit functions;
2. All auditable events for the detailed level of audit; and
3. request session login parameters, user data, credential list, request or request-list, user-ID, request-ID, permission, reason for denial.

Preferably, DSA shall record within each audit record at least the following information:
1. Date and time of the event, type of event, user identity, and the outcome (success or failure) of the event;
2. For each audit event type, based on the auditable event definitions of the functional components, the entire operation cycle of the request process; and
3. Audit trail of any single request with in/out data processed by every DSA component, with success or failure reason.

Preferably, DSA shall be able to associate each auditable event with the identity of the user that caused the event.

Preferably, DSA shall be able to maintain profiles of system usage, where an individual profile represents the historical patterns of usage performed by the member(s) of a group or single user. The profile consists of type of requests, target groups, average number of events per target group. Patterns can be dynamically defined for the domain, for which DSA will provide historical data.

Preferably, DSA shall be able to maintain a suspicion rating associated with each user whose activity is recorded in a profile.

Preferably, the suspicion rating represents the degree to which the user's current activity is found inconsistent with the established patterns of usage represented in the profile.

Preferably, DSA shall be able to indicate an imminent violation of security when a user's suspicion rating exceeds the following threshold conditions: repetition of similar requests, subsequent denial of requests for specific user, number of requests per defined interval.

Preferably, DSA shall be able to maintain an internal representation of the following event sequences of known intrusion scenarios: unusual high number of requests per interval or subsequent denied requests for a specific user and the following signature events: any access with invalid user credentials that may indicate a potential violation of system security.

Preferably, DSA shall be able to compare the signature events and event sequences against the record of system activity discernible from an examination of user profiles and usage profiles.

Preferably, DSA shall be able to indicate an imminent violation of system security when system activity is found to match a signature event or event sequence that indicates a potential violation of system security.

Preferably, DSA shall provide a Graphical User Interface to the System Administrator with the capability to read request trails, profiles, and system profile from the audit records.

Preferably, DSA shall prohibit all users read access to the audit records, except those users that have been granted explicit read-access.

Preferably, DSA shall provide the ability to perform searches, sorting, and ordering of audit data based on user, request, and time.

Preferably, DSA shall be able to include or exclude auditable events from the set of audited events based on the following attributes: Data target identity, user identity, host identity, event type, user, request, and credentials.

Preferably, DSA shall protect the stored audit records from unauthorized deletion.

Preferably, DSA shall be able to prevent unauthorized modifications to the audit records in the audit trail.

Preferably, DSA shall ensure that reliable storage of audit records will be maintained when the following conditions occur: audit storage exhaustion, failure, attack.

Preferably, DSA shall overwrite the oldest stored audit records and switch to an emergency storage area if the audit trail is full.

Preferably, DSA shall provide Administrator-selectable options for use of the cryptographic support standards listed in Table 6, as required to support each of the DSA system communications activities in the column headings of the table.

Preferably, as needed, DSA shall generate cryptographic keys in accordance with the standards identified in Table 6.

Preferably, as needed, DSA shall distribute cryptographic keys in accordance with the standards identified in Table 6.

Preferably, as needed, DSA shall perform cryptographic key access in accordance with the standards identified in Table 6.

Preferably, as needed, DSA shall perform cryptographic key destruction in accordance with the standards identified in Table 6.

Preferably, as needed, DSA shall perform cryptographic operations in accordance with the standards identified in Table 6.

TABLE 6
List of DSA-selectable System Cryptographic methods

| | | | | DSA |
|---|---|---|---|---|
| Encryption-Type/ | Client Au- | client- | DSA Internal | Inter- |
| Certificate | thentication | DSA | Components | domain |
| des_cbc_crc | yes | yes | yes | yes |
| des_cbc_md4 | yes | yes | yes | yes |
| des_cbc_md5 | yes | yes | yes | yes |
| arcfour_hmac_md5 | yes | yes | yes | yes |
| des3_cbc_md5 | yes | yes | yes | yes |
| des3_cbc_sha1 | yes | yes | yes | yes |
| old_des3_cbc_sha1 | yes | yes | yes | yes |
| aes128_cts_hmac_sha1 | yes | yes | yes | yes |
| aes256_cts_hmac_sha1 | yes | yes | yes | yes |
| des_cbc_none | yes | yes | yes | yes |
| des_cfb64_none | yes | yes | yes | yes |
| des_pcbc_none | yes | yes | yes | yes |
| des3_cbc_none | yes | yes | yes | yes |
| Private Certificate | yes | yes | no | yes |
| 3^{rd} Party Certificate | yes | yes | no | yes |

Preferably, DSA shall provide an external interface to the following via a Client Application Integration Interface for network-aware applications (Client Access Layer):

1. Microsoft Windows Desktop Suite

a. Windows Explorer
b. Microsoft Word
c. Microsoft Excel
d. Microsoft PowerPoint

The following is a description of a specific embodiment in accordance with numerous aspects of the present invention. This embodiment can be employed in a single domain system or in a multi-domain system. Where the embodiment is employed in a single domain system, features described for use in a multi-domain system need not be provided. Similarly, where the embodiment is employed in a single domain system, features described for use in a multi-domain system need not be provided. The expression “DSA”, where employed in the following description, refers to the DSA according to this embodiment. The numerical headings are merely for cross-referencing throughout the description of this embodiment.

3. System Definition

This section states the purpose and objectives of this embodiment of the DSA system and describes its operational concepts.

3.1 System Top Level Description

FIG. 1 illustrates the theory of operation of a DSA system in a single Domain. Information flows are numerically labeled to correspond with the required sequence of operational events.

Users must first access DSA to unequivocally Identify & Authenticate their identity to the system. To request access to a data Target, a user must then submit the User Authentication Token they were provided by the system, along with a set of specific Identity Credentials unique to them and known by the system, along with their Request to perform an Operation on a Target. This Request may originate from two possible sources:
1. The user may have an existing (legacy) network-aware application that is integrated transparently using a DSA Application Integration Layer component to generate and issue the Request to DSA on the application's behalf.
2. A DSA-native application that was designed for the customer may issue Requests directly from the application.

DSA receives the Request, Authentication Token, and Credentials, and verifies that the User is authorized to perform the requested Operation on the Target within any specified constraints in the Domain's Security Policy. When the Operation is granted, DSA then generates an Agent.

FIG. 2 illustrates the theory of operation for a multiple-Domain DSA system. Information flows are numerically labeled to correspond with the required sequence of operational events. DSA restricts all communication between Domains to occur only through highly secure DSA-controlled connections that are dynamically established and torn-down in each direction, for each instance of communication (shown with bold arrows in FIG. 2). A user never knows that their Request may have a Target that is physically distributed across multiple Domains as illustrated in FIG. 2. Each DSA Domain operates independently with its own security policy, and is allowed to instantiate secure cross-Domain communications only with other Domains that are trusted. Even so, a DSA Domain never divulges location information of its local Targets across a Domain boundary. For the multiple Domain case, a Request is granted either entirely or not at all. Once all portions of a Target are granted in each Domain, the last Domain in the chain initiates construction of its Agent, and back-propagates the chain all the way to the first Domain that issued the original request. The user then may access their local Agent, without knowledge that there is a chain of multi-Domain Agents that are actually fulfilling the Request in its entirety, across Domain boundaries. In this manner, DSA provides cross-Domain trust management based upon a chain of trust of an “Agent”, not the user.

3.2 External Interfaces

This section identifies each system external interface and briefly describes the interfacing entities.

External communication to DSA originates from the user, the user's application process, and from external DSA Domains that are trusted. All communication external to DSA occurs over a network connection to a DSA Host, to a DSA process residing on an Administrator-selected TCP/IP port above 1000. Network connections in the entire system are assumed to emanate from standard off-the-shelf computers running a TCP/IP protocol stack, and connected to their respective subnets via standard Ethernet interfaces.

3.2.1 DSA Interfaces to Local Domain Users

DSA accepts communication from users in its local Domain to Identify & Authenticate themselves, and communicate their unique Credentials to the system for further identity validation when submitting specific Requests for data.

3.2.1.1 User Authentication Interface

Within a local Domain, all users requesting access to data must first Identify & Authenticate their identity with DSA. The user is prompted for their unique I&A information, and upon system verification, an Authentication token is provided back to the user, who can use this to initiate secure sessions with the system for data access Request processing.

3.2.1.2 User Application Integration

DSA accepts data access Requests from user applications running on a user's host computer. User applications, however, are not aware of the DSA Request processing API, so DSA must provide a transparent interface, called a Legacy Application Integration Layer, for integration of user applications. The Legacy Application Integration Layer is comprised of two types of integration components; network-aware applications and database applications as follows:

3.2.1.2.1 Network-Aware User Applications

User applications that are network-aware are already designed to perform push and pull-type operations on data over a network. To integrate these applications, DSA provides a DSA Client

Access Layer. The Client Access Layer is composed of a set of processes that are customized to the individual user application so that the application's native method for accessing data is transparently mapped into the DSA Request Processing API. The application (and user) is essentially unaware that DSA is controlling its access to the protected data.

FIG. 3 illustrates the nature of the Client Access Layer for network-aware application integration. Each Client Access Layer process may, but does not have to, reside on the same host computer as the user's application process.

The requirements for, and design of, each Client Access Layer component is customer-driven. Examples of candidate applications in this category include the Microsoft Windows Desktop Applications, including Windows Explorer, Microsoft Word, Excel, and PowerPoint to name a few.

3.2.1.2.2 Integration of Database Applications as a User Application

There may be instances where a customer requires that a database application be set up on the user's side of the system and integrated in a manner that allows the database to act like a user application, where it is allowed to push and pull information to and from the system.

To integrate databases as a user in this manner, DSA provides a DSA Thin Data Layer, which is composed of a set of processes that are customized to the individual database APIs so that the database's native method for accessing data is transparently mapped into the DSA Request Processing API, and the database application (and user) is essentially unaware that DSA is controlling its access to the protected data. FIG. 4 illustrates the nature of the Thin Data Layer for database application integration. Each Thin Data Layer process may, but does not have to, reside on the same host computer as the user's database application process.

The requirements for, and design of, each Thin Data Layer component is customer-driven. Examples of candidate database applications in this category include the Oracle and MySQL to name a few.

3.2.1.3 DSA Interfaces to Protected Data Hosts

DSA must interface over a network with the host computers on which the data protected by DSA resides. These Protected Data Hosts may host data that resides on a native file system on the host, or within a database installed on the host. DSA accounts for both of these cases in its interface architecture.

3.2.1.3.1 Protected Data on File System Hosts

To generate and maintain an accurate and current view of the data that it must protect that resides within a host's native filesystem, DSA must provide a set of Filesystem Monitor processes. These processes can transparently access and interpret the contents of the filesystem so that DSA can create its own internal metadata representation of information about the data Targets, including their security attributes and location information. FIG. 5 illustrates the DSA interface with a host having a filesystem upon which protected data resides.

The requirements for, and design of, each Filesystem Monitor component depends upon the nature of the filesystem(s) that a customer wishes to host their protected data upon. As such, these requirements are customer-driven. Representative examples of suitable filesystems for such use include ext2 (standard), swap (standard), ext3 (journaled), reiserfs (journaled), jfs (journaled), xfs (journaled), fat16 (Dos/Windows), fat32 (Windows), vfat (Windows), ntfs (Windows), ufs (bsd, SunOs, NetBsd, FreeBSD, NeXtStep), hfs (Macintosh), md (Multiple Device—RAID systems) and lvm (Logical Volume Manager).

For granted Operations, only DSA Agents have the privileges to perform the authorized Operations on the Data Targets in the protected data host computer, on behalf of the user. This interface is shown in FIG. 5.

3.2.1.3.2 Protected Data on Database Hosts

To generate and maintain an accurate and current view of the data that it must protect that resides within a host's database, DSA must provide a set of Database Monitor processes. These processes can transparently access and interpret the contents of the database so that DSA can create its own internal metadata representation of information about the data Targets, including their security attributes and location information. FIG. 6 illustrates the DSA interface with a host having a database upon which protected data resides.

The requirements for, and design of, each database monitoring component depends upon the nature of the database(s) upon which a customer wishes to host its protected data. As such, these requirements are customer-driven. Representative examples of suitable databases include MySQL 4.x and 5.x, PostgreSQL 8.x and Oracle 10.x.

Identical to the Filesystem host case for granted Operations, only DSA Agents have the privileges to perform the authorized Operations on the Data Targets in the protected data host computer, on behalf of the user. This interface is also shown in FIG. 6.

3.2.1.4 Data Target Access Request Handling & Processing Interface

As illustrated in FIG. 7, DSA provides a single interface to its local Domain users for processing their Requests for access-controlled data Targets, regardless of whether the Request is coming from a DSA-native application or is issued via a DSA Legacy Application Integration Layer process. The DSA Request Processing API requires an initial notification of intent to issue a request, to which it responds with the location of the interface to which the request has to be sent. This feature enables DSA to dynamically perform load balancing of its internal Request processing, by determining which of several possible internal Request processors should receive each Request. The user's application sends the user's Authentication Token (received from DSA during the I&A phase when the user authenticated himself) to the Request processing interface. The system then asks the user to provide an additional set of identity Credentials (defined by the customer for their Domain), which the system verifies. The requesting application subsequently issues to DSA the Request to perform an Operation on a data Target. If the Request is granted, DSA returns an encrypted Agent Access Token and the location of the Agent that has been created to execute the requested Operation.

3.2.2 DSA Inter-Domain Interface

As illustrated in FIG. 8, DSA provides an interface to other external DSA Domains for the purpose of processing Requests having Targets that span more than one Domain. The characteristics of this interface are unique in that the DSA system in each Domain creates a dynamic virtual channel through the hosts at each Domain boundary, such that the DSA-addressable endpoints in each Domain are “behind” the boundary-addressable endpoints of each Domain's boundary host. These virtual channels are established and torn-down for each instance of a communication across a Domain boundary. This mechanism is a highly secure method of cross-Domain communication because no Domain-specific physical addresses are exposed across a Domain boundary. Information sent across these inter-Domain channels is also encrypted for further protection.

FIG. 8 shows instances of cross-Domain communication are required for secure forwarding of non-local Request Targets, for secure forwarding of Agent location information back, and for secure cross-Domain access operations among Agents.

3.3 Major System Components

A single-domain system including a DSA according to this embodiment consists of the components listed in Table 7. The quantity of hosts in the system is entirely driven by a Customer's environment and the number of users it must support.

TABLE 7
Major System Components (Single-Domain)

| Qty | Component | Description | Type |
|---|---|---|---|
| 1 | DSA Core | The core internal DSA system software | Developed in |
| | System | components required to perform access Request | accordance |
| | Software | processing and security policy enforcement for a | with the |
| | | single Domain. Internal design is scalable, with | description |
| | | the ability to add additional internal processing | herein |
| | | components to satisfy processing load in large | |
| | | scale customer networks. | |
| Customer- | DSA Host | DSA host platforms running Security-Enhanced | COTS |
| Dependent | Computer(s) | Linux extensions to a Linux Operating System, | |
| | | configured with TCP/IP protocol stack and | |
| | | associated network interface. Provide I/O, | |
| | | processing, and storage for DSA system | |
| | | functions. Customer environment drives the | |
| | | number of hosts over which DSA core internal | |
| | | processes must be distributed. | |
| Customer- | Data Host File | These processes can transparently access and | Developed in |
| Dependent | System | interpret the contents of the filesystem so that | accordance |
| | Monitors | DSA can create its own internal metadata | with the |
| | | representation of information about the data | description |
| | | Targets, including their security attributes and | herein |
| | | location information. Developed for customers | |
| | | on an as-needed basis, depending upon the nature | |
| | | of the filesystems on their Protected Data Hosts. | |
| Customer- | Data Host | These processes can transparently access and | Developed in |
| Dependent | Database | interpret the contents of the database so that DSA | accordance |
| | Monitors | can create its own internal metadata | with the |
| | | representation of information about the data | description |
| | | Targets, including their security attributes and | herein |
| | | location information. Developed for customers on | |
| | | an as-needed basis, depending upon the nature of | |
| | | the databases on their Protected Data Hosts. | |
| Customer- | DSA Legacy | A DSA interface for providing transparent | Developed in |
| Dependent | Application | integration of user applications that are not aware | accordance |
| | Integration | of the DSA Request processing API. Developed | with the |
| | Layer | for customers on an as-needed basis, depending | description |
| | | upon the nature of the user-side applications and | herein |
| | | databases that must access DSA-protected data. | |
| Customer- | User | Commercial computing platforms hosting the | COTS |
| Dependent | Application | user applications that will access DSA to request | |
| | Hosts | data. No specialized Operating System | |
| | | requirements. Configured with TCP/IP protocol | |
| | | stack and network interface. | |
| Customer- | Protected Data | Commercial computing platforms hosting the | COTS |
| Dependent | Hosts | filesystems or databases upon which DSA- | |
| | | protected data resides. Require Secure Linux | |
| | | extensions to the host Operating System. | |
| | | Configured with TCP/IP protocol stack and | |
| | | network interface. | |
| 1 | TCP/IP | For a single Domain, all hosts in the system must | COTS |
| | Network | be network-reachable, and running a standard | |
| | | TCP/IP protocol stack. | |

System Operation
4.1 Administrator Scenarios

This section describes how the system is intended to be used by the DSA System Administrator, and is centered primarily on the Administrator's Operator-Machine Interface functionality. The DSA System Administrator is an authenticated Role in DSA that is granted access to all configuration parameters and audit logs in the system.

4.1.1 Administrator Configuration of Initial Operational Capability

Prior to the system's Initial Operational Capability, the System Administrator must perform the following configuration operations to initialize users, protected data, and system security parameters.

4.1.1.1 Definition of Domain Data Protection Levels

Data Protection Levels represent a hierarchical labeling and implied separation between groups of data that a customer wishes to protect differently in their domain. The System Administrator initializes the number of Domain data Protection Levels defined in the system and assigns named labels to those levels.

4.1.1.2 Initialization of Data Targets

The System Administrator specifies location information for data Target hosts, initializes Filesystem and Database Monitors on the data Target hosts, and instantiates the initial DSA-internal representation of all data Targets in the system's initial operational capability. While policy dictates that it is the responsibility of the creator of a data Target to label the Target with its Protection Level Label during system operation, it is prior to a system's initial operational capability that the System Administrator ensures that all pre-existing data Targets are labeled with the appropriate DSA Protection Level tags.

4.1.1.3 Definition and Assignment of Data Sets (Target Groups)

An optional configuration step available to the System Administrator is the ability to define Data Set Aliases, which are symbolic names for groups of Targets that can be defined by the System Administrator. Data Targets may then be assigned to Target Groups to simplify the security policy Rule specification process.

4.1.1.4 Definition of Need To Know

“Need To Know” is a data security attribute that allows the system to further restrict data access to only users that are verifiably associated (via user-submitted Credentials) with a specific “Need To Know” attribute. The use of “Need To Know” allows the system more granularity of access control to data Targets within a Protection Level. A practical example of its use is to assign a “Mission” or “Project”-based Need to Know label to a data Target, so that only users associated with that “Mission” are considered as eligible for access to that data Target when the system ultimately makes its access decision based on all other conditions/rules that apply. The System Administrator may optionally define the existence of, and labels for, the Need To Know attributes that must be enforced in a Domain.

4.1.1.5 Definition of User Roles

A Role is an administrative label that the System Administrator can define to simplify security policy rule administration for the many users in a Domain. The System Administrator first defines roles and their relationships, then Security Policy Rules are assigned to Roles (giving “privileges” to Roles that specify the allowed Operations they can perform on Targets), and then Roles may be assigned to users in the system. This process significantly eases the burden of individually assigning Security Policy Rules to each user in the system.

4.1.1.6 Initialization of Users

The System Administrator defines all user Identification & Authentication information, user-specific Credentials (including Need To Know) for further identity verification (possible using a configuration file rather than individually assigning all Credentials via a graphical interface), and assigns Clearance Levels to users. A Clearance Level represents the highest data Protection Level in the system that a user is allowed to access.

4.1.1.7 Definition of Domain Security Policy Rules

The System Administrator defines all Domain security policy Rules prior to initial operational capability. In DSA, the default is that no access is allowed to any Target unless a user is explicitly given privilege to perform an Operation on the Target. The Administrator may assign users to Roles to simplify security policy rule administration, or assign individual rules for users as needed.

4.1.2 Administrator Configuration During System Operation

The System Administrator may perform the following activities during system operation, via the System Administration Graphical User Interface. Upon committing any changes, the system adapts its enforcement mechanisms to coincide with the new configuration parameters.

4.1.2.1 View & Administration of Users

During system operation, the System Administrator may add and remove users, add and remove authentication privileges, and add and modify Clearance Levels.

4.1.2.2 View & Administration of Data Targets

The System Administrator may view the metadata attributes in the system's internal representation of the active data Targets, modify Protection Level labels on the Targets, add and or remove need to now attributes for data targets, and add or remove Targets from the system.

4.1.2.3 View & Administration of User Roles

The System Administrator may add and remove Roles, modify relationships between Roles, and add new relationships between Roles.

4.1.2.4 View & Administration of Security Policy Rules

The System Administrator may add and remove security policy Rules during operation. The system always ensures that access to data is denied unless a Rule exists that grants access.

4.1.2.5 View of System Security Audit Logs

The System Administrator may view the system's security audit logs at any time during system operation.

4.2 System States and Modes

This section describes how the system will be used, by describing the states in which it can exist and the modes of operation that can occur within each state.

4.2.1 Initialization State

The System Administrator's configuration of an Initial Operational Capability as described in Section 4.1.1 occurs once, and is not associated with the Initialization State of the system. The Initialization State is comprised of the sequential initialization of each of the DSA internal system components on their respective hosts. Full system initialization is successful when all DSA component processes have verified their unique identities and active status to the system control process.

4.2.2 Enabled State

The Enabled State is explicitly instantiated by the DSA System Administrator, and can only be done if the Initialization State was successful, and the system has determined that an initial configuration is present. The Enabled State has two modes of operation that can co-exist; a Request Processing Mode and an Administration Mode. If an initial configuration is not present, the system requires an Administration Mode session be completed before entering Request Processing Mode.

4.2.2.1 Request Processing Mode

The Request Processing Mode is the normal operational mode of the system. During this mode the system performs its primary long-term functional responsibility—processing data access Requests and enforcing the Domain's security policy rules.

4.2.2.2 Administration Mode

During the Enabled State, the System Administrator may instantiate a session with the system to perform any of the activities listed in Section 4.1.2. This administrative session does not interfere with the Request Processing mode, but committed changes to security parameters made by the Administrator do impact the system's enforcement of Rules during the Request processing cycle for Requests that are affected by the Administrator's changes.

4.2.3 Disabled State

The system may leave the Enabled State and transition into the Disabled State for the following reasons:
Whenever any non-redundant, critical DSA component process fails to respond to the System Controller with a “heartbeat” within an Administrator-defined grace period. This may occur for several reasons, including loss of a communication link, failure of a DSA host computer, or malfunction of a DSA component process.
Whenever a critical DSA component process fails to successfully authenticate itself to the System Controller within an Administrator-defined number of attempts. Such failure may occur due to malicious tampering with a component, or other unforeseen reasons.
The system determines via its security audit logs that a component process has malfunctioned in its Request processing behavior, and needs to be re-started.

Normal operation may still take place in all DSA component processes that are not affected by the disabled component, but at some point shortly thereafter the system as a whole will be unable to function until the disabled component becomes operational.

4.2.4 Shutdown State

The Shutdown State is a state where the System Controller explicitly stops all responsive system components. The system may transition to the Shutdown State either from the Enabled State or the Disabled State. Transition from Enabled to Shutdown State may be Administrator-initiated intentionally, or may occur if a critical security violation is detected by the system from its security audit logs. Transition from Disabled to Shutdown State may occur when any of the Administrator-defined grace periods or thresholds for automated recovery of a disabled component has been exceeded without success. The Shutdown State may only transition to the Initialization State, via manual Administrator initiation.

4.3 System Configuration Requirements

This section describes how the system is physically configured at start-up time, and how the configuration may be altered during operation as a result of state or mode changes or a failure occurrence. The following subsections provide a comprehensive sequential summary of the system configuration process, with some references to relevant portions of the process that were already described in Sections 4.1 and 4.2.

4.3.1 Establish Initial Operational Capability

The set of activities in this subsection is performed once at the time of initial system deployment.

4.3.1.1 Configure DSA Secure Hosts

The System Administrator must manually configure the following parameters on the secure hosts upon which each DSA component process resides.

4.3.1.1.1 Configuration of Secure Operating System Policies

A key requirement for correct initial configuration of an operational DSA system is that the System Administrator must manually set Mandatory Access Control (MAC) policy parameters in the Security-Enhanced Linux (SE-Linux) kernel extensions such that all DSA processes on each DSA host have equal process priorities, and that no other application processes have higher process priority tha DSA.

4.3.1.1.2 Configuration of Network Access (Port) Restrictions

To further reduce potential system vulnerabilities to network attacks, all DSA hosts will have their network access restricted via Administrator-initiated disabling of all TCP/IP network ports below 1000, except for Port 22 (SSH login).

4.3.1.2 Configure Protected Data Hosts

The System Administrator must also manually configure the following parameters on the secure hosts upon which protected data Targets reside.

4.3.1.2.1 Configuration of Secure Operating System Policies

For DSA-protected data hosts, it is a critical requirement that the System Administrator must manually set the following Mandatory Access Control (MAC) policy parameters in the Security-Enhanced Linux (SE-Linux) kernel extensions of the operating system:
Set process priorities such that only DSA processes are able to access protected data.
   4.3.1.2.2 Configure Database-specific Access Control (if Applicable)

If a protected data host houses its data in a database rather than a filesystem, then the System Administrator must configure the database such that DSA is an authorized user of the database. In this case, DSA can only add additional restrictions (to what the database's native access control mechanism already is configured to allow) on Operations that can be performed on data Targets in the database. DSA can therefore be configured to further narrow what a database's native access control mechanism is configured to allow, but the two must not conflict. Ideally, DSA may be configured as the only authorized-“user” of the database.

4.3.1.2.3 Configure Network Access (Port) Restrictions

For protected data hosts, this requirement is identical to that in 4.3.1.1.2.

4.3.1.3 Enter Initialization State

The System Administrator must define the physical topology (i.e.—DSA host addressing information) for all DSA hosts in the Domain and save this in a secure configuration file. The Administrator must manually initialize the DSA System Controller process, which utilizes the configuration file to initialize all DSA component processes with their associated identity and configuration parameters. Upon verification of successful initialization of all DSA component processes via receipt of valid “heartbeats” from each component by the System Controller, the system allows the Administrator to transition the system into the Enabled State.

4.3.1.4 Perform DSA System Administration (Administration Mode)

Prior to going into Request Processing Mode, the system must verify that an initial configuration has been established for the system. If no initial configuration exists, then the system requires an Administrative Mode session where the configuration steps defined in Section 4.1.1 must be performed.

4.3.1.5 Enter Request Processing Mode

Upon successful completion of an initial administrative configuration, the system may enter Request Processing Mode and begin processing Requests. From this point forward, the system may enable Administrative Mode Sessions as needed and perform all activities described in Section 4.1.2, during normal operation in Request Processing Mode.

4.3.1.6 Enter Disabled State

Section 4.2.3 describes the conditions under which the system can enter and exit the Disabled State.

4.3.1.7 Enter Shutdown State

Section 4.2.4 describes the conditions under which the system can enter and exit the Shutdown State.

5. System Requirements

This section describes all required DSA system-level capabilities and their purposes, and itemizes the requirements associated with each capability. All requirements in this section specify the required behavior of the system, including any relevant performance measures and required behavior under unexpected conditions.

5.1 Life Cycle Support Requirements

This subsection specifies life cycle factors that are applicable to the DSA system.

5.1.1 Operability

5.1.1.1 Secure System Administrative Access

DSA shall {5.1.1.1-1} allow access to its System Administration capability only through the System Administrator Role.

5.1.2 Supportability

5.1.2.1 Reliability

DSA shall {5.1.2.1-1} provide normal operations on a 24 hours per day, 7 days per week basis.

All DSA system components are designed to operate independently in a distributed configuration. For reasons that include communication link failure, DSA host computer failure, or malicious security behavior, an individual system component may enter a Disabled State. The Disabled State of operation, along with the criteria for which a component is transitioned into a Disabled State, are defined in Section 4.2.3. The system is defined as entering the Disabled State whenever any non-redundant, critical DSA component enters a Disabled State.

When the DSA System Controller component enters into the Disabled State, the DSA system shall {5.1.2.1-2} immediately be transitioned into the Shutdown State.

When a DSA component other than the System Controller enters into a Disabled State of operation, the System Controller shall {5.1.2.1-3} attempt to re-start the component an Administrator-configurable number of times before transitioning the component to a Shutdown State.

When a DSA component enters a Disabled State of operation because the component fails to respond to the System Controller with a “heartbeat” within an Administrator-defined grace period, the System Controller shall {5.1.2.1-4} transition the component into a Shutdown State and attempt to re-start it.

When a DSA component fails to successfully authenticate itself to the System Controller within an Administrator-defined number of attempts, the System Controller shall {5.1.2.1-5} transition the component to a Shutdown State and attempt to re-start it.

When DSA security audit log event processing determines that a component has malfunctioned in its Request processing behavior, as determined by a mismatch in input and output Requests, the System Controller shall {5.1.2.1-6} transition the component to a Shutdown state and attempt to re-start it.

When DSA security audit log event processing determines that the system has malfunctioned in its aggregate Request processing behavior, as determined by a mismatch in input and output Requests, the System Controller shall {5.1.2.1-7} transition the system to a Shutdown state and attempt to re-start all components.

5.1.3 Software Portability

The DSA core system component processes shall {5.1.3-1} be portable to host computers running the following Operating Systems:
1. Fedora Linux 32 bit—with Security-Enhanced Linux extensions
2. Fedora Linux 64 bit—with Security-Enhanced Linux extensions
3. FreeBSD 6.0
   5.2 External Interfaces

This subsection describes the interfaces external to DSA, and provides the requirements imposed on the system to achieve those interfaces.

5.2.1 Network Layer Interface

All DSA host component computers shall {5.2.1-1} be configured with standard off-the-shelf Ethernet network interfaces as their means of network communication.

All external network communication to and from DSA component host computers shall {5.2.1-2} occur on Administrator-selected TCP/IP Ports above 1000.

5.2.2 DSA Interfaces to Local Domain Users

5.2.2.1 User Authentication Interface

DSA shall {5.2.2-1} provide a network-accessible external interface to its Identification & Authentication function, for users to authenticate themselves and establish a secure session with DSA.

5.2.2.2 Application-Layer Integration

DSA will provide external interfaces for integration of customer (user) desktop applications and (user) database applications on a customer-driven basis, and these external interfaces will be designed and documented in separate IDDs as needed for future customers.

5.2.2.3 DSA Interfaces to Protected Data Hosts

DSA interacts over a network with the host computers on which the data protected by DSA resides. These Protected Data Hosts may host data that resides on a native filesystem on the host, or within a database installed on the host. DSA must provide interfaces for both of these cases in its interface architecture, as follows:

5.2.2.3.1 Data Target File System Host Interface

Section 3.2.1.3.1 describes the background pertaining to the DSA Filesystem Monitor capability on data Target hosts.

DSA shall {5.2.2.3.1-1} provide a Filesystem Monitor interface to each of the following filesystem types: ext2 (standard), swap (standard), ext3 (journaled), reiserfs (journaled), jfs (journaled), xfs (journaled), fat16 (Dos/Windows), fat32(Windows), vfat (Windows), ntfs (Windows), ufs (bsd, SunOs, NetBsd, FreeBSD, NeXtStep), hfs (Macintosh), md (Multiple Device—RAID systems) and lvm (Logical Volume Manager).

The requirements for, and design of, additional Filesystem Monitor components depends upon the nature of the filesystem(s) that a customer wishes to host their protected data upon. As such, these requirements are customer-driven and will be documented in separate IDDs as needed in the future.

5.2.2.3.2 Data Target Database Hosts

Section 3.2.1.3.2 describes the background pertaining to the DSA Database Monitor capability on data Target hosts.

DSA shall {5.2.2.3.2-1} provide a Database Monitor interface to each of the following database types:
1. MySQL 4.x and 5.x
2. PostgreSQL 8.x
3. Oracle 10.x

The requirements for, and design of, additional Database Monitor components depends upon the nature of the database(s) that a customer wishes to host their protected data upon. As such, these requirements are customer-driven and will be documented in separate IDDs as needed in the future.

5.2.2.4 Access Request Handling Interface

Section 3.2.1.4 describes the nature of the DSA interface for Access Request Handling.

DSA shall {5.2.2.4-1} provide an Access Request Handling Application Programming Interface (API) that receives notification of intent to submit access Requests from user applications.

The Access Request Handling Interface shall {5.2.2.4-2} receive the following data:
1. An attribute for Notification of intent to submit a Request
2. A Call-back interface to the user's application process

The Access Request Handling Interface shall {5.2.2.4-3} provide the following data to the Requestor:
1. The location of its Access Request Processing Interface
   5.2.2.5 Access Request Processing Interface

Section 3.2.1.4 describes the nature of the DSA interface for Access Request Processing.

DSA shall {5.2.2.5-1} provide a location-transparent Access Request Processing API that receives access Requests from user applications.

For a location-transparent interface, the address of the interface component is not provided to the user in advance.

The Access Request Processing Interface shall {5.2.2.5-2} receive the following data:
1. A Call-back interface to the user's application process
2. The user's Authentication Token
3. The user's identity Credentials
4. A DSA Data Target Access Request, which includes:
   a. User ID
   b. Requested Operation (Publish, Subscribe, Read, Write)
   c. An identifier for the desired data Target

The Access Request Processing Interface shall {5.2.2.5-3} provide the following data to the Requestor:
1. A Request Identifier (if and only if the submitted Request was valid in its structure, and the user is known to the system)
2. An encrypted Agent Access Token (if and only if the Request was granted)
3. Location information for the Domain Agent created to satisfy the Request (if and only if the Request was granted)
   5.2.2.6 User Credentials Interface

For each access attempt to a data Target that has a Need To Know security attribute associated with it, DSA shall {5.2.2.6-1} dynamically provide a graphical interface to the user requesting the user to provide their unique (Administrator-defined) Credentials that verify their Need To Know for that data Target.

5.2.3 DSA Inter-Domain Access Interface

Section 3.2.2 describes the nature of the DSA inter-Domain Interface.

DSA shall {5.2.3-1} provide an inter-Domain Access Interface that is externally accessible only to other instances of the inter-Domain Access Interface in other DSA Domains.

The DSA inter-Domain Access Interface shall {5.2.3-2} be capable of dynamically responding to the inter-Domain Access Interface of another Domain on its trusted Domain list, when:
1. contacted to establish a secure connection
2. contacted to terminate a secure connection

Because the inter-Domain Access Interface is only involved with secure transport of information between DSA Domains, there are no external data-specific requirements.

5.3 Operational Requirements

This section describes the Operator-Machine requirements of the system, including the information to be displayed and the manual operations required to operate the system in each state and mode.

5.3.1 System Administration Interface Capabilities

DSA shall {5.3.1-1} provide a Graphical User Interface (GUI) to its System Administration function.

Operating in the system's Administrative Mode of the Enabled State, the System Administration GUI:

Shall {5.3.1-2} enable the Administrator to transition any of the DSA components, except the System Controller, into a Shutdown State.

Shall {5.3.1-3} enable the Administrator to specify the number of Hierarchical data Protection Levels required in the Domain, up to the system-defined maximum limit. The assignment of one (1) Protection Level signifies that all Data Targets and Users in that Domain are at the same level.

Shall {5.3.1-4} enable the Administrator to assign Labels for each Hierarchical Protection Level defined in the Domain.

Shall {5.3.1-5} enable the Administrator to add and remove users from the Domain, and view a summary of active users and their associated “Clearance Level” attribute.

Shall {5.3.1-6} for every new user added to the system, assign a default value for the user's Clearance Level attribute to be the lowest defined Protection Level in the Domain. The default value may be overwritten by a value that is entered by the Administrator.

Shall {5.3.1-7} enable the Administrator to view a summary of the contents of the system's internal metadata representation associated with data Targets in the Domain, including Protection Level labels as a minimum.

Shall {5.3.1-8} enable the Administrator to assign Hierarchical Protection Level labels to Data Targets in the system's internal representation.

Shall {5.3.1-9} enable the Administrator to open and delete any Data Targets in the Domain.

Shall {5.3.1-10} enable the Administrator to define aliases (labeled names) for groups of Data Targets in the Domain.

Shall {5.3.1-11} enable the Administrator to associate Data Targets in the Domain with an existing Data Target Group alias.

Shall {5.3.1-12} enable the Administrator to define the labels for user Roles in the system. (A Role is a label that the Administrator can define to simplify future security policy rule administration for the many users in a Domain).

Shall {5.3.1-13} enable the Administrator to define “lattice” relationships between the Roles in the system, where Roles in the lattice may be assigned in both a peer and hierarchical relationship to each other. The Roles in each successively lower tier in a Role lattice shall {5.3.1-14} only be allowed to inherit an Administrator-specified subset from the set of Privileges assigned to the tier directly above it.

Shall {5.3.1-15} enable the Administrator to assign security policy Rules to Roles.

Shall {5.3.1-16} enable the Administrator to assign a Clearance Level to users in the Domain, with the option to assign a Clearance Level to “All”, to “Roles”, and to individual users.

Shall {5.3.1-17} enable the Administrator to assign Roles to users in the Domain.

Shall {5.3.1-18} enable the Administrator to define Security Policy Rules that apply to a Data Target Group.

Shall {5.3.1-19} enable the Administrator to Create, Modify, and Delete Security Policy Rules for the DSA Domain.

A Rule specifies that a (“user” or “Role”) can perform an “Operation” on a data “Target”, with an optional constraint on “Time”. Valid Operations include “Read”, “Write”, “Publish”, and “Subscribe”. Valid “Time Constraints” include options for “granted between two specified date/times”, “granted before a specified date/time”, or “granted after a specified date/time”.

Shall {5.3.1-20} enable the Administrator to review the Security Audit Logs for each of the DSA Components in the Domain.

Shall {5.3.1-21} enable the Administrator to filter their view of an Audit Log based on messages entering the process, messages exiting the process, Request ID, Requestor identity, and Request Timestamp.

Shall {5.3.1-22} enable the Administrator to generate and view a statistical representation of data in a Security Audit Log, including: Requests received and Requests forwarded.

Shall {5.3.1-23} enable the Administrator to create, modify, and delete labels for the Need To Know security attributes that must be enforced in the Domain.

Shall {5.3.1-24} enable the Administrator to associate Need To Know labels with the data Targets in the Domain.

5.4 Performance Requirements

This section lists the performance requirements associated with the DSA system.

5.4.1 Scalability of Core System Functions

DSA shall {5.4.1-1} modularly be able to scale its Access Request Processing function to operate under a loading of at least 200 Requests per second.

DSA shall {5.4.1-2} modularly be able to scale its Security Policy Rule Enforcement function to operate under a loading of at least 200 Requests per second.

5.4.2 Internal Load Balancing

DSA shall {5.4.2-1} be able to control the individual loading assigned across each of its Access Request Processing components, in configurations where this function is modularly scaled.

5.4.3 Component Identity Control

DSA shall {5.4.3-1} explicitly control the authentic identities of every DSA core functional component in the system. This requirement provides enhanced system security, and significantly helps to prevent insider attacks. The methods available to provide this capability include hashed identification codes, inter-process heartbeats, and event-notification based activity logging.

5.4.4 Secure Control of all System Software Components

DSA shall {5.4.4-1} be able to explicitly and securely control (startup and shutdown) each of its core functional components from its System Control function. This requirement addresses the need for exclusive system control over all core functional components in the distributed security architecture, providing additional security in situations dealing with unexpected events, such as network and host failures, and malicious security behavior.

5.4.5 System Component Independent Operation

In cases where a core DSA system functional component becomes isolated from the remainder of the system, the component shall {5.4.5-1} continue to perform its functional responsibility and attempt (for an Administrator-defined interval) to communicate with the system. This requirement addresses operation under conditions of unexpected network connectivity anomalies (including link and network failures, and failures of other components or their hosts).

5.4.6 Secure Inter-Component Communication

All communication between core DSA system functional components shall {5.4.6-1} be encrypted.

5.4.7 Secure, Restricted Inter-Domain Communication

The requirements in this subsection provide dynamic and secure peer-to-peer Domain connectivity for processing of cross-Domain access Requests.

For any instance of communication required across a security Domain boundary to another Domain, DSA shall {5.4.7-1} for each Request dynamically establish a secure tunnel to another peer DSA Domain (without exposing any subnet nodes).

DSA shall {5.4.7-2} dynamically release the secure tunnel after the transfer is completed.

5.4.8 Location Transparency

DSA utilizes location transparency in two unique ways to support scalability and provide an additional level of security throughout the system.

5.4.8.1 System Component Location Transparency

DSA shall {5.4.8.1-1} require each of its core system functional components to dynamically determine the physical location (address) of another system component to which it must communicate.

DSA shall {5.4.8.1-2} control access between its core system functional components such that only those components having a defined functional responsibility to inter-communicate are allowed to determine the location information of a component to which it must communicate.

5.4.8.2 Location Transparency of Granted Target Data to Users

DSA shall {5.4.8.2-1} explicitly hide all data Target location information from its Requestors (users) during access Request processing, after Requests have been granted, and during the granted access Operation. This is a critical requirement of the system, and also one of its most important unique differentiators. In DSA, there are no “direct” connections allowed between the source of a Request and the Target data (for pull Operations), or location of the Target (for push Operations). All Target location information is “hidden” by DSA, even after access has been granted. Users do not need to know where their granted data resides, or where their published data will be stored.

5.4.9 Multi-Domain, Multi-Request Processing

DSA shall {5.4.9-1} be able to enforce access control decisions where the Target of a Request resides in a single Domain, or is distributed across multiple Domains.

DSA shall {5.4.9-2} be able to enforce access control decisions with multiple Targets specified in a Request, where each Target may have its own source or destination, but only if all Targets are either “push” or “pull” in nature.

5.4.10 Data “Owner” Retention of Permanent Access Rights

DSA shall {5.4.10-1} enable the owner of a data Target to retain permanent access control, even for granted transactions. Even after access has been granted to a Target, and Agent interfaces are created by DSA, local security policy changes that occur during system operation may result in Agent or certificate destruction. This means that the “owners” of Target data in each Domain always have final control over access, independent of issued permissions.

5.4.11 Dynamic Creation of Interfaces to Granted Targets

DSA shall {5.4.11-1} be able to dynamically create and destroy location-transparent interfaces to granted data Targets.

DSA shall {5.4.11-2} be able to dynamically link the interfaces to granted data Targets across each Domain of a multi-Domain Request.

The Agent “chain” (for a multi-Domain Request) created by DSA consists of distributed, linked Agent “interfaces” created on-the-fly for granted requests. A secure token provided back to a Requestor enables transparent access to approved Agent interfaces. In addition to DSA-unique security certificates, granted permissions may also contain 3rd party security certificates in a DSA token.

5.5 Design and Construction Requirements

There are no specific DSA requirements pertaining to physical constraints for the system.

5.6 Adaptation

This section specifies requirements concerning installation-dependent data that the system is required to provide, and operational parameters that the system is required to use that vary according to operational needs.

5.6.1 Distributed Component Location Initialization

DSA shall {5.6.1-1} support flexible initialization of its core system functional components on their individual host platforms each having locations (addresses) specified by a customer at the time of installation.

5.6.2 User Application Integration

Individual customers will specify their requirements for the user-side applications and databases that they wish to integrate as “Requestors” in a DSA Domain. On a case-by-case basis, this will dictate which DSA Client Access Layer (described 3.2.1.2.1) and Thin Data Layer (described 3.2.1.2.2) processes are required to complete user application integration with a DSA core system.

5.6.3 Protected Data Host Integration

Individual customers will specify their requirements for the data (Target)-side applications and databases that they wish to integrate as “datastores” to host the data Targets in a DSA Domain. On a case-by-case basis, this will dictate which DSA Filesystem Monitor (described 3.2.1.3.1) and Database Monitor (described 3.2.1.3.2) processes are required to complete data Target integration with a DSA core system.

5.7 Utilization

This section specifies the computer hardware and software utilization requirements for the system.

5.7.1 Computer Hardware Requirements

DSA software components shall {5.7.1.-1} be hosted on any choice of standard Commercial-Off-The-Shelf computing hardware platforms that are capable of running a Linux Operating System kernel.

Each DSA host computer shall {5.7.1-2} be configured with a commercially available Ethernet network interface card that is compatible with the host Operating System.

5.7.2 Computer Hardware Resource Utilization Requirements

Not applicable.

5.7.3 Computer Software Requirements

DSA software components {5.7.3-3} are hosted on computing platforms running one of the Operating Systems specified in Section 5.1.3.

5.7.4 Computer Communications Requirements

All network communications between DSA hosts shall {5.7.4-1} utilize the standard TCP/IP protocol stack available in the host Operating Systems specified in Section 5.1.3.

5.8 Human Factors

There are no human factors requirements applicable to DSA.

6. System Functional Architecture

This section describes the overall DSA functional architecture, and the concept of execution among the system functions.

6.1 System Functional Description

Table 8 lists the DSA system functions and summarizes their responsibilities and major subfunctions.

TABLE 8
DSA System Functions

| System Function | Description/Subfunctions |
|---|---|
| System Control | Initiates & terminates all DSA components |
| | Establishes unique identities for all components |
| | Monitors the state of all components |
| | Collects security audit data from all components |
| | Collects its own security audit data |
| | Encrypts its communications with other components |
| Inter-Process | Restricts access between DSA core system functional components such |
| Location | that only those components having a defined functional responsibility to |
| Transparency | inter-communicate are allowed to determine the location information of |
| | a component to which it must communicate |
| | Returns a reference to the physical location (address) of a system |
| | component to which another component is requesting to communicate |
| | with. |
| Identification & | Performs an Identification & Authentication function for users |
| Authentication | to authenticate themselves and establish a secure session with DSA. |
| System | Provides a Graphical User Interface to the System |
| Adminstration | Administrator to perform the system administration subfunctions |
| | described in Section 4.1 |
| Access Request | Provides a network-accessible interface to users that notify |
| Handling | their intent to submit a data Target access Request to the system. |
| | Responds with the location of the interface to which the |
| | Request has to be sent. Dynamically performs load balancing of DSA |
| | internal Request processing, by determining which of several possible |
| | internal Request processors should receive each Request. |
| Access Request | Processes Requests from user applications requesting access |
| Processing | to protected data Targets. |
| | Verifies receipt of a valid user Authentication Token, valid |
| | identity Credentials, and a valid Request. |
| | Forwards multi-Domain Requests to Inter-Domain access |
| | controller. |
| | For Requests that have been granted, returns to the Requestor |
| | an encrypted Agent Access Token, and location of the Domain's data |
| | Target access Agent that has privilege to perform the granted |
| | Operation on behalf of the Requestor. |
| | Creates and maintains all data Target access Agents in the |
| | Domain. |
| | Verifies Requestor-submitted Agent Access Token prior to |
| | allowing a Requestor to access an Agent that was created in response |
| | to a granted Request. |
| Data Access | Performs granted Operation on a data Target and returns result |
| Location | (for pull operations), or moves data to an approved Target location |
| Transparency | (for push operations). |
| Security | Dynamically monitors data Targets for user-driven changes to |
| Attribute | security attributes. |
| Updating | Notifies Policy Enforcement of changes to security attributes. |
| Security Policy | Enforces all security policy rules in a Domain. For each |
| Rule | Request, verifies that the Request is not violating a rule prohibiting |
| Enforcement | the requested Operation on a data Target. |
| Virtual Resource | Verifies the existence of a data Target in a Domain. |
| Management | Verifies the security metadata attributes associated with data |
| | Targets in a Domain. |
| Virtual Resource | Maintains a metadata summary of a Domain's data Target |
| Representation | security attributes and location information. |
| Inter-Domain | Provides an inter-Domain Access Interface that is externally |
| Access Control | accessible only to other instances of the inter-Domain Access |
| | Interface in other DSA Domains. |
| | Dynamically responds to the inter-Domain Access Interface of |
| | another Domain on its trusted Domain list, when: |
| | 1. contacted to establish a secure connection |
| | 2. contacted to terminate a secure connection |
| | Provides secure transport of information between Domains. |
| Protected Data | Provides transparent access to, and interpretation of, the file |
| Filesystem | contents for a specific filesystem type that resides on a data Target |
| Monitoring | host. |
| | Interprets requests for access to data Targets, from Agents in the |
| | Domain. |
| Protected Data | Provides transparent access to, and interpretation of, the database |
| Database | contents for a specific database type that resides on a data Target host. |
| Monitoring | Interprets requests for access to data Targets, from Agents in the |
| | Domain. |
| Client | Provides an interface for transparent integration of user network- |
| Application | aware applications that are not aware of the DSA Request processing |
| Integration | API. Developed for customers on an as-needed basis, depending upon |
| Interface | the nature of the user-side applications that must access DSA- |
| | protected data. |
| Client Database | Provides an interface for transparent integration of user database |
| Integration | applications that are not aware of the DSA Request processing API. |
| Interface | Developed for customers on an as-needed basis, depending upon the |
| | nature of the user-side databases that must access DSA-protected data. |

6.1.1 Functional Interaction During Initialization State

FIG. 9 illustrates the sequenced flows among the DSA functions that participate in the system's Initialization State.

6.1.2 Functional Interaction During the Enabled State

6.1.2.1 Functional Interaction in Operational Mode

FIG. 10 illustrates the sequenced flows among the DSA functions that participate in the system's Request Processing Mode during the Enabled State. A single-domain Request processing and fulfillment cycle is shown, along with a user application's data Target access Operation via an Agent.

7. System Physical Architecture

This section describes the physical system architectural design of DSA, including a block diagram of the system. DSA is comprised of a single CSCI. There is no HWCI for DSA.

7.1 System-Wide Design Decisions

System-wide design decisions affecting the single DSA CSCI were identified in Section 5.

7.2 System Physical Description

A diagram of the DSA physical system is shown in FIG. 11. All host computers, including user application hosts, DSA hosts, and data Target hosts, are on a Domain TCP/IP network.

7.3 System Internal/External Interface Description

The DSA external interface architecture was fully described in Section 3.2. The internal interface architecture is illustrated in FIGS. 9 and 10.

7.4 System Internal Data Description

Internal to the DSA CSCI, between the core functional components, the component-to-component messages are all Sensis-defined and encrypted between components for system security purposes. This is also true for inter-Domain communications between DSA peer systems. The external API to user applications is an open API for developers to use in designing interfaces that connect either DSA native applications or user-legacy applications to the DSA core system. The nature of the messages passed to and from the external DSA user-side API is described in FIG. 7 and in Section 3.2.1.4.

8. CSCI Requirements

This section specifies the Computer Software Configuration Item (CSCI) requirements for DSA, which capture the characteristics of the system that are the conditions for its acceptance. DSA is composed of a single CSCI, and the DSA CSCI requirements are the software requirements that are generated to satisfy the system requirements defined in Section 5. The CSCI requirements are organized into groups of system capabilities, as specified in Section 8.2.

8.1 Required States and Modes

DSA shall {8.1-1} be capable of operating in the following States and Modes, as defined in Section 4.2:
1. Initialization State
2. Enabled State
   a. Administration Mode
   b. Request Processing Mode
3. Disabled State
4. Shutdown State

DSA shall {8.1-2} transition its operation between States in accordance with the conditions specified in Section 4.2.

8.2 Capability Requirements

8.2.1 Identification & Authentication

8.2.1.1 Authentication Failure Handling

DSA shall {8.2.1.1-1} detect when an (Administrator-configurable positive integer within a range of acceptable values) number of unsuccessful user and Administrator authentication attempts occur to DSA.

When the defined number of unsuccessful authentication attempts has been met or surpassed, DSA shall {8.2.1.1-2} mark the user and add them to a rejection list.

8.2.1.2 User Attribute Definition

DSA shall {8.2.1.2-1} maintain the following list of security attributes belonging to individual users: Name, Password and a Domain-dependent, Administrator-specified, dynamic list of user identification Credentials (including need to know credentials, if applicable).

8.2.1.3 Specification of Secrets

8.2.1.3.1 Verification of Secrets

DSA shall {8.2.1.3.1-1} provide a mechanism to verify that secrets meet all Administrator-predefined user Credentials.

8.2.1.4 DSA Generation of Secrets

DSA shall {8.2.1.4-1} provide a mechanism to generate secrets that meet Domain-defined security requirements.

DSA shall {8.2.1.4-2} be able to enforce the use of DSA-generated secrets for authentication based on user Credentials.

8.2.1.5 User Authentication

8.2.1.5.1 User Authentication Before Any Action

DSA shall {8.2.1.5.1-1} require each user to be successfully authenticated before allowing any other DSA security function-mediated actions on behalf of that user.

8.2.1.6 Unforgeable Authentication

DSA shall {8.2.1.6-1} prevent use of authentication data that has been forged by any user of DSA.

DSA shall {8.2.1.6-2} prevent use of authentication data that has been copied from any other user of DSA.

8.2.1.7 Single-Use Authentication Mechanisms

DSA shall {8.2.1.7-1} prevent re-use of authentication data related to a granted Request.

8.2.1.8 Re-Authenticating

DSA shall {8.2.1.8-1} re-authenticate the user if a system-defined timeout period expires.

8.2.1.9 User-Subject Binding

DSA shall {8.2.1.9-1} associate the appropriate user security attributes with subjects acting on behalf of that user.

8.2.2 System Access

8.2.2.1 Session Establishment

DSA shall {8.2.2.1-1} be able to deny session establishment based on determination that a user has provided incorrect identity Credentials with their access Request.

If a Need To Know attribute is associated with a requested data Target, DSA shall {8.2.2.1-2} require the requestor to provide additional identity Credentials verifying their Need To Know for that data Target.

DSA shall {8.2.2.1-3} be able to deny session establishment based on determination that a user has provided incorrect Need To Know identity Credentials in response to system prompts during Request processing.

8.2.3 User Data Protection

8.2.3.1 Access Control Policy

8.2.3.1.1 Complete Access Control

DSA shall {8.2.3.1.1-1} enforce its System Access Control Policy on all users and all data Targets, and all Operations among users and data Targets covered by the System Access Control Policy.

DSA shall {8.2.3.1.1-2} ensure that all Operations between any user in the Domain and any data Target in the Domain are covered by the DSA System Access Control Policy.

8.2.3.2 Access Control Functions

DSA shall {8.2.3.2-1} enforce the DSA System Access Control Policy to its protected data Targets based on the following user and data Target security attributes specified in Tables 9 and 10:

TABLE 9
Requestor/User Security Attributes

| Subject | Attributes |
|---|---|
| Requestor/User | Authentication Token |
| | Credentials (including for Need to Know) |
| | Clearance Level |

TABLE 10
Data Target Security Attributes

| Object | Attributes |
|---|---|
| data Target | Protection Level |
| | Need to Know |
| | Time (of access attempt) |

DSA shall {8.2.3.2-2} enforce all of the rules in Table 11 to determine if an Operation among controlled users and controlled data Targets is allowed:

TABLE 11
Rules to Allow Requested Operations in DSA

| Operations | Rules to Allow Requested Operation |
|---|---|
| Read, | 1. The user's Authentication Token is valid in the Domain at the Time of the Request. |
| Write, | |
| Publish, | |
| Subscribe | |
| Read, | 2. The user provided all valid additional identification Credentials that the system |
| Write, | required for their session, at the time of the Request. |
| Publish, | |
| Subscribe | |
| Read, | 3. The user's Clearance Level is greater than, or equal to, the hierarchical Protection |
| Write, | Level assigned to the requested data Target, at the Time of the Request. |
| Publish, | |
| Subscribe | |
| Read, | 4. If Need To Know is applicable to a requested data Target, the user provided all valid |
| Write, | additional identification Credentials that the system required to verify their Need To |
| Publish, | Know, during Request processing. |
| Subscribe | |
| Read, | 5. The system verifies that the user has the privilege of performing the requested |
| Write, | Operation on the specified data Target, at the Time of the enforcement decision. |
| Publish, | |
| Subscribe | |
| Read, | 6. The user's Authentication Token is valid in the Domain at the Time of the access |
| Write, | Operation. |
| Publish, | |
| Subscribe | |
| Read, | 7. The user's additional identification Credentials are still valid at the Time of the |
| Write, | access Operation |
| Publish, | |
| Subscribe | |
| Read, | 8. The user's Clearance Level is greater than, or equal to, the hierarchical Protection |
| Write, | Level assigned to the requested data Target, at the Time of the access Operation. |
| Publish, | |
| Subscribe | |
| Read, | 9. The system has not revoked the user's privilege of performing the requested |
| Write, | Operation on the specified data Target, between the time of the enforcement decision |
| Publish, | and the Time of the access Operation. |
| Subscribe | |
| Read, | 10. There are no Time Constraints associated with access to the requested data Target |
| Write, | that prevent the user from accessing the Target at the Time of the access Operation. |
| Publish, | |
| Subscribe | |

DSA shall {8.2.3.2-3} explicitly deny access of users to data Targets if any of the following seven (7) conditions are TRUE:
1. The user provided an invalid Authentication Token with their Request.
2. The user's Authentication permissions were revoked, between the Time of the Request and the Time of the Operation to access the data Target.
3. The user provided an invalid set of additional identification Credentials that the system required for their session, including Need To Know for a specific data Target.
1. The system does not give that user/Role the privilege of performing the requested Operation on the specified data Target, at both the time of the Request, and the time of the access Operation.
5. There are Time Constraints associated with access to the requested data Target that prevent the user from accessing the Target at the Time of the access Operation.
6. The user's Clearance Level is lesser than the hierarchical Protection Level assigned to the requested data Target, at the Time of the Request, or at the time of the access Operation.
7. The data Target no longer exists in the Domain at the Time of the access Operation.
   8.2.3.3 Security Attribute Updating

DSA shall {8.2.3.3-1} provide the capability to detect changes in the Protection Level attribute associated with a data Target, when a data Target is Written or Published.

DSA shall {8.2.3.3-2} provide the capability to dynamically update its Policy Enforcement function upon determination that a data Target's Protection Level attribute has been modified.

DSA shall {8.2.3.3-3} provide the capability to dynamically update its Policy Enforcement function upon determination that a data Target's Need To Know attribute has been modified.

8.2.3.4 Virtual Resource Management

DSA shall {8.2.3.4-1} provide the capability to verify the existence of all protected data Targets in its Domain.

DSA shall {8.2.3.4-2} provide the capability to associate all data Targets in a Domain with their relevant security attributes.

8.2.3.5 Export to outside of local Domain Control

8.2.3.5.1 Export of User Data With Security Attributes

The DSA in each Domain of a multi-Domain Request shall {8.2.3.5.1.-1} enforce its System Access Control Policy when exporting a data Target.

The DSA in each Domain of a multi-Domain Request that must export a data Target during an access Operation, shall {8.2.3.5.1.-2} export the local data Target with the Target's Protection Level security attribute mapped to the Protection Level security attribute of the receiving Domain. Protection Level mappings between Domains are administratively provided between each trusted neighbor Domain during DSA's Initialization State in each Domain.

DSA shall {8.2.3.5.1.-3} ensure that the Protection Level security attribute, when exported outside the local Domain, is unambiguously associated with the exported data Target.

DSA shall {8.2.3.5.1.-4} encrypt the transmission of all data Targets during export from a local Domain.

8.2.3.7 Import from Outside of Local Domain Control

8.2.3.7.1 Import of User Data with Security Attributes

The DSA in each Domain of a multi-Domain Request shall {8.2.3.7.1.-1} enforce its System Access Control Policy when importing a data Target.

The DSA in each Domain of a multi-Domain Request that must import a data Target during an access Operation, shall {8.2.3.7.1.-2} use the security attributes associated with the imported data Target.

DSA shall {8.2.3.7.1.-3} ensure that the protocol used provides for the unambiguous association between the security attributes and the user data Target received.

DSA shall {8.2.3.7.1.-4} ensure that interpretation of the security attributes of the imported user data Target is as intended by the source of the user data.

8.2.3.8 Internal DSA Transfer

8.2.3.8.1 Transmission Separation By Attribute

DSA shall {8.2.3.8.1-1} utilize an Administrator-configurable encryption method to prevent the disclosure of user data when it is transmitted between physically-separated parts of the system in a single Domain.

DSA shall {8.2.3.8.1-2} separate data Targets controlled by the DSA System Access Control Policy when transmitted between physically-separated parts of the system, based on the value of the Protection Level of the data Target.

8.2.3.9 Residual Information Protection

8.2.3.9.1 Full Residual Information Protection

DSA shall {8.2.3.9.1-1} ensure that any previous information content of a resource is made unavailable upon the allocation of the resource to, and deallocation of the resource from all objects.

8.2.3.10 Inter-Security Function User Data Confidentiality Transfer Protection

8.2.3.10.1 Basic Data Exchange Confidentiality

DSA shall {8.2.3.10.1-1} in the enforcement of its DSA System Access Control Policy, be able to transmit and receive objects in a manner protected from unauthorized disclosure.

8.2.4 Security Management

8.2.4.1 Management of Security Functions in DSA

8.2.4.1.1 Management of Security Functions Behavior

DSA shall {8.2.4.1.1-1} restrict the ability to determine the behavior of, and disable (except for the System Controller), the DSA core functional components to the System Administrator Role.

8.2.4.2 Management of Security Attributes

8.2.4.2.1 Management of Security Attributes

DSA shall {8.2.4.2.1-1} restrict the ability to change_default, query, modify, or delete, the Clearance Level and Protection Level security attributes in the system to the System Administrator Role.

8.2.4.2.2 Secure Security Attributes

DSA shall {8.2.4.2.2-1} ensure that only secure values are accepted for security attributes. 8.2.4.2.3 Static Attribute Initialization

DSA shall {8.2.4.2.3-1} provide restrictive default values for the Clearance Level security attribute.

DSA shall {8.2.4.2.3-2} allow the System Administrator to specify alternative initial values to override the default values when an object or information is created.

8.2.4.3 Management of Security Function Data

8.2.4.3.1 Management of Security Function Data

DSA shall {8.2.4.3.1-1} restrict the ability to query, delete, and clear, the system security Audit Log data to the System Administrator Role.

8.2.4.3.2 Secure Security Function Data

DSA shall {8.2.4.3.2-1} ensure that only secure values are accepted for DSA security function data.

8.2.4.4 Revocation

8.2.4.4.1 Revocation

DSA shall {8.2.4.4.1-1} restrict the ability to revoke security attributes associated with its users within a Domain to the System Administrator Role.

DSA shall {8.2.4.4.1-2} enforce System Administrator-initiated revocation of user security attributes immediately following a committed change.

8.2.4.5 Security Attribute Expiration

8.2.4.5.1 Time-Limited Authorization

DSA shall {8.2.4.5.1-1} restrict the capability to specify an expiration time for time-limited access to a data Target, to the System Administrator Role.

For the time-limited security attribute on a data Target, DSA shall {8.2.4.5.1-2} be able to revoke a user's access rights after the expiration time for the indicated security attribute has passed.

8.2.4.6 Specification of Management Functions

8.2.4.6.1 Specification of Management Functions

DSA shall {8.2.4.6.1-1} be capable of performing all of the security management functions to which an Administrator interface was specified in Section 5.3.1.

8.2.4.7 Security Management Roles

8.2.4.7.1 Restrictions on Security Roles

DSA shall {8.2.4.7.1-1} maintain the Role: System Administrator.

DSA shall {8.2.4.7.1-2} be able to associate users with Roles.

DSA shall {8.2.4.7.1-3} ensure that the conditions for lattice-based Role relationships described in 5.3.1 are satisfied.

8.2.4.7.2 Assuming Roles

DSA shall {8.2.4.7.2-1} require an explicit request to assume the System Administrator Role.

8.2.5 Privacy

8.2.5.1 Unobservability

8.2.5.1.1 Authorized User Observability

DSA shall {8.2.5.1.1-1} provide the System Administrator with the capability to observe the data Target Request and data Target access behavior of all users in the Domain.

8.2.6 Protection of System Security Functions

8.2.6.2 Fail Secure

8.2.6.2.1 Failure With Preservation of Secure State

DSA shall {8.2.6.2.1-1} preserve a secure state when the following types of failures occur:
identity or correct operation of a component fails network congestion or interruption
host system failure
   8.2.6.3 Availability of Exported DSA Data
   8.2.6.3.1 Inter-Functional Component Availability Within a Defined Availability Metric

DSA shall {8.2.6.3.1-1} ensure the availability of all DSA inter-Domain data provided to an external trusted Domain, if connectivity is available, and both peer DSA inter-Domain access controllers are operating correctly.

8.2.6.4 Confidentiality of Exported DSA Security Function Data

8.2.6.4.1 Inter-Domain Confidentiality During Transmission

DSA shall {8.2.6.4.1-1} protect all DSA data transmitted from the local DSA Domain to a remote trusted Domain from unauthorized disclosure during transmission.

8.2.6.5 Internal DSA Security Function Data Transfer

8.2.6.5.1 Security Function Data Transfer Separation

DSA shall {8.2.6.5.1-1} protect DSA data from disclosure and modification when it is transmitted between separate parts of the system.

DSA shall {8.2.6.5.1-2} separate user data from DSA data when such data is transmitted between separate parts of the system.

8.2.6.5.2 DSA Data Integrity Monitoring

DSA shall {8.2.6.5.2-1} be able to detect modification of data, substitution of data, re-ordering of data, deletion of data, and encryption errors for DSA data transmitted between separate parts of the system.

Upon detection of a data integrity error, DSA shall {8.2.6.5.2-2} write the error into the security Audit Log and move the system into Administrative mode until integrity is restored.

8.2.6.6 DSA Security Function Physical Protection

8.2.6.6.1 Notification of Physical Attack

DSA shall {8.2.6.6.1-1} provide unambiguous detection of physical tampering that might compromise the DSA Security Function.

DSA shall {8.2.6.6.1-2} provide the capability to determine whether physical tampering with DSA's devices or DSA's elements has occurred.

DSA shall {8.2.6.6.1-3} monitor all of its DSA hosts and functional components and notify the System Administrator when physical tampering with DSA's hosts or components has occurred.

8.2.6.6.2 Resistance to Physical Attack

DSA shall {8.2.6.6.2-1} resist physical tampering scenarios to any DSA host or functional component by responding automatically such that system security is not violated.

8.2.6.7 Trusted Recovery

8.2.6.7.1 Automated Recovery Without Undue Loss

When automated recovery from interface intrusion attempt is not possible, DSA shall {8.2.6.7.1-1} enter the Administrative mode where the ability to return to a secure state is provided.

For interface attack and component identity failures, DSA shall {8.2.6.7.1-2} ensure the return of the system to a secure state using automated procedures.

The functions provided by DSA to recover from failure or service discontinuity shall {8.2.6.7.1-3} ensure that the secure initial state is restored without exceeding the Administrator-configured thresholds for loss of system data or objects within the system.

DSA shall {8.2.6.7.1-4} provide the capability to determine the objects that were or were not capable of being recovered.

8.2.6.7.2 Function Recovery

DSA shall {8.2.6.7.2-1} ensure that the following Security Functions and associated failure scenarios have the property that the Security Function either completes successfully, or for the indicated failure scenarios, recovers to a consistent and secure state:
1. Security Function: component identity checking.
   Failure Scenario: component identity check failure.
2. Security Function: component Request processing.
   Failure Scenario: mismatches between individual component Request handling statistics and overall system audit trail summary.
3. Security Function: component inter-process communications.
   Failure Scenario: reachability of a minimum number of DSA components will send the system into a secure state, and return to full operation if the Domain-defined threshold is not exceeded.
      8.2.6.8 Reference Mediation
      8.2.6.8.1 Non-Bypassibility of the DSA System Security Policy

DSA shall {8.2.6.8.1-1} ensure that security policy enforcement functions are invoked and succeed before each function within the system is allowed to proceed

8.2.6.9 Security Function Domain Separation

8.2.6.9.1 Complete Reference Monitor

The unisolated portion of DSA shall {8.2.6.9.1-1} maintain a security domain for its own execution that protects it from interference and tampering by untrusted subjects.

DSA shall {8.2.6.9.1-2} enforce separation between the security domains of subjects in the system.

DSA shall {8.2.6.9.1-3} maintain the part of the system that enforces the access control functional processing in a security domain for its own execution that protects them from interference and tampering by the remainder of the DSA security functions and by subjects untrusted with respect to the system.

8.2.6.10 Time Stamps

8.2.6.10.1 Reliable Time Stamps

DSA shall {8.2.6.10.1-1} be able to provide reliable time stamps for its own use

8.2.7 Resource Utilization

8.2.7.1 Fault Tolerance

DSA shall {8.2.7.1-1} ensure the operation of all the system's capabilities when the following failures occur:
Loss of inter-component communication for less than an Administrator-defined time limit.
Failure to verify component identity for less than an Administrator-defined maximum number of re-try attempts.
   8.2.7.2 Priority of Service

DSA shall {8.2.7.2-1} assign a priority to each user in the system.

DSA shall {8.2.7.2-2} ensure that each access to data Targets shall be mediated on the basis of the user's assigned priority.

8.2.8 Trusted Path/Channels

8.2.8.1 Inter-Domain Trusted Channel

A DSA Domain shall {8.2.8.1-1} be able to provide a communication channel between itself and an external trusted DSA Domain that is logically distinct from other communication channels and provides assured identification of its end points and protection of the channel data from modification or disclosure.

DSA shall {8.2.8.1-2} permit its own local Domain access controller to initiate communication via the trusted channel that it instantiates.

DSA shall {8.2.8.1-3} initiate communication via the trusted channel for inter-Domain access Request Processing functions or data Target access Operations.

8.2.8.2 Trusted Path

DSA shall {8.2.8.2-1} provide a communication path between itself and local users that is logically distinct from other communication paths and provides assured identification of its end points and protection of the communicated data from modification or disclosure.

DSA shall {8.2.8.2-2} permit local users to initiate communication via the trusted path.

DSA shall {8.2.8.2-3} require the use of the trusted path for initial user authentication, any Request processing operation, and any data Target access Operation.

8.2.9 Security Auditing

8.2.9.1 Security Audit Automatic Response

8.2.9.1.1 Security Alarms

DSA shall {8.2.9.1.1-1} initialize following actions upon detection of a potential security violation:
Shutdown a component, if the component had an identity violation, and generate an alarm.
Restart the component with a new instance of identity information.
After the second violation in sequence, shutdown the entire system in the Domain.
   8.2.9.2 Security Audit Data Generation
   8.2.9.2.1 Audit Data Generation

DSA shall {8.2.9.2.1-1 be able to generate an audit record of the following auditable events:
1. Start-up and shutdown of the audit functions
2. All auditable events for the detailed level of audit
3. Request session login parameters, user data, Credential list, Request or Request-list, user-ID, Request-ID, permission, reason for denial.

DSA shall {8.2.9.2.1-2} record within each audit record at least the following information:
1. Date and time of the event, type of event, user identity, and the outcome (success or failure) of the event.
2. For each audit event type, based on the auditable event definitions of the functional components, the entire operation cycle of the Request process.
3. Audit trail of any single Request with in/out data processed by every DSA component, with success or failure reason.
   8.2.9.2.2 User Identity Association

DSA shall {8.2.9.2.2-1} be able to associate each auditable event with the identity of the user that caused the event.

8.2.9.3 Security Audit Analysis

8.2.9.3.1 Profile-Based Anomaly Detection

DSA shall {8.2.9.3.1-1} be able to maintain profiles of system usage, where an individual profile represents the historical patterns of usage performed by the member(s) of a group or single user. The profile consists of type of Requests, target groups, average number of events per target group. Patterns can be dynamically defined for the domain, for which DSA will provide historical data.

DSA shall {8.2.9.3.1-2} be able to maintain a suspicion rating associated with each user whose activity is recorded in a profile.

The suspicion rating represents the degree to which the user's current activity is found inconsistent with the established patterns of usage represented in the profile.

DSA shall {8.2.9.3.1-3} be able to indicate an imminent violation of security when a user's suspicion rating exceeds the following threshold conditions: repetition of similar Requests, subsequent denial of Requests for specific user, number of Requests per defined interval.

8.2.9.3.2 Complex Attack Heuristics

DSA shall {8.2.9.3.2-1} be able to maintain an internal representation of the following event sequences of known intrusion scenarios: unusual high number of Requests per interval or subsequent denied Requests for a specific user and the following signature events: any access with invalid user Credentials that may indicate a potential violation of system security.

DSA shall {8.2.9.3.2-2} be able to compare the signature events and event sequences against the record of system activity discernible from an examination of user profiles and usage profiles.

DSA shall {8.2.9.3.2-3} be able to indicate an imminent violation of system security when system activity is found to match a signature event or event sequence that indicates a potential violation of system security.

8.2.9.4 Security Audit Review

8.2.9.4.1 Audit Review

DSA shall {8.2.9.4.1-1} provide a Graphical User Interface to the System Administrator with the capability to read Request trails, profiles, and system profile from the audit records.

8.2.9.4.2 Restricted Audit Review

DSA shall {8.2.9.4.2-1} prohibit all users read access to the audit records, except those users that have been granted explicit read-access

8.2.9.4.3 Selectable Audit Review

DSA shall {8.2.9.4.3-1} provide the ability to perform searches, sorting, and ordering of audit data based on user, Request, and time.

8.2.9.5 Security Audit Event Selection

8.2.9.5.1 Selective Audit

DSA shall {8.2.9.5.1-1} be able to include or exclude auditable events from the set of audited events based on the following attributes:
Data Target identity, user identity, host identity, event type, user, Request, and Credentials
   8.2.9.6 Security Audit Event Storage
   8.2.9.6.1 Guarantees of Audit Data Availability

DSA shall {8.2.9.6.1-1} protect the stored audit records from unauthorized deletion.

DSA shall {8.2.9.6.1-2} be able to prevent unauthorized modifications to the audit records in the audit trail.

DSA shall {8.2.9.6.1-3} ensure that reliable storage of audit records will be maintained when the following conditions occur: audit storage exhaustion, failure, attack.

8.2.9.6.2 Prevention of Audit Data Loss

DSA shall (8.2.9.6.2-1} overwrite the oldest stored audit records and switch to an emergency storage area if the audit trail is full.

8.2.11 Cryptographic Support

DSA shall {8.2.11-1} provide Administrator-selectable options for use of the cryptographic support standards listed in Table 12, as required to support each of the DSA system communications activities in the column headings of the table.

8.2.11.1 Cryptographic Key Management

8.2.11.1.1 Cryptographic Key Generation

As needed, DSA shall {8.2.11.1.1-1} generate cryptographic keys in accordance with the standards identified in Table 12.

8.2.11.1.2 Cryptographic Key Distribution

As needed, DSA shall {8.2.11.1.2-1} distribute cryptographic keys in accordance with the standards identified in Table 12.

8.2.11.1.3 Cryptographic Key Access

As needed, DSA shall {8.2.11.1.3-1} perform cryptographic key access in accordance with the standards identified in Table 12.

8.2.11.1.4 Cryptographic Key Destruction

As needed, DSA shall {8.2.11.1.4-1} perform cryptographic key destruction in accordance with the standards identified in Table 12.

8.2.11.1.5 Cryptographic Operation

As needed, DSA shall {8.2.11.1.5-1} perform cryptographic operations in accordance with the standards identified in Table 12.

TABLE 12
List of DSA-selectable System Cryptographic methods

| | Certificate | | | |
|---|---|---|---|---|
| | Client | | | DSA |
| | Authenti- | client- | DSA Internal | Inter- |
| Encryption-Type | cation | DSA | Components | Domain |
| des_cbc_crc | yes | yes | yes | yes |
| des_cbc_md4 | yes | yes | yes | yes |
| des_cbc_md5 | yes | yes | yes | yes |
| arcfour_hmac_md5 | yes | yes | yes | yes |
| des3_cbc_md5 | yes | yes | yes | yes |
| des3_cbc_sha1 | yes | yes | yes | yes |
| old_des3_cbc_sha1 | yes | yes | yes | yes |
| aes128_cts_hmac_sha1 | yes | yes | yes | yes |
| aes256_cts_hmac_sha1 | yes | yes | yes | yes |
| des_cbc_none | yes | yes | yes | yes |
| des_cfb64_none | yes | yes | yes | yes |
| des_pcbc_none | yes | yes | yes | yes |
| des3_cbc_none | yes | yes | yes | yes |
| Private Certificate | yes | yes | no | yes |
| 3^{rd} Party Certificate | yes | yes | no | yes |

Explanatory information regarding each of the cryptographic algorithms in Table 12 may be found in Section 9.

8.3 External Interface Requirements

DSA external interface requirements have been stated and specified in sufficient detail in Section 5.2.

The following requirement exists pertaining to Section 5.2.2.2:

DSA shall {8.3-1} provide an external interface to the following via a Client Application Integration Interface for network-aware applications, as described in 3.2.1.2.1 (Client Access Layer):

1. Microsoft Windows Desktop Suite

a. Windows Explorer
b. Microsoft Word
c. Microsoft Excel
d. Microsoft PowerPoint
   8.4 Internal Interface Requirements

All applicable internal interface requirements have been specified in Section 8.2. No additional requirements apply.

8.5 Internal Data Requirements

All applicable internal data requirements have been specified in Sections 5.3.1 and 8.2. No additional requirements apply.

8.6 Adaptation Requirements

Section 5.6.1 specifies the adaptation requirement for the system.

8.8 Security and Privacy Requirements

Because the core functionality of the DSA system pertains to security, all security requirements have been specified as Capability requirements in Section 8.2. No further requirements apply.

8.9 CSCI Environment Requirements

CSCI environment requirements have been fully specified in Sections 5.1.3 and 5.7.1.

9—References for Cryptographic Standards

The list below provides URL links to supporting information that describe the cryptographic standards listed in Table 12:

Serpent: http://www.cl.cam.ac.uk/˜rja14/serpent.html; AES: http://www.nist.gov/aes; Twofish: http://www.counterpane.com/twofish.html; DES: http://www.itl.nist.gov/fibspubs/; Secure Hash: http://csrc.nist.gov/encryption/shs/dfips-180-2.pdf; RC6: http://www.rsasecurity.com/rsalabs/rc6/; and SSL-Protocol: http://home.netscape.com/eng/ss13/.

Any two or more structural parts of the systems described herein can be integrated. Any structural part of the systems described herein can be provided in two or more parts. Similarly, any two or more functions can be conducted simultaneously, and/or any function can be conducted in a series of steps.

1. A method of processing a request from a requester, comprising:
receiving from a requestor a first request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
determining whether a local domain contains all of said at least one element in said target, said local domain comprising at least one processor;
if said local domain contains all of said at least one element in said target:
(1) if said local domain contains a rule for each element in said target indicating that said requestor is authorized to perform said desired operation on said element:
(a) enabling a first agent to access said at least one element to perform said desired operation, and
(b) transmitting to said requester a first agent location set of indicia, said first agent location set of indicia enabling said requestor to access said first agent;
(2) if said local domain does not contain a rule for each element in said target indicating that said requestor is authorized to perform said desired operation on said target:
(a) denying said request;
if said local domain contains at least one element in said target but does not contain all of said at least one element in said target:
(1) if said local domain contains a rule for each said element contained in said local domain indicating that said requestor is authorized to perform said desired operation on said at least one element in said target:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain; and
(2) if said local domain does not contain a rule for each element contained in said local domain indicating that said requestor is authorized to perform said desired operation on said target:
(a) denying said request.

2. A method as recited in claim 1, further comprising receiving at least one requestor set of indicia, said requestor set of indicia comprising indicia selected from the group consisting of indicia input by the requester and indicia derived from the requestor; and
comparing said requestor set of indicia with at least one set of stored requester indicia.

3. A method as recited in claim 1, further comprising receiving at least one identification set of indicia, said identification set of indicia comprising indicia selected from the group consisting of indicia input by the requestor and indicia derived from the requestor; and
comparing said identification set of indicia with at least one set of stored identification indicia.

4. A method as recited in claim 1, further comprising receiving at least one authentication set of indicia, said authentication set of indicia comprising indicia selected from the group consisting of indicia input by the requestor and indicia derived from the requestor; and
comparing said authentication set of indicia with at least one set of stored authentication indicia.

5. A method as recited in claim 1, wherein said second request further comprises a credential set of indicia.

6. A method as recited in claim 1, wherein said second request further comprises a request identification set of indicia comprising a set of indicia which is representative of said request.

7. A method as recited in claim 1, further comprising determining whether said local domain contains a rule for each element in said target indicating that said requestor is authorized to perform said desired operation on said element by performing at least one step selected from among the group of steps consisting of:
(1) comparing a stored clearance level for said requestor with a stored protection level for said element;
(2) determining whether a stored NTK for said requestor includes performing said desired operation on said element;
(3) determining whether a stored NTK for said element includes performance of said operation by said requestor;
(4) receiving from said requestor at least one credential set of indicia, said credential set of indicia comprising indicia selected from the group consisting of indicia input by the requestor and indicia derived from the requester, and comparing said credential set of indicia with at least one set of stored credential indicia;
(5) determining whether a time of submission of said request falls within a stored time period in which submission of a request for said desired operation on said element is acceptable; and
(6) determining whether a time at which performance of said operation is requested falls within a stored period of time which is acceptable for said desired operation on said element.

8. A method as recited in claim 1, wherein said desired operation is selected from among the group consisting of a read operation, a write operation, a subscribe operation and a publish operation.

9. A method as recited in claim 1, wherein if said local domain contains a rule for each element in said target indicating that said requestor is authorized to perform said desired operation on said element, said domain issues a token for said requestor, and said method further comprises receiving said token.

10. A method as recited in claim 1, further comprising creating said first agent prior to said enabling said first agent.

11. A method as recited in claim 1, wherein said method comprises making a single access control decision within said local domain, either granting or denying said request.

12. A method as recited in claim 1, wherein no application which is not an agent can access protected data within said local domain.

13. A method as recited in claim 1, wherein no application which is not an agent can perform any operation on protected data within said local domain.

14. A method as recited in claim 1, wherein each application within said local domain can access location information regarding only other applications within said local domain, and only through a secure name server within said local domain.

15. A method as recited in claim 1, wherein the only communication between any application in said local domain and any application in said second domains travels between an access request handling application within said first domain and an access request handling application within said second domain.

16. A method as recited in claim 1, wherein said request must be completely granted before said requestor is given access to any of said elements within said target.

17. A method as recited in claim 1, wherein no location information of any element is passed from said local domain to said second domain or from said second domain to said local domain.

18. A method of processing a request from a requestor, comprising:
receiving from a requestor a first request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
determining whether a local domain contains all of said at least one element in said target, said local domain comprising at least one processor;
if said local domain contains all of said at least one element in said target:
(a) enabling a first agent to access said at least one element to perform said desired operation, and
(b) transmitting to said requestor a first agent location set of indicia, said first agent location set of indicia enabling said requestor to access said first agent; and
if said local domain does not contain all of said at least one element in said target:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain.

19-34. (canceled)

35. A method of processing a request from a requester, comprising:
receiving from a requestor a first request comprising at least one desired operation set of indicia and a requested target identification set of indicia, said desired operation set of indicia comprising a set of indicia which is representative of at least one desired operation, said requested target identification set of indicia comprising a set of indicia which is representative of a requested target, said requested target comprising at least one element, said element comprising an information set of indicia, said information set of indicia being representative of information;
determining whether a local domain contains all of said at least one element in said requested target, said local domain comprising at least one processor;
if said local domain contains all of said at least one element in said requested target:
(1) if said local domain contains a rule for each element in said target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;
(2) if said local domain does not contain a rule for each element in said target indicating that said requestor is authorized to perform said desired operation on said at least one element:
(a) denying said request;
if said local domain contains at least one element in said target but does not contain all of said at least one element in said target:
(1) if said local domain does not contain a rule for each element in said local domain indicating that said requestor is authorized to perform said desired operation on said at least one element contained in said local domain:
(a) denying said request;
(2) if said local domain contains a rule for each said element contained in said local domain indicating that said requestor is authorized to perform said desired operation on said element contained in said local domain:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain; and
(b) transmitting said second request to a second domain;
(c) determining whether said second domain contains all of said at least one element in said secondary target, said second domain comprising at least one processor;
(d) if said second domain contains all of said at least one element in said secondary target:
(1) if said second domain contains a rule for each said element in said secondary target indicating that said requestor is authorized to perform said desired operation on each said element in said secondary target:
(a) enabling said second domain agent to access all elements which are both (i) contained in said requested target and (ii) contained in said second domain;
(b) transmitting to said local domain a second domain agent location set of indicia, said second domain agent location set of indicia enabling a local domain agent to access said second domain agent;
(c) enabling said local domain agent to:
(i) access any elements which are both contained in said requested target and contained in said local domain; and
(ii) access, via said second domain agent, all elements which are both contained in said requested target and contained in said second domain; and
(d) transmitting to said requestor a local domain agent location set of indicia, said local domain agent location set of indicia enabling said requestor to access said local domain agent;
(2) if said local domain does not contain a rule for each element contained in said local domain indicating that said requestor is authorized to perform said desired operation on said target:
(a) denying said request;
if said local domain contains none of said at least one element in said target:
(1) creating a second request, said second request comprising (a) said at least one desired operation set of indicia and (b) a secondary target identification set of indicia comprising a set of indicia which is representative of all elements which are contained in said target; and
(2) transmitting said second request to a second domain;
(3) determining whether said second domain contains all of said at least one element in said secondary target, said second domain comprising at least one processor;
(4) if said second domain contains all of said at least one element in said secondary target:
(a) if said second domain contains a rule for each said element in said secondary target indicating that said requester is authorized to perform said desired operation on each said element in said secondary target:
(1) enabling said second domain agent to access all elements which are contained in said requested target;
(2) transmitting to said local domain a second domain agent location set of indicia, said second domain agent location set of indicia enabling a local domain agent to access said second domain agent;
(3) enabling said local domain agent to access, via said second domain agent, all elements which are contained in said second domain; and
(4) transmitting to said requestor a local domain agent location set of indicia, said local domain agent location set of indicia enabling said requestor to access said local domain agent;
(b) if said local domain does not contain a rule for each element contained in said local domain indicating that said requestor is authorized to perform said desired operation on said target:
(1) denying said request.

36-58. (canceled)

59. A method of processing a request from a requester, comprising:
receiving from a requestor a first request comprising at least one desired operation set of indicia and a requested target identification set of indicia, said desired operation set of indicia comprising a set of indicia which is representative of at least one desired operation, said requested target identification set of indicia comprising a set of indicia which is representative of a requested target, said requested target comprising at least one element, said element comprising an information set of indicia, said information set of indicia being representative of information;
determining whether a local domain contains all of said at least one element in said requested target, said local domain comprising at least one processor;
if said local domain contains all of said at least one element in said requested target and said local domain contains a rule for each element in said requested target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;
if said local domain contains all of said at least one element in said requested target and said local domain does not contain a rule for each element in said requested target indicating that said requestor is authorized to perform said desired operation on said element:
(a) denying said request;
if said local domain does not contain all of said at least one element in said requested target:
(a) if said local domain contains at least one of said at least one element in said requested target and said local domain does not contain a rule for each element in said requested target indicating that said requestor is authorized to perform said desired operation on said element, denying said request; otherwise:
(b) creating a current request, said current request comprising (1) said at least one desired operation set of indicia, and (2) a current target identification set of indicia comprising a set of indicia which is representative of a current target set, said current target set comprising all elements which are both (i) contained in said requested target and (ii) not contained in said local domain; and
(c) transmitting said current request to a next domain, said next domain comprising at least one processor;
if said request has not been denied, repeating a sub-routine comprising:
(1) determining whether said next domain contains all elements in said current target set;
(2) if said next domain contains all of said elements in said current target set and said next domain does not contain a rule for each element in said current target set indicating that said requestor is authorized to perform said desired operation on said element, denying said request;
(3) if said next domain contains all of said elements in said current target set and said next domain contains a rule for each element in said current target set indicating that said requester is authorized to perform said desired operation on said element:
(a) enabling a first non-local agent to access said elements in said current target set,
(b) transmitting to a next prior domain a first non-local agent location set of indicia, said first non-local agent location set of indicia enabling a next prior domain agent to access said first non-local agent;
(c) unless said next non-local agent location set of indicia has reached said local domain, repeating a step of:
(i) enabling said next prior domain agent to access any elements which are both contained in said requested target and contained in said next prior domain; and
(ii) transmitting to said next prior domain a next non-local agent location set of indicia, said next non-local agent location set of indicia enabling said next prior domain agent to access said next non-local agent;
until said next non-local agent location set of indicia reaches said local domain; and
(d) enabling said local domain agent to access any elements which are both contained in said requested target and contained in said local domain; and transmitting to said requestor a local domain agent location set of indicia, said local domain agent location set of indicia enabling said requestor to access said local domain agent;
(4) if said next domain contains at least one of said elements in said current target set and said next domain does not contain a rule for each element in said next domain and in said current target set indicating that said requestor is authorized to perform said desired operation on said element in said next domain and in said current target set, denying said request; otherwise:
(5) if said next domain does not contain all of said elements in said current target set:
(a) creating a next request, said next request comprising (1) said at least one desired operation set of indicia, and (2) a new current target identification set of indicia comprising a set of indicia which is representative of a new current target set, said new current target set comprising all elements which were (i) contained in said requested target, (ii) not contained in said local domain, and (iii) not contained in any domain to which a current request has been transmitted; and
(b) transmitting said next request to a next domain,
until (1) a non-local agent location set of indicia is transmitted to said local domain agent, or (2) said repeating of said sub-routine is terminated.

60. A method as recited in claim 59, further comprising:
determining whether policy rules in said local domain currently contain at least one rule which grants permission to said requester to perform said desired operation on any of said elements in said target and contained in said local domain; and
for each next domain, determining whether policy rules in said next domain currently contain at least one rule which grants permission to said requestor to perform said desired operation on any of said elements in said target and contained in said next domain.

61. A method as recited in claim 59, further comprising determining whether said local domain contains a rule for each element in said target which is contained in said local domain indicating that said requestor is authorized to perform said desired operation on said element in said target which is contained in said local domain by performing at least one step selected from among the group of steps consisting of:
(1) comparing a stored clearance level for said requestor with a stored protection level for said element in said target which is contained in said local domain;
(2) determining whether a stored NTK for said requestor includes performing said operation on said element in said target which is contained in said local domain;
(3) determining whether a stored NTK for said element in said target which is contained in said local domain includes performance of said desired operation by said requestor;
(4) receiving at least one credential set of indicia, said credential set of indicia comprising indicia selected from the group consisting of indicia input by the requestor and indicia derived from the requestor, and comparing said credential set of indicia with at least one set of stored credential indicia;
(5) determining whether a time of submission of said request falls within a stored time period in which submission of a request for said desired operation on said element in said target which is contained in said local domain is acceptable;
(6) determining whether a time at which performance of said operation is requested falls within a stored period of time which is acceptable for said desired operation on said element in said target which is contained in said local domain; and
for each said next domain, determining whether said next domain contains a rule for each element in said target which is contained in said next domain indicating that said requestor is authorized to perform said desired operation on said element in said target which is contained in said next domain by performing at least one step selected from among the group of steps consisting of:
(1) comparing a stored clearance level for said requestor with a stored protection level for said element in said target which is contained in said next domain;
(2) determining whether a stored NTK for said requestor includes performing said desired operation on said element in said target which is contained in said next domain;
(3) determining whether a stored NTK for said element in said target which is contained in said next domain includes performance of said desired operation by said requestor;
(4) receiving at least one credential set of indicia, said credential set of indicia comprising indicia selected from the group consisting of indicia input by the requestor and indicia derived from the requestor, and comparing said credential set of indicia with at least one set of stored credential indicia;
(5) determining whether a time of submission of said request falls within a stored time period in which submission of a request for said desired operation on said element in said target which is contained in said next domain is acceptable; and
(6) determining whether a time at which performance of said operation is requested falls within a stored period of time which is acceptable for said desired operation on said element in said target which is contained in said next domain.

62. A method as recited in claim 59, wherein said method comprises making a single access control decision across said local and next domains, either granting or denying said request.

63. A method as recited in claim 62, wherein said local domain has its own security policies pertaining to elements contained within said local domain, and each said next domain has its own security policies pertaining to elements contained within said second domain.

64. A method as recited in claim 63, wherein policy decisions regarding elements in said local domain are made within said local domain, and policy decisions regarding elements in each said next domain are made within said next domain.

65. A method as recited in claim 59, wherein no application which is not an agent can access protected data within any of said domains.

66. A method as recited in claim 59, wherein no application which is not an agent can perform any operation on protected data within any of said domains.

67. A method as recited in claim 59, wherein each application within said local domain can access location information regarding only other applications within said local domain, and only through a secure name server within said local domain, and each application within any said next domain can access location information regarding only other applications within said next domain, and only through a secure name server within said next domain.

68. A method as recited in claim 59, wherein the only communication between any application in one of said domains and any application in any other one of said domains travels between an access request handling application within said one domain and an access request handling application within said other domain.

69. A method as recited in claim 59, wherein said request must be completely granted before said requestor is given access to any of said elements within said target.

70. A method as recited in claim 59, wherein no location information of any element is passed from any one of said domains to any other of said domains.

71. A method as recited in claim 59, wherein said sub-routine is terminated when said local domain receives a current request.

72. A method as recited in claim 59, wherein said desired operation is a pull operation, and wherein a plurality of current requests are transmitted in sequence to a plurality of domains, and wherein said method further comprises for each element contained in a domain other than said local domain, transmitting an element representation, from a non-local agent in a domain in which said element is contained, to an agent in a domain which is a next prior domain in said sequence, each said element representation comprising indicia representative of said element, until all of said element representations reach said local domain, and then transmitting from said local agent to said requestor all of said element representations and indicia representative of any elements contained in said local domain.

73. A method as recited in claim 59, wherein said desired operation is a push operation, and wherein a plurality of current requests are transmitted in sequence to a plurality of domains, and wherein said method further comprises transferring element representations corresponding to each said element from said requestor to an agent in said local domain, performing said push operation on any elements in said local domain, transferring element representations for each said element other than any said element in said local domain through a sequence of at least one non-local agent, each said non-local agent being contained in a non-local domain, each said element representation being passed through at least a portion of said sequence of at least one non-local agent until it reaches a non-local agent in a non-local domain in which said corresponding element is contained and said push operation is performed on said element.

74-88. (canceled)

89. A method of processing a request from a requester, comprising:
receiving from a requestor a request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
determining whether a local domain contains all of said at least one element in said target, said local domain comprising at least one processor;
if said local domain contains all of said at least one element in said target:
(1) if said local domain contains a rule for each element in said target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;
(2) if said local domain does not contain a rule for each element in said target indicating that said requestor is authorized to perform said desired operation on said target:
(a) denying said request; and
if said local domain does not contain all of said at least one element in said target:
(a) denying said request.

90-96. (canceled)

97. A method of transmitting at least one set of indicia representative of information from a first domain to a second domain comprising:
transmitting at least one set of indicia representative of information from a first virtual address in a first domain to a second virtual address in said first domain, said first domain comprising at least a first processor, and then
transmitting said set of indicia representative of information from said second virtual address in said first domain to a second domain via a first physical address in said first domain, said second domain comprising at least a second processor.

98. A method as recited in claim 97, further comprising terminating said first virtual address and said second virtual address after said transmitting.

99. A method as recited in claim 97, wherein said second domain receives said set of indicia representative of information at a first virtual address in said second domain via a first physical address in said second domain.

100. A method as recited in claim 97, wherein said second domain receives said set of indicia representative of information at a first virtual address in said second domain via a first physical address in said second domain and passes said set of indicia representative of information from said first virtual address in said second domain to a second virtual address in said second domain.

101. A method comprising determining whether a requestor is authorized to perform a desired operation on a target comprising at least one element, said element comprising an information set of indicia, by:
(1) comparing a stored clearance level for said requestor with a stored protection level for said element;
(2) performing at least one step selected from among (a) determining whether a stored NTK for said requestor includes performing said desired operation on said at least one element and (b) determining whether a stored NTK for said element includes performance of said desired operation by said requester; and
(3) receiving from said requestor at least one credential set of indicia, said credential set of indicia comprising indicia selected from the group consisting of indicia input by the requestor and indicia derived from the requestor, and comparing said credential set of indicia with at least one set of stored credential indicia for said requestor.

102-105. (canceled)

106. A method of processing a request from a requestor, comprising:
receiving from a requestor a request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
enabling an agent in a first domain to access said at least one element in said first domain to perform said desired operation, and
transmitting to said requestor a first domain agent location set of indicia, said first domain agent location set of indicia representing a location of said first domain agent;
wherein no application which is not an agent can access protected data within said first domain.

107-116. (canceled)

117. An apparatus for processing a request from a requester, comprising:
means for receiving from a requestor a first request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
means for determining whether a local domain contains all of said at least one element in said target, said local domain comprising at least one processor;
means for carrying out the following:
if said local domain contains all of said at least one element in said target:
(1) if said local domain contains a rule for each element in said target indicating that said requestor is authorized to perform said desired operation on said element:
(a) enabling a first agent to access said at least one element to perform said desired operation, and
(b) transmitting to said requestor a first agent location set of indicia, said first agent location set of indicia enabling said requestor to access said first agent;
(2) if said local domain does not contain a rule for each element in said target indicating that said requestor is authorized to perform said desired operation on said target:
(a) denying said request;
if said local domain contains at least one element in said target but does not contain all of said at least one element in said target:
(1) if said local domain contains a rule for each said element contained in said local domain indicating that said requestor is authorized to perform said desired operation on said at least one element in said target:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain; and
(2) if said local domain does not contain a rule for each element contained in said local domain indicating that said requestor is authorized to perform said desired operation on said target:
(a) denying said request.

118-127. (canceled)

128. An apparatus for processing a request from a requestor, comprising:
means for receiving from a requestor a first request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
means for determining whether a local domain contains all of said at least one element in said target, said local domain comprising at least one processor;
means for carrying out the following:
if said local domain contains all of said at least one element in said target:
(a) enabling a first agent to access said at least one element to perform said desired operation, and
(b) transmitting to said requestor a first agent location set of indicia, said first agent location set of indicia enabling said requestor to access said first agent; and
if said local domain does not contain all of said at least one element in said target:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain.

129-138. (canceled)

139. An apparatus for processing a request from a requestor, comprising:
means for receiving from a requestor a first request comprising at least one desired operation set of indicia and a requested target identification set of indicia, said desired operation set of indicia comprising a set of indicia which is representative of at least one desired operation, said requested target identification set of indicia comprising a set of indicia which is representative of a requested target, said requested target comprising at least one element, said element comprising an information set of indicia, said information set of indicia being representative of information;
means for determining whether a local domain contains all of said at least one element in said requested target, said local domain comprising at least one processor;
means for carrying out the following:
if said local domain contains all of said at least one element in said requested target:
(1) if said local domain contains a rule for each element in said target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;
(2) if said local domain does not contain a rule for each element in said target indicating that said requestor is authorized to perform said desired operation on said at least one element:
(a) denying said request;
if said local domain contains at least one element in said target but does not contain all of said at least one element in said target:
(1) if said local domain does not contain a rule for each element in said local domain indicating that said requestor is authorized to perform said desired operation on said at least one element contained in said local domain:
(a) denying said request;
(2) if said local domain contains a rule for each said element contained in said local domain indicating that said requestor is authorized to perform said desired operation on said element contained in said local domain:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain; and
(b) transmitting said second request to a second domain;
(c) determining whether said second domain contains all of said at least one element in said secondary target, said second domain comprising at least one processor;
(d) if said second domain contains all of said at least one element in said secondary target:
(1) if said second domain contains a rule for each said element in said secondary target indicating that said requestor is authorized to perform said desired operation on each said element in said secondary target:
(a) enabling said second domain agent to access all elements which are both (i) contained in said requested target and (ii) contained in said second domain;
10 (b) transmitting to said local domain a second domain agent location set of indicia, said second domain agent location set of indicia enabling a local domain agent to access said second domain agent;
(c) enabling said local domain agent to:
(i) access any elements which are both contained in said requested target and contained in said local domain; and
(ii) access, via said second domain agent, all elements which are both contained in said requested target and contained in said second domain; and
(d) transmitting to said requestor a local domain agent location set of indicia, said local domain agent location set of indicia enabling said requestor to access said local domain agent;
(2) if said local domain does not contain a rule for each element contained in said local domain indicating that said requestor is authorized to perform said desired operation on said target:
(a) denying said request;
if said local domain contains none of said at least one element in said target:
(1) creating a second request, said second request comprising (a) said at least one desired operation set of indicia and (b) a secondary target identification set of indicia comprising a set of indicia which is representative of all elements which are contained in said target; and
(2) transmitting said second request to a second domain;
(3) determining whether said second domain contains all of said at least one element in said secondary target, said second domain comprising at least one processor;
(4) if said second domain contains all of said at least one element in said secondary target:
(a) if said second domain contains a rule for each said element in said secondary target indicating that said requestor is authorized to perform said desired operation on each said element in said secondary target:
(1) enabling said second domain agent to access all elements which are contained in said requested target;
(2) transmitting to said local domain a second domain agent location set of indicia, said second domain agent location set of indicia enabling a local domain agent to access said second domain agent;
(3) enabling said local domain agent to access, via said second domain agent, all elements which are contained in said second domain; and
(4) transmitting to said requestor a local domain agent location set of indicia, said local domain agent location set of indicia enabling said requestor to access said local domain agent;
(b) if said local domain does not contain a rule for each element contained in said local domain indicating that said requestor is authorized to perform said desired operation on said target:
(1) denying said request.

140-157. (canceled)

158. An apparatus for processing a request from a requestor, comprising:
means for receiving from a requestor a first request comprising at least one desired operation set of indicia and a requested target identification set of indicia, said desired operation set of indicia comprising a set of indicia which is representative of at least one desired operation, said requested target identification set of indicia comprising a set of indicia which is representative of a requested target, said requested target comprising at least one element, said element comprising an information set of indicia, said information set of indicia being representative of information;
means for determining whether a local domain contains all of said at least one element in said requested target, said local domain comprising at least one processor;
means for carrying out the following:
if said local domain contains all of said at least one element in said requested target and said local domain contains a rule for each element in said requested target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;
if said local domain contains all of said at least one element in said requested target and said local domain does not contain a rule for each element in said requested target indicating that said requestor is authorized to perform said desired operation on said element:
(a) denying said request;
if said local domain does not contain all of said at least one element in said requested target:
(a) if said local domain contains at least one of said at least one element in said requested target and said local domain does not contain a rule for each element in said requested target indicating that said requestor is authorized to perform said desired operation on said element, denying said request; otherwise:
(b) creating a current request, said current request comprising (1) said at least one desired operation set of indicia, and (2) a current target identification set of indicia comprising a set of indicia which is representative of a current target set, said current target set comprising all elements which are both (i) contained in said requested target and (ii) not contained in said local domain; and
(c) transmitting said current request to a next domain, said next domain comprising at least one processor;
if said request has not been denied, repeating a sub-routine comprising:
(1) determining whether said next domain contains all elements in said current target set;
(2) if said next domain contains all of said elements in said current target set and said next domain does not contain a rule for each element in said current target set indicating that said requestor is authorized to perform said desired operation on said element, denying said request;
(3) if said next domain contains all of said elements in said current target set and said next domain contains a rule for each element in said current target set indicating that said requestor is authorized to perform said desired operation on said element:
(a) enabling a first non-local agent to access said elements in said current target set,
(b) transmitting to a next prior domain a first non-local agent location set of indicia, said first non-local agent location set of indicia enabling a next prior domain agent to access said first non-local agent;
(c) unless said next non-local agent location set of indicia has reached said local domain, repeating a step of:
(i) enabling said next prior domain agent to access any elements which are both contained in said requested target and contained in said next prior domain; and
(ii) transmitting to said next prior domain a next non-local agent location set of indicia, said next non-local agent location set of indicia enabling said next prior domain agent to access said next non-local agent;
until said next non-local agent location set of indicia reaches said local domain; and
(d) enabling said local domain agent to access any elements which are both contained in said requested target and contained in said local domain; and transmitting to said requestor a local domain agent location set of indicia, said local domain agent location set of indicia enabling said requestor to access said local domain agent;
(4) if said next domain contains at least one of said elements in said current target set and said next domain does not contain a rule for each element in said next domain and in said current target set indicating that said requestor is authorized to perform said desired operation on said element in said next domain and in said current target set, denying said request; otherwise:
(5) if said next domain does not contain all of said elements in said current target set:
(a) creating a next request, said next request comprising (1) said at least one desired operation set of indicia, and (2) a new current target identification set of indicia comprising a set of indicia which is representative of a new current target set, said new current target set comprising all elements which were (i) contained in said requested target, (ii) not contained in said local domain, and (iii) not contained in any domain to which a current request has been transmitted; and
(b) transmitting said next request to a next domain,
until (1) a non-local agent location set of indicia is transmitted to said local domain agent, or (2) said repeating of said sub-routine is terminated.

159-183. (canceled)

184. An apparatus for processing a request from a requester, comprising:
means for receiving from a requestor a request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
means for determining whether a local domain contains all of said at least one element in said target, said local domain comprising at least one processor;
means for carrying out the following:
if said local domain contains all of said at least one element in said target:
(1) if said local domain contains a rule for each element in said target indicating that said requestor is authorized to perform said desired operation on said element:
(a) enabling a local domain agent to access said at least one element to perform said desired operation, and
(b) transmitting to said requestor a local domain agent location set of indicia, said local domain agent location set of indicia enabling said requestor to access said local domain agent;
(2) if said local domain does not contain a rule for each element in said target indicating that said requestor is authorized to perform said desired operation on said target:
(a) denying said request; and
if said local domain does not contain all of said at least one element in said target:
(a) denying said request.

185-190. (canceled)

191. An apparatus for transmitting at least one set of indicia representative of information from a first domain to a second domain comprising:
means for transmitting at least one set of indicia representative of information from a first virtual address in a first domain to a second virtual address in said first domain, said first domain comprising at least a first processor, and then transmitting said set of indicia representative of information from said second virtual address in said first domain to a second domain via a first physical address in said first domain, said second domain comprising at least a second processor.

192-194. (canceled)

195. An apparatus for determining whether a requestor is authorized to perform a desired operation on a target comprising at least one element, said element comprising an information set of indicia, comprising:
(1) means for comparing a stored clearance level for said requestor with a stored protection level for said element;
(2) means for performing at least one step selected from among (a) determining whether a stored NTK for said requestor includes performing said desired operation on said at least one element and (b) determining whether a stored NTK for said element includes performance of said desired operation by said requester; and
(3) means for receiving from said requestor at least one credential set of indicia, said credential set of indicia comprising indicia selected from the group consisting of indicia input by the requestor and indicia derived from the requestor, and comparing said credential set of indicia with at least one set of stored credential indicia for said requestor.

196-198. (canceled)

199. An apparatus for processing a request from a requestor, comprising:
means for receiving from a requester a request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
means for enabling an agent in a first domain to access said at least one element in said first domain to perform said desired operation, and
means for transmitting to said requestor a first domain agent location set of indicia, said first domain agent location set of indicia representing a location of said first domain agent;
wherein no application which is not an agent can access protected data within said first domain.

200-208. (canceled)

209. A computer-readable medium having computer-executable commands for performing the following:
receiving from a requestor a first request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
determining whether a local domain contains all of said at least one element in said target, said local domain comprising at least one processor;
if said local domain contains all of said at least one element in said target:
(1) if said local domain contains a rule for each element in said target indicating that said requester is authorized to perform said desired operation on said element:
(a) enabling a first agent to access said at least one element to perform said desired operation, and
(b) transmitting to said requester a first agent location set of indicia, said first agent location set of indicia enabling said requestor to access said first agent;
(2) if said local domain does not contain a rule for each element in said target indicating that said requestor is authorized to perform said desired operation on said target:
(a) denying said request;
if said local domain contains at least one element in said target but does not contain all of said at least one element in said target:
(1) if said local domain contains a rule for each said element contained in said local domain indicating that said requester is authorized to perform said desired operation on said at least one element in said target:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain; and
(2) if said local domain does not contain a rule for each element contained in said local domain indicating that said requestor is authorized to perform said desired operation on said target:
(a) denying said request.

210. (canceled)

211. A computer-readable medium having computer-executable commands for performing the following:
receiving from a requestor a first request comprising at least one desired operation set of indicia and a requested target identification set of indicia, said desired operation set of indicia comprising a set of indicia which is representative of at least one desired operation, said requested target identification set of indicia comprising a set of indicia which is representative of a requested target, said requested target comprising at least one element, said element comprising an information set of indicia, said information set of indicia being representative of information;
determining whether a local domain contains all of said at least one element in said requested target, said local domain comprising at least one processor;
if said local domain contains all of said at least one element in said requested target:
(1) if said local domain contains a rule for each element in said target indicating that said requestor is authorized to perform said desired operation on said element:
(a) enabling a local domain agent to access said at least one element to perform said desired operation, and
(b) transmitting to said requester a local domain agent location set of indicia, said local domain agent location set of indicia enabling said requestor to access said local domain agent;
(2) if said local domain does not contain a rule for each element in said target indicating that said requestor is authorized to perform said desired operation on said at least one element:
(a) denying said request;
if said local domain contains at least one element in said target but does not contain all of said at least one element in said target:
(1) if said local domain does not contain a rule for each element in said local domain indicating that said requester is authorized to perform said desired operation on said at least one element contained in said local domain:
(a) denying said request;
(2) if said local domain contains a rule for each said element contained in said local domain indicating that said requestor is authorized to perform said desired operation on said element contained in said local domain:
(a) creating a second request, said second request comprising (1) said at least one desired operation set of indicia and (2) a secondary target identification set of indicia comprising a set of indicia which is representative of all elements which are both (i) contained in said target and (ii) not contained in said local domain; and
(b) transmitting said second request to a second domain;
(c) determining whether said second domain contains all of said at least one element in said secondary target, said second domain comprising at least one processor;
(d) if said second domain contains all of said at least one element in said secondary target:
(1) if said second domain contains a rule for each said element in said secondary target indicating that said requestor is authorized to perform said desired operation on each said element in said secondary target:
(a) enabling said second domain agent to access all elements which are both (i) contained in said requested target and (ii) contained in said second domain;
(b) transmitting to said local domain a second domain agent location set of indicia, said second domain agent location set of indicia enabling a local domain agent to access said second domain agent;
(c) enabling said local domain agent to:
(i) access any elements which are both contained in said requested target and contained in said local domain; and
(ii) access, via said second domain agent, all elements which are both contained in said requested target and contained in said second domain; and
(d) transmitting to said requestor a local domain agent location set of indicia, said local domain agent location set of indicia enabling said requestor to access said local domain agent;
(2) if said local domain does not contain a rule for each element contained in said local domain indicating that said requestor is authorized to perform said desired operation on said target:
(a) denying said request;
if said local domain contains none of said at least one element in said target:
(1) creating a second request, said second request comprising (a) said at least one desired operation set of indicia and (b) a secondary target identification set of indicia comprising a set of indicia which is representative of all elements which are contained in said target; and
(2) transmitting said second request to a second domain;
(3) determining whether said second domain contains all of said at least one element in said secondary target, said second domain comprising at least one processor;
(4) if said second domain contains all of said at least one element in said secondary target:
(a) if said second domain contains a rule for each said element in said secondary target indicating that said requestor is authorized to perform said desired operation on each said element in said secondary target:
(1) enabling said second domain agent to access all elements which are contained in said requested target;
(2) transmitting to said local domain a second domain agent location set of indicia, said second domain agent location set of indicia enabling a local domain agent to access said second domain agent;
(3) enabling said local domain agent to access, via said second domain agent, all elements which are contained in said second domain; and
(4) transmitting to said requestor a local domain agent location set of indicia, said local domain agent location set of indicia enabling said requestor to access said local domain agent;
(b) if said local domain does not contain a rule for each element contained in said local domain indicating that said requestor is authorized to perform said desired operation on said target:
(1) denying said request.

212. (canceled)

213. A computer-readable medium having computer-executable commands for performing the following:
receiving from a requestor a first request comprising at least one desired operation set of indicia and a requested target identification set of indicia, said desired operation set of indicia comprising a set of indicia which is representative of at least one desired operation, said requested target identification set of indicia comprising a set of indicia which is representative of a requested target, said requested target comprising at least one element, said element comprising an information set of indicia, said information set of indicia being representative of information;
determining whether a local domain contains all of said at least one element in said requested target, said local domain comprising at least one processor;
if said local domain contains all of said at least one element in said requested target and said local domain contains a rule for each element in said requested target indicating that said requestor is authorized to perform said desired operation on said element:
(a) enabling a local domain agent to access said at least one element to perform said desired operation, and
(b) transmitting to said requester a local domain agent location set of indicia, said local domain agent location set of indicia enabling said requestor to access said local domain agent;
if said local domain contains all of said at least one element in said requested target and said local domain does not contain a rule for each element in said requested target indicating that said requestor is authorized to perform said desired operation on said element:
(a) denying said request;
if said local domain does not contain all of said at least one element in said requested target:
(a) if said local domain contains at least one of said at least one element in said requested target and said local domain does not contain a rule for each element in said requested target indicating that said requestor is authorized to perform said desired operation on said element, denying said request; otherwise:
(b) creating a current request, said current request comprising (1) said at least one desired operation set of indicia, and (2) a current target identification set of indicia comprising a set of indicia which is representative of a current target set, said current target set comprising all elements which are both (i) contained in said requested target and (ii) not contained in said local domain; and
(c) transmitting said current request to a next domain, said next domain comprising at least one processor;
if said request has not been denied, repeating a sub-routine comprising:
(1) determining whether said next domain contains all elements in said current target set;
(2) if said next domain contains all of said elements in said current target set and said next domain does not contain a rule for each element in said current target set indicating that said requestor is authorized to perform said desired operation on said element, denying said request;
(3) if said next domain contains all of said elements in said current target set and said next domain contains a rule for each element in said current target set indicating that said requestor is authorized to perform said desired operation on said element:
(a) enabling a first non-local agent to access said elements in said current target set,
(b) transmitting to a next prior domain a first non-local agent location set of indicia, said first non-local agent location set of indicia enabling a next prior domain agent to access said first non-local agent;
(c) unless said next non-local agent location set of indicia has reached said local domain, repeating a step of:
(i) enabling said next prior domain agent to access any elements which are both contained in said requested target and contained in said next prior domain; and
(ii) transmitting to said next prior domain a next non-local agent location set of indicia, said next non-local agent location set of indicia enabling said next prior domain agent to access said next non-local agent;
until said next non-local agent location set of indicia reaches said local domain; and
(d) enabling said local domain agent to access any elements which are both contained in said requested target and contained in said local domain; and transmitting to said requestor a local domain agent location set of indicia, said local domain agent location set of indicia enabling said requestor to access said local domain agent;
(4) if said next domain contains at least one of said elements in said current target set and said next domain does not contain a rule for each element in said next domain and in said current target set indicating that said requester is authorized to perform said desired operation on said element in said next domain and in said current target set, denying said request; otherwise:
(5) if said next domain does not contain all of said elements in said current target set:
(a) creating a next request, said next request comprising (1) said at least one desired operation set of indicia, and (2) a new current target identification set of indicia comprising a set of indicia which is representative of a new current target set, said new current target set comprising all elements which were (i) contained in said requested target, (ii) not contained in said local domain, and (iii) not contained in any domain to which a current request has been transmitted; and
(b) transmitting said next request to a next domain,
until (1) a non-local agent location set of indicia is transmitted to said local domain agent, or (2) said repeating of said sub-routine is terminated.

214. (canceled)

215. A computer-readable medium having computer-executable commands for performing the following:
receiving from a requestor a request comprising at least one desired operation set of indicia and at least one target identification set of indicia, said desired operation set of indicia comprising a set of indicia which is representative of at least one desired operation, each said target identification set of indicia comprising a set of indicia which is representative of a target, said target comprising at least one element, said element comprising an information set of indicia, said information set of indicia being representative of information;
determining whether a local domain contains all of said at least one element in said target, said local domain comprising at least one processor;
if said local domain contains all of said at least one element in said target:
(1) if said local domain contains a rule for each element in said target indicating that said requester is authorized to perform said desired operation on said element:
(a) enabling a local domain agent to access said at least one element to perform said desired operation, and
(b) transmitting to said requestor a local domain agent location set of indicia, said local domain agent location set of indicia enabling said requester to access said local domain agent;
(2) if said local domain does not contain a rule for each element in said target indicating that said requestor is authorized to perform said desired operation on said target:
(a) denying said request; and
if said local domain does not contain all of said at least one element in said target:
(a) denying said request.

216. A computer-readable medium having computer-executable commands for performing the following:
transmitting at least one set of indicia representative of information from a first virtual address in a first domain to a second virtual address in said first domain, said first domain comprising at least a first processor, and then
transmitting said set of indicia representative of information from said second virtual address in said first domain to a second domain via a first physical address in said first domain, said second domain comprising at least a second processor.

217-220. (canceled)

221. A method of processing a request from a requestor, comprising:
receiving from a requestor a request comprising at least one desired operation set of indicia and at least one target identification set of indicia, said desired operation set of indicia comprising a set of indicia which is representative of at least one desired operation, each said target identification set of indicia comprising a set of indicia which is representative of a target,
determining whether to deny said request by comparing combinations of indicia in said request with allowable combinations of indicia stored in at least one bitmap.

222. A method as recited in claim 221, wherein said bitmap contains indicia selected from among users, protection levels, operations, targets and NTK.

223. An arrangement of stored data, comprising:
at least one data storage structure, said data storage structure comprising a bitmap containing allowable combinations of indicia for use in determining whether to deny a request for a user to perform an operation on a target.

224. An arrangement of stored data as recited in claim 223, wherein said indicia is selected from among users, protection levels, operations, targets, NTK, roles, clearance levels and credentials.

225. An arrangement of stored data as recited in claim 223, wherein said indicia correspond to at least one rule.

226. A method as recited in claim 1, wherein said method is computer-implemented.

227. A method as recited in claim 18, wherein said method is computer-implemented.

228. A method as recited in claim 35, wherein said method is computer-implemented.

229. A method as recited in claim 59, wherein said method is computer-implemented.

230. A method as recited in claim 89, wherein said method is computer-implemented.

231. A method as recited in claim 101, wherein said method is computer-implemented.

232. A method as recited in claim 106, wherein said method is computer-implemented.

233. A computer-readable medium comprising computer instructions which, when executed by a computer, perform a method as recited in claim 1.

234. A computer-readable medium comprising computer instructions which, when executed by a computer, perform a method as recited in claim 18.

235. A computer-readable medium comprising computer instructions which, when executed by a computer, perform a method as recited in claim 97.

236. A processor on which is stored software for carrying out a method as recited in claim 1.

237. A processor on which is stored software for carrying out a method as recited in claim 18.

238. A processor on which is stored software for carrying out a method as recited in claim 97.
